(19) United States
(12) Patent Application Publication
(10) Pub. No.: US 2006/0199920 A1
(43) Pub. Date: Sep. 7, 2006

(54) Photosensitive resin composition capable of being developed with aqueous developer and photosensitive dry film resist, and use thereof

(76) Inventors: Koji Okada, Osaka (JP); Toshio Yamanaka, Osaka (JP)

Correspondence Address: HOGAN & HARTSON L.L.P., 500 S. GRAND AVENUE, SUITE 1900, LOS ANGELES, CA, 90071-2611, US

(21) Appl. No.: 10/553,272

(22) PCT Filed: Apr. 13, 2004
(86) PCT No.: PCT/JP04/05273

§ 371 Date: Oct. 12, 2005

(30) Foreign Application Priority Data
Apr. 15, 2003 (JP) 2003-110359
Apr. 23, 2003 (JP) 2003-117947
Apr. 28, 2003 (JP) 2003-124026
Apr. 28, 2003 (JP) 2003-123192

(51) Int. Cl. C08L 77/00; C08L 83/04

(52) U.S. Cl. 525/426; 525/479

(57) ABSTRACT

A photosensitive resin composition according to the present invention includes at least a base resin component (A) and a (meth)acryls compound (B), wherein the base resin component (A) is any one of: a polyimide resin (A-1) having at least either a hydroxyl group or a carboxyl group in its structure; a polyamide resin (A-2) having at least either a hydroxyl group or a carboxyl group in its structure; and photosensitive imide(meth)acrylsiloxaneoligomer (A-3). On this account, it is possible to realize characteristics such as (1) realization and improvement of water system developing property, (2) improvement of utility as an imidized film, (3) improvement of post-curing property, and (4) simplification of manufacture of a print wiring substrate. Thus, the photosensitive resin composition can be favorably used particularly in a photosensitive dry film resin, a laminate using the same, a print wiring substrate using the same, and the like.

### TECHNICAL FIELD

The present invention relates to a photosensitive resin composition, a photosensitive dry film resist, and usage thereof. Particularly, the present invention relates to [i] a photosensitive resin composition capable of realizing characteristics such as: (1) it is possible to realize water system development (particularly, development carried out with basic aqueous solution) and it is possible to obtain a favorable pattern shape; (2) it is not necessary to perform post-bake at a high temperature since it is not necessary to imidize the photosensitive resin composition, and it is possible to favorably use the photosensitive resin composition as film photosensitive materials; (3) the photosensitive resin composition are superior in properties (mechanical strength, heat resistance, easiness to process, chemical resistance, electric insulation, adhesiveness) after being cured; and (4) it is possible to prevent steps for manufacturing a print wiring substrate from being complicated, and [ii] a photosensitive dry film resist, and [iii] usage thereof.

### BACKGROUND ART

Recently, with rapid improvement in performances and functions and rapid decrease in sizes and weights of electronic devices, electronic parts used in these electronic devices are required to have smaller sizes, lighter weights, and smaller thickness. Thus, on a print wiring substrate which is to be provided with electronic parts, it is required to install a semiconductor or the like in a high density manner, to make wires finer, and it is required to the print wiring substrate multi-layered in order to improve functions and performances of the electronic parts.

Further, as the print wiring substrate, a flexible print wiring substrate (referred to also as FPC as required) has recently attracted more attentions than an ordinary rigid print wiring substrate, and has come to be further demanded. In making the wirings finer, it is necessary to use an insulative material having a higher electric insulation property in order to protect the wirings.

Incidentally, in manufacturing the print wiring substrate, a photosensitive material is used in various manners. Specifically, for example, the photosensitive material is used as (i) a resist material used to form a patterned circuit (pattern circuit) on the print wiring substrate, (ii) a protection layer formed to protect a surface and the pattern circuit of the print wiring substrate, (iii) an insulation layer formed between layers in case where the print wiring substrate has a plurality of layers, (iv) and the like.

For example, a polymer film referred to as a cover lay film is used to form the protection layer. That is, the cover lay film is combined with a surface (conductor surface) of the FPC so as to protect the conductive surface. As a process for combining the cover lay film with the conductor surface, it is general to perform the following process: an adhesive is applied to a surface of the cover lay film (polyimide film), and the cover lay film is processed by punching or the like so as to have a predetermined shape, and thus processed cover lay film is made to overlap a flexible copper plate and is properly positioned, and then the cover lay film is thermally pressed against the flexible copper plank with a pressing device or the like.

However, as the foregoing adhesive, an epoxy adhesive or an acrylic adhesive is mainly used, but such adhesive is inferior in (i) heat resistance such as soldering heat resistance and bonding strength at high temperature and (ii) flexibility. As the cover lay film, it is general to favorably use a polyimide film. However, in case of combining the cover lay film with the conductor surface with an adhesive, it is impossible to sufficiently make use of a performance of the polyimide film.

Further, in case of combining the cover lay film with the FPC with the epoxy adhesive or the acrylic adhesive, it is necessary to form a hole or a window on an uncombined cover lay film so as to correspond to a junction of a terminal or a part of the circuit. That is, it is necessary to process the cover lay film so as to have a pattern corresponding to the circuit. However, the cover lay film is thin, so that it is difficult to form a hole and the like. Furthermore, the hole and the like of the cover lay film are almost manually positioned so as to correspond to junctions of terminals or portions of the FPC. This is not preferable in terms of workability and positional accuracy, so that the manufacturing cost increases.

In order to reduce the cost by improving the workability and the positional accuracy, conventionally, (i) a method for forming a protection layer by applying a photosensitive composition to the conductor surface and (ii) a photosensitive cover lay film have been developed.

In this way, the photosensitive material is variously used in manufacturing the print wiring substrate. As to a state of the photosensitive material, it is general that the photosensitive material is in a liquid state or the photosensitive material is in a film shape.

Among them, the film-shape photosensitive material is superior to the liquid photosensitive material in evenness of a film thickness and workability. Thus, the film-shape photosensitive material is variously used as (i) a pattern circuit resist film used to form a pattern circuit, (ii) the photosensitive cover lay film, (iii) a photosensitive dry film resist used to form the interlayer insulation layer, (iv) a solder resist film used to coat a soldered print wiring substrate, (v) and the like. The film is arranged so as to correspond to use thereof.

In patterning the photosensitive dry film resist, steps of applying and exfoliating the photo resist are included, so that all the steps for patterning are extremely complicated. Thus, in order to reduce the operation steps and improve the accuracy in film formation, conventionally, how to improve the photosensitivity of the photosensitive dry film resist has been studied. For example, instead of a conventional development process using an organic solvent, a development process using an aqueous solution is adopted as effective means for improving the photosensitivity. It is advantageous to carry out development with an aqueous solution (water system development) in terms of not only improvement of the photosensitivity but also environmental problems which have recently attracted great attentions. Generally, an example of developer used in the water system development is basic aqueous solution (alkaline aqueous solution).

As one of means for realizing the water system development, first, (1) a technique in which a carboxyl group and a hydroxyl group (collectively referred to as a hydrophilic hydroxyl group) are introduced into a base polymer included in the photosensitive dry film resist is known. As to a technique concerning the photosensitive material, a technique in which not the film-shape photosensitive material but liquid varnish or the like obtained by dissolving the photosensitive material in an organic solvent is used is widely proposed, and is in practical use. As a method for realizing the water system development in such liquid photosensitive material, (2) a technique in which a photosensitive polyimide precursor is used as the base polymer is known recently. Specific examples of the technique are: (2-1) such a technique that a photosensitive polyimide precursor obtained by introducing naphthoquinone diazide into a carboxyl group of polyamide acid is used as the base polymer (see Patent Document 1); (2-2) such a technique that a photosensitive polyimide precursor obtained by introducing a carboxyl group into a side chain of polyamic acid into which a photopolymeric acryloyl group has been introduced on the basis of an ester bond is used as the base polymer (see Patent Document 2); (2-3) such a technique that a photosensitive polyimide precursor obtained by introducing an amine compound or a diisocyanate compound having a methacroyl group at the position of the carboxyl group of polyamic acid is used as the base polymer (see Patent Documents 3 and 4); (2-4) such a technique that photosensitive polyimide obtained by introducing a methacroyl group via an ester bond is used (see Patent Document 5); and the like.

Further, as a method for realizing the water system development, (3) a technique in which photosensitive imidized polyimide is used as the base polymer is known. Specific examples of the technique are: such a technique that photosensitive polyimide obtained by introducing a photosensitive group and a hydrophilic group into a polyimide side chain is used as the base polymer (see Patent Document 6); and the like.

Here, as the polyimide resin which is superior in heat resistance, easiness to process, and the like, (4) a polyimide resin having a siloxane structure (siloxane polyimide resin) is known. Specific examples of the polyimide resin are: soluble silicone-imide copolymer having a block whose glass transition temperature is high and a block whose glass transition temperature is low (see Patent Document 7); and the like. Further, examples of a resin composition having the siloxane polyimide resin are: a resin composition having: polyimide siloxane obtained by using aromatic diamine having an —OH group and a COOH group and diaminopolysiloxane (see Patent Document 8); a resin composition, obtained by using siloxane diamine, which has a polyimide resin being soluble in organic solvent and having a glass transition temperature of 350° C. or lower (see Patent Document 9); and the like. It is known that both the compositions are not photosensitive but are superior in heat resistance and easiness to process.

The photosensitive cover lay film using the siloxane polyimide resin is superior in an electric insulation property, soldering heat resistance, a film formation property, and flexibility.

Further, (5) a solder resist film containing a photo-curing polyimide resin having a vinyleter group in a polymer side chain is known (see Patent Document 10). The solder resist film is extremely thin, and realizes high soldering heat resistance, chemical resistance, film formation, electric insulation property, and flexibility, but development based on alkaline aqueous solution is not realized.

[Patent Document 1]

Japanese Unexamined Patent Publication No. 258835/1994 (Tokukaihei 6-258835)(Publication date: Sep. 16, 1994)

[Patent Document 2]

Japanese Unexamined Patent Publication No. 95848/1998 (Tokukaihei 10-95848)(Publication date: Apr. 14, 1998)

[Patent Document 3]

Japanese Unexamined Patent Publication No. 145794/1979 (Tokukaisho 54-145794)(Publication date: Nov. 14, 1979)

[Patent Document 4]

Japanese Unexamined Patent Publication No. 160140/1984 (Tokukaisho 59-160140)(Publication date: Sep. 10, 1984)

[Patent Document 5]

Japanese Examined Patent Publication No. 30207/1980 (Tokukosho 55-30207) (Japanese Unexamined Patent Publication No. 115541/1970 (Tokukaisho 45-115541)(Publication date: Nov. 5, 1974))

[Patent Document 6]

Japanese Unexamined Patent Publication No. 147768/2000 (Tokukai 2000-147768)(Publication date: May 26, 2000)

[Patent Document 7]

Japanese Unexamined Patent Publication No. 118424/1986 (Tokukaisho 61-118424)(Publication date: Jun. 5, 1986)

[Patent Document 8]

Japanese Unexamined Patent Publication No. 733/1998 (Tokukaihei 10-733)(Publication date: Jan. 6, 1998)

[Patent Document 9]

Japanese Unexamined Patent Publication No. 242820/1995 (Tokukaihei 7-242820)(Publication date: Sep. 16, 1995)

[Patent Document 10]

Japanese Unexamined Patent Publication No. 27667/1994 (Tokukaihei 6-27667)(Publication date: Feb. 4, 1994)

However, each of the foregoing conventional techniques concerning the photosensitive material raises the following problem in terms of practical use particularly in manufacturing the print wiring substrate. Thus, each of the foregoing techniques insufficiently serves to practical use as the photosensitive dry film resist technique which realizes the water system development.

Specifically, first, a technique (1) in which a hydrophilic hydroxyl group is introduced into the base polymer causes properties such as electric insulation property and chemical resistance of the photosensitive dry film resist to drop, and also results in insufficient development.

For example, the technique in which a carboxyl group is introduced into the base polymer raises such problem that: electric insulation property, chemical resistance, and anti-hydrolysis property of thus obtained photosensitive dry film resist drop. Further, the technique in which a photosensitive polyimide resin composition having a phenol ring raises such problem that: heat resistance, electric insulation property, and anti-alkali property of thus obtained photosensitive dry film resist deteriorate, and a ratio at which a film remains after the development is low, and a development process window is narrow.

On the other hand, a technique (2) in which the photosensitive polyimide precursor is used has the aforementioned various advantages, but this technique is related to the liquid photosensitive material and is not a technique in which the film-shape photosensitive dry film resist is used. Thus, according to this technique, it is difficult to improve the uniformity of the film thickness and easiness to process unlike the film-shape photosensitive dry film resist.

Further, use of the photosensitive polyimide precursor in the technique (2) may limit use of the photosensitive dry film resist.

Specifically, in case of the photosensitive cover lay film for example, it is necessary to perform the step of imidizing polyamic acid after the film is laminated in a state of polyamic acid on the FPC and is subjected to exposure and development. Thus, it is necessary to perform high temperature heating (post-bake) at 250° C. so as to imidize the photosensitive polyimide precursor (polyamic acid). That is, according to this technique, polyamic acid (photosensitive polyimide precursor) has to be imidized to obtain the photosensitive polyimide. At that time, the polyamic acid has to be exposed to high temperature of 250° C. or higher for a long time.

Such high temperature thermally damages parts and the like of the print wiring substrate with which the photosensitive dry film resist is combined. For example, in case of the FPC, portions other than (i) a copper foil serving as a conductive layer and (ii) photosensitive polyimide may deteriorate. Thus, manufacture thereof may be limited depending on a type of the print wiring substrate.

Further, dehydration reaction occurs due to ring closure in imidizing the photosensitive polyimide precursor, so that its volume contracts. Thus, the film thickness is decreased and the size is less stabilized. Alternatively, it is necessary to remove an acloyl group by heat depending on a kind of photosensitive polyimide, so that the film thickness may be largely decreased at this time.

While, according to a technique (3) in which photosensitive polyimide having been imidized is used, it is possible to avoid problems and the like caused by imidizing the photosensitive material like the technique (2) using the photosensitive polyimide precursor.

Further, a technique (4) using the siloxane polyimide resin has various advantages, but its application to the photosensitive dry film resist still has problems to be solved. Thus, in order to correspond to the high-density installation and the higher definition of the print wiring substrate, further improvement of properties are required.

For example, according to a technique (4-1) using epoxy denaturalized polyimide having a siloxane structure, a molecular weight of the epoxy denaturalized polyimide preferably ranges from 5000 to 1000000. In Examples, epoxy denaturalized polyimide whose molecular weight is approximately 60000 is used. By using the photosensitive polyimide having such molecular weight, it is possible to use the photosensitive cover lay film having superior properties. Note that, in terms of easiness to process and the like, use of photosensitive polyimide whose molecular weight is lower than that of the above photosensitive polyimide results in the following advantages: its solubility in a developer is improved, so that it is possible to reduce time taken to carry out development (developing property is improved); it is possible to drop a temperature at which the film is combined with the base material. However, the foregoing technique may insufficiently provide the foregoing advantages.

While, according to a technique (4-2) using imide siloxane oligomer, oligomer whose molecular weight is lower is used, so that it is possible to obtain the following advantages: the developing property is improved; the temperature at which the film is combined with the base material drops; and a similar advantage. However, this technique is based on a condition under which oligomer is applied, and is not based on a condition under which oligomer is used as the photosensitive dry film resist. Thus, this technique may be insufficiently applied to the case of using for the photosensitive dry film resist.

Further, according to a technique (5) using a solder resist film containing photo-curing polyimide resin, it is possible to obtain the aforementioned various advantages. However, the photosensitive resin composition using the photo-curing polyimide resin contains a thinner as an essential component, so that the step of removing the thinner is included after the photosensitive resin composition is applied to the FPC. Thus, the steps for manufacturing the FPC are complicated.

In addition, in the photosensitive dry film resist and the photosensitive resin composition (including varnish or the like to be applied) available for the photosensitive dry film resist, the storage stability is an important property.

Specifically, it is general that the photosensitive resin composition and the photosensitive dry film resist are stored in a refrigerator whose temperature ranges from 0° C. to 10° C. However, in case where the photosensitive resin composition and the photosensitive dry film resist are left at a room temperature while being used, this raises such problem that: when the photosensitive resin composition is used as varnish, its viscosity increases or the solubility (developing property) of the photosensitive dry film resist with respect to developer (alkali aqueous solution for example) changes.

The quality instability not only causes the manufacturing steps to be complicated but also causes reproducibility of the pattern formation step using them to drop. That is, the viscosity of the varnish changes and the developing property of the photosensitive dry film resist changes, so that also the developing condition changes day by day. As a result, the productivity of the print wiring substrate drops.

The present invention was completed in view of the foregoing problems, and has an object to provide [1] a photosensitive resin composition characterized in that: (1) it is possible to realize water system development, and it is possible to obtain a favorable pattern shape (it is possible to realize and improve a water system developing property); (2) since it is not necessary to imidize the composition, it is not necessary to perform post-bake at a high temperature, and it is possible to favorably use the composition as a film-shape photosensitive material (it is possible to improve the availability as the film having been imidized); (3) properties of the cured composition, e.g., mechanical strength, heat resistance, easiness to process, chemical resistance, electric insulation property, and adhesiveness, are excellent (it is possible to improve properties of the cured composition); and (4) it is possible to simplify the manufacturing steps of the print wiring substrate, and it is possible to prevent the manufacturing steps from being complicated (it is possible to simplify the manufacture of the print wiring substrate), [ii] a photosensitive dry film resist using the same, and [iii] a usage thereof.

### DISCLOSURE OF INVENTION

The inventors of the present invention diligently studied so as to solve the foregoing problems. As a result of the study, they found it possible not only to favorably realize water system development but also to realize the foregoing properties by constituting, as base polymer, a photosensitive resin composition so that: (i) a polyimide resin or a polyamide resin which contains a hydrophilic hydroxyl group in its structure is used, or photosensitive imide(meth)acrylsiloxaneoligomer is used as a main component which can take the place of the base polymer; (ii) at least a (meth)acryls compound is combined therewith; and (iii) various components are added thereto as required.

That is, a photosensitive resin composition according to the present invention includes a base resin component (A) and a (meth)acryls compound (B) as essential components, wherein the base resin component (A) is any one of: a polyimide resin (A-1) having at least either a hydroxyl group or a carboxyl group in its structure; a polyamide resin (A-2) having at least either a hydroxyl group or a carboxyl group in its structure; and photosensitive imide(meth)acrylsiloxaneoligomer (A-3).

A preferable example of the photosensitive resin composition according to the present invention is as follows: the base resin component is the polyimide resin (A-1) or the polyamide resin (A-2), and the (meth)acryls compound (B) is at least one kind of a compound selected from (meth)acrylic compound, epoxy (meth)acrylate, polyester (meth)acrylate, urethane (meth)acrylate, and imide (meth)acrylate.

It is preferable to arrange the photosensitive resin composition so that: the polyimide resin (A-1) is a polyimide resin having a phenolic hydroxyl group (A-1-1) which is a polyimide resin partially made of a phenol derivative having an amino group, and the phenol derivative is such that two or more phenol compounds bind each other via an atom or an atom group in a chain manner and each of the phenol compounds at both ends has an amino group which substitutes one of hydrogen atoms in a benzene ring.

Further, an example of the photosensitive resin composition is as follows: the phenol derivative used as a martial for the polyimide resin (A-1-1) is a compound represented by formula (1) 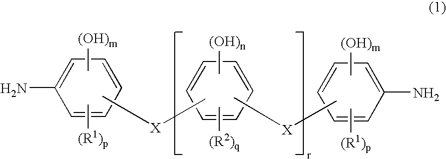
where R¹ and R² may be identical with or different from each other, and each of R¹ and R² represents a hydrogen atom, an alkyl group containing 1 to 9 carbon atoms in its molecule, an alkoxy group containing 2 to 10 carbon atoms in its molecule, or COOR³ (R³ represents a hydrogen atom or an alkyl group containing 1 to 9 carbon atoms in its molecule), and X represents —O—, —S—, —SO₂—, —C(CH₃)₂—, —CH₂—, —C(CH₃)(C₂H₅)—, or C(CF₃)₂—, and each of m and p is an integer not less than 0 which is under such condition that m+p=4, and each of n and q is an integer not less than 0 which is under such condition that n+q=4, and r is any one of integers 0 to 10.

Therefore, as the polyimide resin (A-1), it is preferable to use a polyimide resin having at least one recurring unit represented by formula (2) 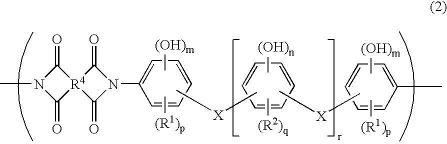
where R¹ and R² may be identical with or different from each other, and each of R¹ and R² represents a hydrogen atom, an alkyl group containing 1 to 9 carbon atoms in its molecule, an alkoxy group containing 2 to 10 carbon atoms in its molecule, or COOR³ (R³ represents a hydrogen atom or an alkyl group containing 1 to 9 carbon atoms in its molecule), and X represents —O—, —S—, —SO₂—, —C(CH₃)₂—, —CH₂—, —C(CH₃)(C₂H₅)—, or C(CF₃)₂—, and R⁴ represents a residue of aromatic tetra carboxylate dianhydride, and each of m and p is an integer not less than 0 which is under such condition that m+p=4, and n and q are under such condition that n+q=4, and n is an integer not less than 0 and q is an integer not less than 0, and r is any one of integers 0 to 3.

Further, in the photosensitive resin composition, a weight-average molecular weight of the polyimide resin (A-1) or the polyamide resin (A-2) is preferably 5000 or more and 100000 or less. Further, a hydroxyl equivalent of the polyimide resin (A-1) or the polyamide resin (A-2) is preferably 5000 or less, and the hydroxyl equivalent of the polyimide resin (A-1) or the polyamide resin (A-2) is more preferably 3000 or less.

Further, as the (meth)acryls compound (B), it is preferable to use a compound having at least one epoxy group and at least one (meth)acryl group in its molecule. Alternatively, it is preferable to use epoxy (meth)acrylate having at least two hydroxyl groups.

Further, the photosensitive resin composition preferably includes, as an accessory component (C), at least one kind selected from: at least one kind (C-1) of a photoreaction initiator, a sensitizer, and a photopolymerization assistant; a flame retardant (C-2); an epoxy resin (C-3); and a curing promotion agent and/or a curing agent (C-4).

According to the foregoing arrangement, it is possible to realize the developing property (water system developing property) with the basic aqueous solution, and it is possible to avoid drop in properties such as electric insulation property and the like or it is possible to improve the properties. Therefore, in the photosensitive dry film resist, it is possible to obtain a favorable pattern and it is possible to simplify a manufacturing process of a print substrate using the photosensitive dry film resist. Further, in the base polymer having the hydroxyl group, an amount of the introduced hydroxyl group is controlled, so that it is possible to provide a photosensitive dry film resist which can be dissolved in the basic aqueous solution in short time.

Next, another preferable example of the photosensitive resin composition according to the present invention is as follows: the base resin component is the polyimide resin (A-1), and the polyimide resin (A-1) is a photosensitive polyimide resin (A-1-2) obtained by reacting a compound having a carbon-carbon double bond with a polyimide resin having a hydroxyl group in its structure, and the (meth)acryls compound (B) is at least one kind of a compound selected from a (meth)acrylic compound, an epoxy(meth)acrylate, a polyester(meth)acrylate, a urethane(meth)acrylate, and an imide(meth)acrylate, and the photosensitive resin composition further includes, as an accessory component (C), at least one kind (C-1) selected from a photoreaction initiator, a sensitizer, and a photopolymerization assistant.

It is preferable to arrange the photosensitive resin composition so that: the photosensitive polyimide resin (A-1-2) is a polyimide resin having a phenolic hydroxyl group which is a polyimide resin partially made of a phenol derivative having an amino group, and the phenol derivative is such that two or more phenol compounds bind each other via an atom or an atom group in a chain manner and each of the phenol compounds at both ends has an amino group which substitutes one of hydrogen atoms in a benzene ring.

Further, an example of the phenol derivative used as a martial for the polyimide resin is a compound represented by formula (3) 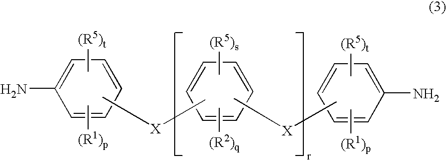
where R¹ and R² may be identical with or different from each other, and each of R¹ and R² represents a hydrogen atom, an alkyl group containing 1 to 9 carbon atoms in its molecule, an alkoxy group containing 2 to 10 carbon atoms in its molecule, or COOR³ (R³ represents a hydrogen atom or an alkyl group containing 1 to 9 carbon atoms in its molecule), and X represents —O—, —S—, —SO₂—, —C(CH₃)₂—, —CH₂—, —C(CH₃)(C₂H₅)—, or C(CF₃)₂—, and all of R⁵ may be identical with or different from each other, and each R⁵ represents —OH or an unsaturated organic group having a carbon-carbon double bond in its structure, and each R⁵ includes both —OH and the unsaturated organic group, a number of —OH or the unsaturated organic group being at least one, and each of t and p is an integer not less than 0 which is under such condition that t+p=4, and each of s and q is an integer not less than 0 which is under such condition that s+q=4, and r is any one of integers 0 to 10.

Note that, an example of the unsaturated organic group is an organic group selected from a group (4) 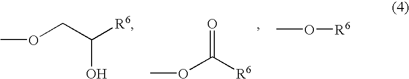
where R⁶ is a monovalent organic group having a carbon-carbon double bond.

Therefore, as the photosensitive polyimide resin (A-1-2), it is preferable to use a polyimide resin having at least one recurring unit represented by formula (5) 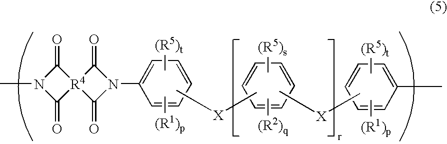
where R¹ and R² may be identical with or different from each other, and each of R¹ and R² represents a hydrogen atom, an alkyl group containing 1 to 9 carbon atoms in its molecule, an alkoxy group containing 2 to 10 carbon atoms in its molecule, or COOR³ (R³ represents a hydrogen atom or an alkyl group containing 1 to 9 carbon atoms in its molecule), and X represents —O—, —S—, —SO₂—, —C(CH₃)₂—, —CH₂—, —C(CH₃)(C₂H₅)—, or C(CF₃)₂—, and R⁴ represents a residual group of aromatic tetra carboxylic dianhydride, and all of R⁵ may be identical with or different from each other, and each R⁵ represents —OH or an unsaturated organic group containing a carbon-carbon double bond in its structure, each R⁵ includes both —OH and the unsaturated organic group, a number of —OH or the unsaturated organic group being at least one, and each of t and p is an integer not less than 0 which is under such condition that t+p=4, and each of s and q is an integer not less than 0 which is under such condition that s+q=4, and r is any one of integers 0 to 10. Note that, the unsaturated organic group is an organic group selected from the group (4). Further, in the photosensitive resin composition, a weight-average molecular weight of the photosensitive polyimide resin (A-1-2) is preferably 5000 or more and 200000 or less. Further, a weight-average molecular weight of each phenolic hydroxyl group of the polyimide resin is 10000 or less.

Further, in the photosensitive resin composition, as the (meth)acryls compound (B), it is preferable to use a compound having at least one epoxy group and at least one (meth)acryl group in its molecule. Alternatively, as the (meth)acryls compound (B), it is preferable to use epoxy (meth)acrylate having at least two hydroxyl groups in its molecule.

Further, it is preferable that the photosensitive resin composition includes, as the accessory component (C), at least one kind selected from: a sensitizer, and a photopolymerization assistant; a flame retardant (C-2); an epoxy resin (C-3); and a curing promotion agent and/or a curing agent (C-4).

According to the foregoing arrangement, it is possible to realize the water system developing property, and it is possible to avoid drop in properties such as electric insulation property and the like or it is possible to improve the properties. Therefore, in the photosensitive dry film resist, it is possible to obtain a favorable pattern and it is possible to simplify a manufacturing process of a print substrate using the photosensitive dry film resist. Further, in the base polymer having the hydroxyl group, an amount of the introduced hydroxyl group is controlled, so that it is possible to provide a photosensitive dry film resist which can be dissolved in the basic aqueous solution in short time.

A still another example of the photosensitive resin composition according to the present invention, particularly an example of the photosensitive resin composition for realizing improvement of the storage stability is as follows: the base resin component is the polyimide resin (A-1), and the polyimide resin (A-1) is a soluble polyimide resin (A-1-3) having a polymerizable functional group and at least one of a carboxyl group and a hydroxyl group, and the photosensitive resin composition further includes, as a storage stabilization additive (D), at least one kind selected from a polymerization inhibitor, a stabilizer, and an oxidization inhibitor.

It is preferable to arrange the photosensitive resin composition so that: the soluble polyimide resin (A-1-3) includes, as a polymerizable functional group, at least one kind of a functional group selected from a vinyl group and a (meth)acryl group.

Further, it is preferable to arrange the photosensitive resin composition so that: the storage stabilization additive (D) is at least one kind of a compound selected from a hydroquinone compound, a hindered phenolic compound, a nitrosamine compound, and an aromatic amine.

Further, it is preferable to arrange the photosensitive resin composition so that: a viscosity increasing rate in case where the photosensitive resin composition is left at a room temperature for 7 days under such condition that the photosensitive resin composition is dissolved in an organic solvent is 0% or more and 20% or less.

In addition, it is preferable that the photosensitive resin composition further includes, as the accessory component (C), at least one kind selected from: at least one kind (C-1) of a photoreaction initiator, a sensitizer, and a photopolymerization assistant; a flame retardant (C-2); an epoxy resin (C-3); and a curing promotion agent and/or a curing agent (C-4).

According to the foregoing arrangement, it is possible to realize the water system developing property, and it is possible to improve the storage stability. Particularly, even when the photosensitive resin composition is made into a varnish, it is possible to suppress increase in viscosity of the stored varnish, and it is possible to reduce gradual variation of the solubility with respect to the basic aqueous solution during the time of development. Further, it is possible to improve an anti-hydrolysis property of the photosensitive dry film resist that has been cured.

Further, a still another example of the photosensitive resin composition according to the present invention is as follows: the base resin component is the photosensitive imide(meth)acrylsiloxaneoligomer (A-3), and the (meth)acryls compound is a polyunsaturated(meth)acryls compound (B-1) having two or more unsaturated double bonds, and an amount of the polyunsaturated(meth)acryls compound (B-1) ranges from 5 to 200 parts by weight with respect to 100 parts by weight of the photosensitive imide (meth)acrylsiloxaneoligomer (A-3).

It is preferable to arrange the photosensitive resin composition so that: the base resin component is the photosensitive imide(meth)acrylsiloxaneoligomer (A-3), and the(meth)acryls compound is a polyunsaturated (meth)acryls compound (B-1) having two or more unsaturated double bonds, and an amount of the polyunsaturated(meth)acryls compound (B-1) ranges from 5 to 200 parts by weight with respect to 100 parts by weight of the photosensitive imide(meth)acrylsiloxaneoligomer (A-3).

Further, it is preferable to arrange the photosensitive resin composition so that: the photosensitive imide(meth)acrylsiloxaneoligomer (A-3) is obtained by reacting imidesiloxaneoligomer with an epoxy compound having a double bond, and the imidesiloxaneoligomer is obtained by reacting diamine with tetra carboxylic dianhydride and imidizing the diamine and the tetra carboxylic dianhydride that have been reacted.

It is preferable to use at least siloxanediamine as the diamine serving as the monomer constituting the imidesiloxanepolymer, and it is preferable to use, as the siloxanediamine, diaminopolysiloxane represented by formula (6) 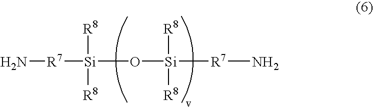
where R⁷ is —CᵤH₂ᵤ— or —C₆H₄—, and R⁸ is a methyl group, an ethyl group, or a phenyl group, and u is any one of integers 1 to 6, and v is any one of integers 2 to 50.

Further, it is preferable to arrange the photosensitive resin composition so that: in case of using the diaminopolysiloxane as the diamine, a molar ratio of the diaminopolysiloxane ranges from 5 to 70mol % with respect to 100mol % of whole the diamine.

Further, diamine having a phenolic hydroxyl group or diamine having a carboxyl group may be used as the diamine. In case of using the diamine having a phenolic hydroxyl group as the diamine, it is preferable that a molar ratio of the tetra carboxylate dianhydride ranges from 50 to 95mol % with respect to 100 mol % of whole the diamine. In case of using the diamine having a carboxyl group as the diamine, it is preferable that a molar ratio of the diamine ranges from 50 to 95 mol % with respect to 100 mol % of the tetra carboxylate dianhydride.

As the diamine having a phenolic hydroxyl group or the diamine having a carboxyl group, it is preferable to use an aromatic diamine compound represented by formula (7) 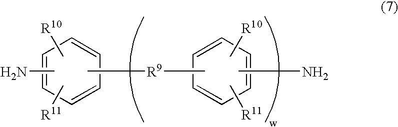
where R⁹ represents a group having a direct bond or a bivalent group selected from —O—, —S—, —CO—, —SO₂—, —SO—, —CH₂—, —C(CH₃)₂—, —O—C₆H₄—O—, —C₆H₄—, and —O—C₆H₄—C(CH₃)₂—C₆H₄—O—, and R¹⁰ represents —OH or —COOH, and R¹¹ represents a hydrogen atom, a methyl group, or a halogen atom.

Further, it is preferable that the photosensitive resin composition further includes a flame retardant (C-2) as the accessory component (C). At this time, it is preferable that an amount of the flame retardant (C-2) ranges from 5 to 200 parts by weight with respect to 100 parts by weight of the photosensitive imide(meth)acrylsiloxaneoligomer (A-3) and 5 to 200 parts by weight of the polyunsaturated(meth)acryls compound (B-1).

It is preferable that: the flame retardant (C-2) is at least one kind of a compound selected from phosphate ester, condensed phosphate ester, phosphite ester, phosphagene compound, phosphine oxide, phosphine, phosphate ester having halogen atom, condensed phosphate ester having halogen atom, (meth)acryls compound having halogen atom, and organopolysiloxane compound.

Further, it is preferable that the photosensitive resin composition further includes: at least one kind (C-1) selected from a photoreaction initiator, a sensitizer, and a photopolymerization assistant; an epoxy resin (C-3); and at least one kind (C-4) selected from a curing promotion agent and/or a curing agent.

According to the foregoing arrangement, it is not necessary to carry out imidization unlike polyamide acid serving as a precursor of polyimide, and it is not necessary to expose the resultant to a high temperature not less than 250° C. for a long time. Thus, it is possible to avoid deterioration of portions other than the copper foil or polyimide, so that it is possible to obtain a photosensitive resin composition and a photosensitive cover lay film having superior properties.

Further, the present invention includes a photosensitive dry film resist, being made of the aforementioned photosensitive resin composition. The photosensitive dry film resist in this case means, particularly, a photosensitive cover lay film, a photosensitive dry film resist, and a solder resist film.

It is preferable to arrange the photosensitive dry film resist so that: in case of using, as a developer, 1 wt % of sodium hydrate whose temperature is 40° C. and using a spray developing device as developing means, a dissolving time at a spray pressure of 0.85 MPa is 180 seconds or less. At this time, it is more preferable that the dissolving time is 20 seconds or more.

Alternatively, it is preferable to arrange the photosensitive dry film resist so that: in case of using, as a developer, a sodium hydrate aqueous solution whose temperature is 40° C. and whose concentration is 1 wt % and using a spray developing device as developing means, a dissolving time at a spray pressure of 0.85 MPa varies within a range of ±20% after the photosensitive dry film resist is left at room temperature for 7 days compared with the photosensitive dry film resist before being left for 7 days.

A specific usage of the present invention is not particularly limited. However, for example, the present invention can be used in a laminate, including a layer made of the photosensitive dry film resist, and the laminate includes at least either a protective film for protecting the surface of the photosensitive dry film resist or a support film for supporting the photosensitive dry film resist.

Further, other usage of the present invention is, for example, a print wiring substrate using the photosensitive dry film resist as an insulating protection layer; a flexible print wiring (FPC) substrate using the photosensitive dry film resist as a photosensitive cover lay film; or an FPC including a photosensitive cover lay film made of the photosensitive resin composition.

For a fuller understanding of the nature and advantages of the invention, reference should be made to the ensuing detailed description taken in conjunction with the accompanying drawings.

### BRIEF DESCRIPTION OF DRAWINGS

FIG. 1 is a plan view showing an example of a comb-shape copper pattern circuit formed on an FPC exemplified as a target on which a photosensitive dry film resist according to the present invention is laminated.

### BEST MODE FOR CARRYING OUT THE INVENTION

One embodiment of the present invention is described below. Note that, the present invention is not limited to this.

A photosensitive resin composition according to the present invention includes a base resin component (A) and a (meth)acryls compound (B) as essential components, wherein the base resin component (A) is any one of: a polyimide resin (A-1) having at least either a hydroxyl group or a carboxyl group in its structure; a polyamide resin (A-2) having at least either a hydroxyl group or a carboxyl group in its structure; and photosensitive imide(meth)acrylsiloxaneoligomer (A-3).

Further, the photosensitive dry film resist according to the present invention is produced by using the photosensitive resin composition. The present invention is typically used in a print wiring substrate using the photosensitive dry film resist as an insulating protection film or in a similar product for example.

The photosensitive resin composition according to the present invention may include the base polymer and (meth)acryls compound as essential components, but may include other components such as accessory components described later. Further, among the accessory components, particularly, at least one kind selected from a polymerization inhibitor, a stabilizer, and an oxidation inhibitor, which will be described later, is referred to as a storage stabilization additive. In the following description, the base resin component and the (meth)acryls compound which are essential components are respectively referred to as a component (A) and a component (B). The accessory component is referred to as a component (C), and the storage stabilization additive is referred to as a component (D).

### (I) Component (A): Base Resin Component

First, the base resin component (A) is specifically described as follows. Generally, the photosensitive resin composition contains one or more kinds of polymer components and one or more kinds of oligomer components. In the present invention, a polymer component whose weight is largest in contents included in the photosensitive resin composition is referred to as a base polymer. Here, photosensitive imide (meth)acrylsiloxaneoligomer described later is less polymerized than general polyimide polymer, so that this can be regarded as an oligomer component. However, upon curing, this component finally serves as a main polymer component as in the foregoing base polymer. In the present invention, also the photosensitive imide (meth)acrylsiloxaneoligomer is treated as in the base polymer.

Thus, in the present invention, not only the base polymer but also the photosensitive imide(meth)acrylsiloxaneoligomer is referred to as the “base resin component”.

<Base Polymer having a Hydroxyl Group>

As the base resin component (A) according to the present invention, any one of the base polymer and the oligomer substantially serving as polymer is used as described above. Among them, either base polymer containing a carboxyl group and a hydroxyl group (collectively referred to as a hydroxy hydrophilic group) in its structure (in a polymer chain) or a photosensitive polyimide resin having a carbon-carbon double bond is used as the base polymer so as to realize the water system developing property. Note that, the base polymer contains at least either the carboxyl group or the hydroxyl group, so that the base polymer can be regarded as having a —OH group as a functional group. Thus, the base polymer is referred to as base polymer having a hydroxyl group for convenience in description.

As the base polymer having a hydroxyl group, it is preferable to use the polyimide resin containing the hydroxy hydrophilic group (A-1) (for convenience in description, the polyimide resin is referred to as polyimide resin having a hydroxyl group) or the polyamide resin containing the hydroxy hydrophilic group (A-2) (for convenience in description, the polyamide resin is referred to as polyamide resin having a hydroxyl group). One kind of the base polymer having a hydroxyl group may be used, or two or more kinds of the base polymer having a hydroxyl group may be used. Further, among the base polymer having a hydroxyl groups, it is preferable to use the polyimide resin having a hydroxyl group (A-1). More specifically, the polyimide resin having a hydroxyl group (A-1) is not particularly limited, but specific examples thereof include: phenolic polyimide resin having a hydroxyl group (A-1-1) which is a polyimide resin partially made of an phenolic derivative having an amino group; a photosensitive polyimide resin (A-1-2), containing a hydroxyl group, which has a carbon-carbon double bond; and a soluble polyimide resin (A-1-3), containing a polymerizable functional group, which contains at least either a carboxyl group or a hydroxyl group.

Further, a weight-average molecular weight of the base polymer having a hydroxyl group is not particularly limited, but its lower limit is preferably 5000 or more, more preferably 10000 or more. Further, an upper limit of the weight-average molecular weight is preferably 200000 or less, more preferably 100000 or less, still more preferably 80000 or less, particularly preferably 50000 or less. The weight-average molecular weight can be measured by a liquid chromatography (GPC). Specifically, the weight-average molecular weight can be measured by a size excluding chromatography (SEC) such as HLC822OGPC (commercial name: produced by Tosoh Corporation).

Further, a weight-average molecular weight of each hydroxyl group of the base polymer having a hydroxyl group (hereinafter, this weight-average molecular weight is referred to as a hydroxyl equivalent) is preferably 10000 or less, more preferably 5000 or less, still more preferably 3000 or less, most preferably 1000 or less. When the hydroxyl equivalent exceeds 5000, it is difficult to realize the water system developing property of the photosensitive dry film resist using the base polymer having a hydroxyl group. The hydroxyl equivalent of the base polymer having a hydroxyl group is calculated in accordance with a weight ratio between a molecular weight of material for the base polymer having a hydroxyl group and an amount of the charged material.

Further, in the base polymer having a hydroxyl group, an amount of introduced hydroxyl group is controlled., so that it is possible to improve the alkali solubility of the photosensitive dry film resist. Thus, it is possible to provide the photosensitive dry film resist which can be dissolved in basic aqueous solution in a short time.

The following description specifically explains each base resin component. The phenolic polyimide resin having a hydroxyl group (A-1) will be described collectively along with an explanation for a general polyimide resin having a hydroxyl group which can be favorably used in the present invention.

### (I-1) Polyimide Resin having a Hydroxyl Group and Phenolic Polyimide Resin having a Hydroxyl Group (A-1-1)

In the present invention, the polyimide resin having a hydroxyl group is used as the base polymer having a hydroxyl group, so that it is possible to obtain the photosensitive dry film resist, having superior heat resistance, being hardly damaged upon being bent, having a superior mechanical property, a superior electric insulation property, and superior chemical resistance. Particularly, the hydroxyl group is contained in the structure, so that it is possible to realize the water system development.

A weight-average molecular weight of the polyimide resin having a hydroxyl group may have any value as long as it is within the range explained in the description of the base polymer having a hydroxyl group. Particularly, a lower limit of the weight-average molecular weight is preferably 5000 or more, more preferably 10000 or more. Further, an upper limit of the weight-average molecular weight is preferably 100000 or less, more preferably 80000 or less, particularly preferably 50000 or less.

Further, a hydroxyl equivalent of the polyimide resin having a hydroxyl group may have any value as long as it is within the range explained in the description of the base polymer having a hydroxyl group. Particularly, the hydroxyl equivalent is preferably 5000 or less, more preferably 3000 or less, still more preferably 1000 or less.

A specific kind of the polyimide resin having a hydroxyl group according to the present invention is not particularly limited. However, in the present invention, particularly a polyimide resin partially made of phenolic derivative having an amino group is favorably used as a first example. The phenolic derivative having an amino group is a compound arranged so that: (i) two or more phenolic compounds bond to each other via an atom or an atom group in a catenulate manner; and (ii) each of the phenolic compounds positioned in both ends has such structure that one of the hydrogen atoms of a benzene ring is substituted by an amino group.

More specifically, an example of the phenolic derivative having an amino group is a compound represented by the following formula (1) 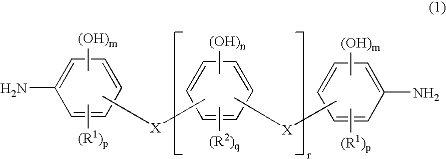
where R¹ and R² may be identical with or different from each other, and each of R¹ and R² represents a hydrogen atom, an alkyl group containing 1 to 9 carbon atoms in its molecule, an alkoxy group containing 2 to 10 carbon atoms in its molecule, or COOR³ (R³ represents a hydrogen atom or an alkyl group containing 1 to 9 carbon atoms in its molecule), and X represents —O—, —S—, —SO₂—, —C(CH₃)₂—, —CH₂—, —C(CH₃)(C₂H₅)—, or C(CF₃)₂—, and each of m and p is an integer not less than 0 which is under such condition that m+p=4, and each of n and q is an integer not less than 0 which is under such condition that n+q=4, and r is any one of integers 0 to 10.

Thus, a preferable example of the base polymer having a hydroxyl group (particularly, the polyimide resin (A-1)) according to the present invention is a polyimide resin (i.e., the phenolic polyimide resin having a hydroxyl group (A-1-1)) having at least one recurring unit represented by the following formula (2) 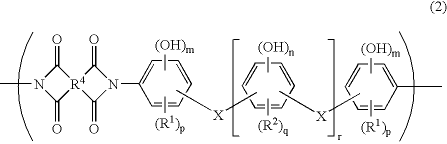
where R¹ and R² may be identical with or different from each other, and each of R¹ and R² represents a hydrogen atom, an alkyl group containing 1 to 9 carbon atoms in its molecule, an alkoxy group containing 2 to 10 carbon atoms in its molecule, or COOR³ (R³ represents a hydrogen atom or an alkyl group containing 1 to 9 carbon atoms in its molecule), and X represents —O—, —S—, —SO₂—, —C(CH₃)₂—, —CH₂—, —C(CH₃)(C₂H₅)—, or C(CF₃)₂—, and R⁴ represents a residual of aromatic tetra carboxylate dianhydride, and each of m and p is an integer not less than 0 which is under such condition that m+p=4, and n and q are under such condition that n+q=4, and n is an integer not less than 0 and q is an integer not less than 0, and r is any one of integers 0 to 3.

When the polyimide resin having a hydroxyl group is used as the component (A) (base resin component), it is possible to improve the solubility of the obtained photosensitive dry film resist with respect to alkaline aqueous solution. Further, various kinds of the polyimide resin having a hydroxyl group can be used, but a single kind of the polyimide resin having a hydroxyl group may be used, or a combination of two or more types may be used as appropriate.

Note that, it is preferable that the polyimide resin having a hydroxyl group used in the present invention dissolves in organic solvent. That is, it is preferable that the polyimide resin having a hydroxyl group used in the present invention has not only the hydroxyl group but also a structure which allows the polyimide resin having a hydroxyl group to dissolve in various kinds of organic solvent. The organic solvent is not particularly limited, but examples thereof include: formaldehyde solvent such as N,N-dimethylformaldehyde and N,N-diethylformaldehyde; and ether solvent such as 1,4-dioxane, 1,3-dioxolan, and tetrahydrofuran.

The solubility with respect to the organic solvent is specifically as follows: the solubility with respect to 100 g of the organic solvent is preferably 1.0 g or more at 20° C., more preferably 5.0 g or more at 20° C., still more preferably 10 g or more at 20° C. Note that, when the solubility of the polyimide resin having a hydroxyl group with respect to 100 g of the organic solvent is 1.0 g or less at 20° C., it is difficult to form the photosensitive film layer so as to have a desired thickness.

<Production Method of Polyimide Resin having a Hydroxyl Group>

The polyimide resin having a hydroxyl group can be made of its precursor, polyamide acid (polyamic acid). The polyamide acid can be synthesized by reacting diamine with acid dianhydride in the organic solvent.

Specifically, diamine is dissolved in the organic solvent in an inert atmosphere such as argon and nitrogen. Alternatively, diamine is diffused in a slurry manner so as to prepare a diamine solution. The polyamide acid is produced by adding and reacting acid dianhydride with the diamine solution under such condition that the acid dianhydride is dissolved in the organic solvent or is diffused in a slurry manner or under such condition that the acid dianhydride is in a solid state.

A synthesis condition under which the diamine and the acid dianhydride are reacted with each other is not particularly limited. However, for example, a temperature condition is preferably 80° C. or lower, more preferably 0 to 50° C. Further, a reaction time may be arbitrarily set within a range from 30 minutes to 50 hours.

The organic solvent used in the synthesis reaction of the polyimide acid is not particularly limited as long as the organic solvent is organic polar solvent. Particularly, it is preferable to select organic polar solvent, being capable of dissolving polyamide acid, whose boiling point is as low as possible.

With generation of polyamide acid which results from promotion of reaction between the diamine and the acid dianhydride, the viscosity of the reaction liquid rises. Further, as will be described later, polyamide acid solution obtained by synthesizing polyamide acid is heated under a reduced pressure and the solution is imidized at the same time as removal of the organic solvent. Thus, it is advantageous in terms of the production step to select organic polar solvent, being capable of dissolving the polyamide acid, whose boiling point is as low as possible.

Specific examples of the organic polar solvent include: formamide solvent such as N,N-dimethylformamide; acetamide solvent such as N,N-dimethylacetamide; pyrrolidone solvent such as N-methyl-2-pyrrolidone and N-vinyl-2-pyrrolidone; ether solvent such as tetrahydrofuran, dioxane, and dioxolan; and the like. A single organic polar solvent may be used, or a suitable combination of two or more kinds may be used.

Further, an average molecular weight of polyamide acid to be synthesized is preferably within a range of from 1000 to 100000. When the average molecular weight is less than 1000, also a molecular weight of the polyimide resin finally generated by using polyamide acid becomes lower. Thus, even when the polyimide resin is used without any modification, the obtained photosensitive film layer is likely to be brittle. While, when the average molecular weight exceeds 100000, the viscosity of the obtained polyamide acid solution is likely to rise. As a result, the easiness to treat the polyamide acid solution may drop.

<Material 1 for Polyimide Resin having a Hydroxyl Group Diamine>

The diamine used to synthesize the polyamide acid is not particularly limited. However, in order to realize the water system development described later, it is preferable that diamine having one or more hydroxyl groups in its molecule is used as at least a part of the material. Further, in terms of the heat resistance and the chemical resistance, it is preferable that aromatic diamine having one or more aromatic rings in its molecule is used as at least a part of the material. Further, it is more preferable that aromatic diamine having one or more hydroxyl groups in its molecule is used as at least a part of the material. On this account, it is possible to give the heat resistance and the water system developing property to the obtained photosensitive dry film resist. As will be detailed later, the water system development means a condition under which it is possible to carry out the development with alkaline aqueous solution.

An example of the diamine favorably used to synthesize the polyimide acid in the present invention is an phenolic derivative having an amino group represented by the aforementioned formula (1). In the present invention, it is preferable that the phenolic derivative having an amino group is used as a part of the material (that is, the material for polyamide acid serving as the precursor) of the polyimide resin having a hydroxyl group.

Further, it is particularly preferable to arrange the phenolic derivative having an amino group used in the present invention so that: in the formula (1), each of R¹ and R² is a hydrogen atom (H). Further, it is particularly preferable to arrange the phenolic derivative having an amino group so that: in the formula (1), each of m and n is 1 or 2. Further, as to the phenolic derivative having an amino group, in the formula (1), it is preferable that r is any one of integers 0 to 5, and it is more preferable that r is any one of integers 0 to 2.

The phenolic derivative having an amino group is not particularly limited as long as it is the phenolic derivative including any amino group. However, specific examples of the phenolic derivative having an amino group include compounds such as 2,2′-diaminobisphenol A, 2,2′-bis(3-amino-4-hydroxyphenil)hexafluoropane, bis(2-hydroxy-3-amino-5-methylphenyl)methane, 2,6-di{(2-hydroxy-3-amino-5-methylphenyl)methyl}-4-methyl phenol, 2,6-di{2-hydrox-3-amino-5-methylphenyl)methyl}-4-hydroxy benzoic acid propyl, and the like. These compounds may be independently used, or a suitable combination of two or more kinds may be used.

An example of a constitutional formula of the phenolic derivative having an amino group particularly preferably used in the present invention is the following compound group. Of course, the present invention is not limited to these compounds.

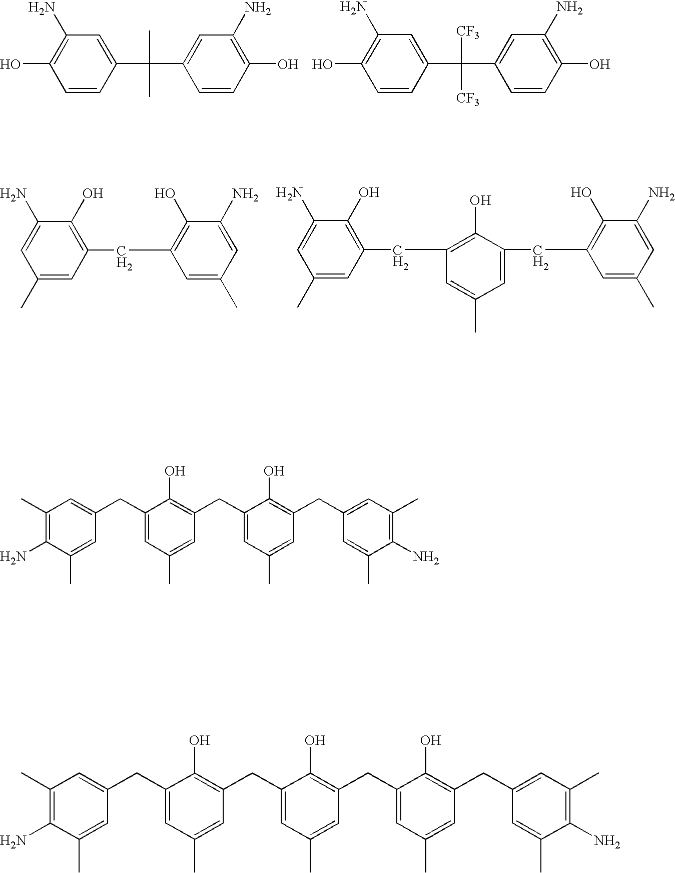

Further, in the present invention, not only the diamine having the hydroxyl group but also other diamine may be simultaneously used as a part of the material. Specific examples of other diamine are compounds such as: bis[4-(3-aminophenoxy)phenyl]sulfone; reactive silicone having an amino group in each end of a siloxane structure (hereinafter, the reactive silicone is referred to as silicon diamine); and [bis(4-amino-3-carboxy)phenyl]methane. However, the diamine is not limited to them. These diamines may be independently used, or a suitable combination of two or more kinds may be used.

<Material 2 for Polyimide Resin having a Hydroxyl Group: Acid Dianhydride>

The acid dianhydride used to synthesize the polyamide acid is not particularly limited as long as the acid dianhydride has a carboxyl group, that is, as long as the acid dianhydride is carboxylate dianhydride. However, in order to improve the heat resistance, it is preferable to use acid dianhydride having 1 to 4 aromatic rings or alicyclic acid dianhydride. Further, in order to obtain a polyimide resin whose solubility with respect to organic solvent is high, it is preferable to use at least a part of acid dianhydride having two or more aromatic rings, and it is more preferable to use at least a part of acid dianhydride having four or more aromatic rings.

The acid dianhydride is not particularly limited as long as the acid dianhydride is carboxylic acid dianhydride, but specific examples of the acid dianhydride include: aliphatic or alicyclic tetra carboxylate dianhydride such as butane tetra carboxylate dianhydride and 1,2,3,4-cyclobutane tetra carboxylate dianhydride; aromatic tetra carboxylate dianhydride such as pyromellitic acid dianhydride, 3,3′,4,4′-benzophenone tetra carboxylate dianhydride, and 3,3′,4,4′-biphenylsulfone tetra carboxylate dianhydride; and aliphatic tetra carboxylate dianhydride having aromatic rings such as 1,3,3a,4,5,9b-hexahydro-2, 5-dioxo-3-furanyl)-naptho[1,2-c]furan-1, and 3-dione. The acid dianhydride may be independently used, or a suitable combination of two or more kinds may be used.

As the acid dianhydride, particularly, it is preferable to use a part of the acid dianhydride, having two or more aromatic rings, such as 2,2′-bis(4-hydroxyphenyl)propane dibenzoate-3,3′,4,4′-tetra carboxylate dianhydride, 2,3′,3,4′-biphenylether tetra carboxylate dianhydride, and 3,4,4′-biphenylether tetra carboxylate dianhydride.

In case of synthesizing polyamide acid by using the diamine and the acid dianhydride, at least one kind of the diamine and at least one kind of the acid dianhydride are reacted with each other. That is, for example, a diamine component containing an phenolic derivative having an amino group (diamine containing a hydroxyl group) as at least a part thereof and the acid dianhydride are used so as to carry out polymerization reaction in the organic solvent as described above, thereby obtaining polyamide acid containing a hydroxyl group in its molecular chain.

At this time, if one kind of diamine and one kind of acid dianhydride are substantially equal with each other in terms of mol, polyamide acid containing one kind of acid dianhydride component and one kind of diamine component is obtained. Further, in case of using two or more kinds of acid dianhydride components and two or more kinds of diamine components, a molar ratio of plural diamine components and a molar ratio of plural acid dianhydride components are adjusted to be substantially equal with each other in terms of mol, thereby intentionally obtaining a polyamide acid copolymer.

<Imidization of Polyamide Acid>

The polyimide resin having a hydroxyl group used in the present invention is obtained by imidizing the polyamide acid having been synthesized in the foregoing manner. The polyamide acid is imidized by ring closure based on dehydration. The ring closure based on dehydration can be carried out, for example, by (i) an azeotropy process using an azeotropic solvent, (ii) a thermal process, or (iii) a chemical process.

The azeotropy process using azeotropic solvent is specifically such that: an azeotropic solvent such as toluene and xylene is added to polyamide acid solution and thus obtained resultant is heated, thereby positively exclude water to the outside the system.

The thermal process for causing the ring closure based on dehydration may be carried out by heating the polyamide acid solution. Alternatively, it may be so arranged that: the polyamide acid solution is made to flow in a spreading manner on or is applied to a film-shape support such as a glass plate, a metal plate, a PET (polyethylene terephthalate), and the like, and then the film-shape support is heated at a temperature ranging from 80° C. to 300° C. Further, it is also possible to carry out the ring closure based on dehydration with respect to polyamide acid by performing such an operation that: the polyamide acid solution is poured directly into a container having been subjected to a mold releasing process such as coating with a fluorine resin, and the container is dried by heating under a reduced pressure. The ring closure based on dehydration is carried out with respect to polyamide acid in accordance with the thermal process, so that it is possible to obtain the polyimide resin.

Note that, a heating time in each process varies depending on an amount of the polyamide acid solution to be subjected to the ring closure based on dehydration and a temperature at which the polyamide acid solution is heated. Generally, it is preferable to heat the polyamide acid solution for a period of time ranging from one minute to five hours after the process temperature has reached the maximum temperature.

While, the chemical process for causing the ring closure based on dehydration may be carried out by performing such operation that: a dehydrating agent and, if it is necessary, tertiary amine whose amount is suitable as a catalyst are added to the polyamide solution, and thus obtained resultant is heated (the-resultant is imidized); Note that, this heating process is a process based on the foregoing thermal process. On this account, it is possible to obtain the polyimide resin.

As the dehydrating agent used in the chemical process, acid anhydride such as acetic anhydride and propionic acid anhydride is generally used, but the dehydrating agent is not particularly limited. Further, as the tertiary amine, pyridine, isoquinoline, triethylamine, trimethylamine, imidazole, picoline, and the like may be used, but the tertiary amine is not particularly limited to these compounds.

Note that, the polyimide resin used in the present invention has a phenolic hydroxyl group, so that the acid anhydrate added as the dehydrating agent may react with the hydroxyl group. Therefore, in terms of stoichiometry, it is preferable to set an amount of the acid anhydride used to a minimum amount required in imidizing the solution.

In order to give more reactivity and the curing property to the polyimide resin having a hydroxyl group obtained in the foregoing manner, a compound having an epoxy group reactive with soluble polyimide is used, thereby introducing various functional groups. Here, the compound having an epoxy group is a compound having two or more functional groups selected from an epoxy group, a carbon-carbon triple bond, and a carbon-carbon double bond, as a photo polymerization group and/or a thermally polymerizable functional group.

Thus, the functional group introduced in order to give the reactivity and the curing property to the polyimide resin having a hydroxyl group is at least two or more functional groups selected from the epoxy group, the carbon-carbon triple bond, and the carbon-carbon double bond. The functional groups serve as a photo polymerization group and/or a thermally polymerizable functional group. The polyimide resin having a hydroxyl group obtained by introducing the photo polymerization group and/or the thermally polymerizable functional group having been obtained in this manner has favorable curing property and adhesiveness.

Further, in order to improve (i) the adhesiveness with respect to the print substrate or the pattern circuit and (ii) easiness to process in adhesion, not only the polyimide resin having a hydroxyl group but also other resin may be additionally used. Such a resin is not particularly limited. However, examples thereof include: thermosetting resins such as an epoxy resin, an acryl resin, a cyanate ester resin, a bismaleimide resin, a bisallylnadiimide resin, and a phenolic resin; thermoplastic resins such as polyester, polyamide, polyurethane, and polycarbonate; and the like. In case of combining these resins with the hydroxy polyimide, these resins may be independently used, or a suitable combination of two or more kinds may be used.

### (I-2) Photosensitive Polyimide Resin (A-1-2)

In the present invention, a second example of the base resin component (A) is a photosensitive polyimide resin (A-1-2) among polyimide resin having a hydroxyl groups. The photosensitive polyimide resin (A-1-2) is obtained by reacting a compound having a carbon-carbon double bond with a hydroxyl group in the polyimide resin having a hydroxyl group, and the hydroxyl group remains in this resin. In the photosensitive polyimide resin, a photosensitive group is introduced due to a covalent bond, so that the curing property of an exposed portion is excellent. Further, the photosensitive polyimide resin has been imidized, so that it is not necessary to perform post bake at a high temperature, and its volume is less constricted in the dehydration reaction caused by ring closure in imidizing the resin, thereby obtaining superior resolution.

Specifically, the photosensitive polyimide resin (A-1-2) includes at least one recurring unit represented by the following formula (5) 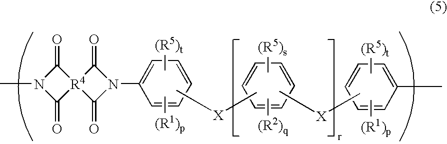
where R¹ and R² may be identical with or different from each other, and each of R¹ and R² represents a hydrogen atom, an alkyl group containing 1 to 9 carbon atoms in its molecule, an alkoxy group containing 2 to 10 carbon atoms in its molecule, or COOR³ (R³ represents a hydrogen atom or an alkyl group containing 1 to 9 carbon atoms in its molecule), and X represents —O—, —S—, —SO₂—, —C(CH₃)₂—, —CH₂—, —C(CH₃)(C₂H₅)—, or C(CF₃)₂—, and R⁵ represents a residual of aromatic tetra carboxylate dianhydride, and all of R⁵ may be identical with or different from each other, and each R⁵ represents —OH or an unsaturated organic group containing a carbon-carbon double bond in its structure, each R⁵ includes both —OH and the unsaturated organic group, a number of —OH or the unsaturated organic group being at least one, and each of t and p is an integer not less than 0 which is under such condition that t+p=4, and each of s and q is an integer not less than 0 which is under such condition that s+q=4, and r is any one of integers 0 to 10.

Note that, the unsaturated organic group included in R⁵ is an organic group selected from the following group (4) 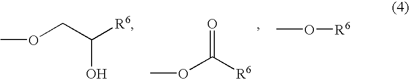
where R⁶ is a monovalent organic group having a carbon-carbon double bond.

The photosensitive polyimide resin (A-1-2) is basically arranged in the same manner as in the phenolic polyimide resin having a hydroxyl group (A-1-1), but its molecule includes at least one phenolic hydroxyl group and at least one photosensitive group having a carbon-carbon double bond. Thus, it is possible to further improve the solubility with respect to the alkaline aqueous solution and the curing property.

A weight-average molecular weight of the photosensitive polyimide resin (A-1-2) is within the range explained in the description of the base polymer having a hydroxyl group. Particularly, the weight-average molecular weight preferably ranges from 5000 to 200000, more preferably from 10000 to 100000. When the weight-average molecular weight is less than 5000, the obtained photosensitive dry film resist is likely to be cloggy, and the cured film is likely to be damaged upon being bent. While, when the weight-average molecular weight exceeds 200000, the viscosity of the photosensitive polyimide resin (A-1-2) becomes too high upon preparing the photosensitive polyimide resin (A-1-2) as organic solvent solution, so that it is likely to be hard to treat the photosensitive polyimide resin (A-1-2). Further, the developing property of the obtained photosensitive dry film resist may drop. Note that, the hydroxyl equivalent is within the range explained in the description of the base polymer having a hydroxyl group.

A method for synthesizing the photosensitive polyimide resin (A-1-2) is not particularly limited. However, specifically, it is possible to synthesize the photosensitive polyimide resin (A-1-2) by reacting a compound having a carbon-carbon double bond with the polyimide resin having a hydroxyl group for example.

<Introduction of Photosensitive Group into Hydroxyl Group of Polyimide Resin having a Hydroxyl Group>

In order to give the photosensitive property to the polyimide resin having a hydroxyl group obtained in the foregoing manner, the photosensitive polyimide resin (A-1-2) used as one of the base polymer having a hydroxyl groups is synthesized by reacting a compound having a carbon-carbon double bond. The compound having a carbon-carbon double bond is not particularly limited as long as the compound reacts with the phenolic hydroxyl group in the polyimide resin having a hydroxyl group. However, examples thereof include an epoxy compound having a carbon-carbon double bond, (meth)acrylate anhydride, and allyl halide such as allyl bromide.

For example, in case of reacting an epoxy compound having a carbon-carbon double bond with the polyimide resin having a hydroxyl group (hereinafter, the epoxy compound is referred to as a double bond epoxy resin for convenience in description), it is possible to adopt, for example, a method in which the polyimide resin having a hydroxyl group and the double bond epoxy compound are reacted with each other, in the presence of organic bases such as pyridine and triethylamine, in an inert solvent. On this account, it is possible to obtain the desired photosensitive polyimide resin (A-1-2).

It is preferable that the reaction temperature is in a temperature range in which the epoxy group and the hydroxyl group react with each other, that is, in a temperature range of from 40° C. or higher to 130° C. or lower. In this temperature range, it is preferable to carry out the reaction particularly at a temperature at which reaction such as polymerization of the carbon-carbon double bond is not caused by heat. Specifically, the reaction is carried out more preferably within a temperature range of from 40° C. or higher to 100° C. or lower, still more preferably within a temperature range of from 50° C. or higher to 80° C. or lower. Further, the reaction time can be suitably set, and is not particularly limited. However, it is general that the reaction time ranges from about one hour to about 20 hours.

The photosensitive polyimide resin (A-1-2) obtained by the foregoing reaction is used in a state corresponding to purpose of use. For example, reaction solution after the reaction may be used without any modification, or may be used after being purified through deposition in alcohol solvent such as methanol and the like. Further, rinse may be carried out with alcohol solvent as required.

The double bond epoxy compound is not particularly limited as long as the compound has the epoxy group and the carbon-carbon double bond in its same molecule. However, specific examples of the double bond epoxy compound include: glycidyl acrylate, glycidyl methacrylate, allyl glycidyl ether, glycidyl vinyl ether, and the like. Among them, it is particularly preferable to use glycidyl methacrylate since glycidyl methacrylate can be easily purchased at low cost and has a favorable reaction property.

Further, in case of reacting the polyimide resin having a hydroxyl group with the (meth)acrylate anhydride, it is possible to adopt, for example, a method in which the hydroxyl group in the polyimide resin having a hydroxyl group is condensed with the (meth)acrylate anhydride, in the presence of organic bases such as pyridine and triethylamine, in an inert solvent. On this account, it is possible to obtain the desired photosensitive polyimide resin (A-1-2).

It is preferable that the reaction temperature is in a temperature range in which the hydroxyl group in the polyimide resin having a hydroxyl group can be made into acyl. Specifically, it is preferable to carry out the reaction in a temperature range of from 0° C. or higher to 100° C. or lower. In this temperature range, it is preferable to carry out the reaction at a temperature at which reaction such as polymerization of the carbon-carbon double bond is not caused by heat. Specifically, the reaction is carried out more preferably within a temperature range of from 10° C. or higher to 100° C. or lower, still more preferably within a temperature range of from 20° C. or higher to 80° C. or lower. Further, the reaction time can be suitably set, and is not particularly limited. However, it is general that the reaction time ranges from about one hour to about 20 hours.

It is preferable to purify the reaction solution, obtained by the foregoing reaction, through deposition in alcohol solvent such as methanol and the like. On this account, it is possible to remove (meth)acrylate generated by the reaction. Note that, rinse may be carried out with an alcohol solvent as required.

Further, in case of reacting the polyimide resin having a hydroxyl group with the allyl halide, it is possible to adopt, for example, a method in which a polyimide resin having a hydroxyl group is reacted with the allyl halide, in the presence of organic bases such as pyridine and triethylamine, in an inert solvent. On this account, it is possible to obtain the desired photosensitive polyimide resin (A-1-2).

It is preferable to carry out the reaction within a temperature range of from 0° C. or higher to 100° C. or lower which allows the reaction. In this temperature range, it is particularly preferable to carry out the reaction at a temperature at which reaction such as polymerization of the carbon-carbon double bond is not caused by heat. Specifically, the reaction is carried out more preferably within a temperature range of from 0° C. or higher to 80° C. or lower, still more preferably within a temperature range of from 20° C. or higher and 50° C. or lower. Further, the reaction time can be suitably set, and is not particularly limited. However, it is general that the reaction time ranges from about one hour to about 20 hours.

It is preferable to purify the reaction solution, obtained by the foregoing reaction, through deposition in alcohol solvent such as methanol and the like. Note that, rinse may be carried out with an alcohol solvent as required.

In a reaction with any one of the aforementioned compounds, it is extremely preferable to leave the hydroxyl group in the photosensitive polyimide resin (A-1-2) in order to keep the developing property with respect to the alkaline aqueous solution after introducing the photosensitive group. Thus, the photosensitive polyimide resin (A-1-2) can be included in the polyimide resin having a hydroxyl group (A-1).

Here, in order to leave the hydroxyl group in the photosensitive polyimide resin, hydrocyl groups in the structure are not entirely reacted, but a value indicative of an equivalent of the compound having the carbon-carbon double bond to be reacted is adjusted so that the hydroxyl groups remain. Specifically, it is preferable to carry out the adjustment so that the hydroxyl equivalent of the reacted photosensitive polyimide resin is 10000 or less.

Further, in a reaction with any one of the aforementioned compounds, it is preferable to add a polymerization inhibitor so as to prevent the carbon-carbon double bond from causing polymerization during the reaction. The polymerization inhibitor is not particularly limited, but specific examples of the polymerization inhibitor include: hydroquinone derivative such as p-methoxyphenol; phenothiazine; and N-nitrohydroxylamic salts.

### (I-3) Soluble Polyimide Resin (A-1-3)

In the present invention, it is possible to use, as a third example of the base resin component (A), a soluble polyimide resin, having the polymerizable functional group (A-1-3) and a hydroxy hydrophilic group (a carboxyl group and/or a hydroxyl group). The soluble polyimide resin (A-1-3) includes particularly a storage stabilization additive (D), and is favorably used as the base resin component (A) of a photosensitive resin composition which is superior in the storage stability.

The “solubility” of the soluble polyimide resin (A-1-3) is not particularly limited as long as the resin dissolves in an organic solvent. More specifically, with respect to 100 g of the organic solvent, the solubility of the soluble polyimide resin is preferably 1.0 g or more at 20° C., more preferably 5.0 g or more at 20° C., still more preferably 10 g or more at 20° C. When the solubility with respect to 100 g of the organic solvent is less than 1.0 g at 20° C., it may be difficult to form the photosensitive dry film resist film having a desired thickness.

The organic solvent is not particularly limited, but specific examples of the organic solvent include: formaldehyde solvent such as N,N-dimethylformaldehyde and N,N-diethylformaldehyde; and ether solvent such as 1,4-dioxane, 1,3-dioxolan, and tetrahydrofuran.

Particularly, in the soluble polyimide resin (A-1-3), it is preferable that the solubility with respect to 100 g of tetrahydrofuran is 1.0 g or more at 20° C. in order to obtain the photosensitive dry film resist having a certain thickness.

Further, a weight-average molecular weight of the soluble polyimide resin (A-1-3) is in the range explained in the description of the base polymer having a hydroxyl group. However, a lower limit of the weight-average molecular weight is preferably 5000 or more, more preferably 10000 or more. While, an upper limit of the weight-average molecular weight is preferably 100000 or less, more preferably 80000 or less, particularly preferably 50000 or less.

When the weight-average molecular weight is less than 5000, the obtained photosensitive dry film resist is likely to be cloggy, treatability of the film drops, and the cured film is likely to be damaged upon being bent. While, when the weight-average molecular weight exceeds 100000, the viscosity of the organic solvent solution (varnish) of the soluble polyimide resin becomes too high, so that it is likely to be hard to treat the varnish. Further, the developing property of the obtained photosensitive dry film resist is likely to drop.

A method for synthesizing the soluble polyimide resin (A-1-3) is not particularly limited. However, specifically, it is possible to synthesize the soluble polyimide resin (A-1-3) by synthesizing a soluble polyimide resin having hydroxylic hydrophilicity and denaturating it. In the following description, first, a method for producing the soluble polyimide resin having hydroxylic hydrophilicity is explained, and a denaturation method thereof is then explained. Note that, for convenience in description, the soluble polyimide resin having hydroxylic hydrophilicity is referred to as a precursor soluble polyimide resin as required.

<Soluble Polyimide Resin having Hydroxylic Hydrophilicity>

The precursor soluble polyimide resin can be obtained from polyamide acid, serving as its precursor, as in the polyimide resin having a hydroxyl group serving as the precursor of the polyimide resin having a hydroxyl group (A-1). The polyamide acid is synthesized by reacting diamine with acid dianhydride in an organic solvent.

Specifically, in an inert atmosphere such as argon and nitrogen, diamine is dissolved in the organic solvent, or is diffused in a slurry manner, thereby preparing diamine solution. The polyamide acid is produced by adding acid dianhydride to the diamine solution under such condition that the acid dianhydride is dissolved in the organic solvent or is diffused in a slurry manner, or under such condition that the acid dianhydride is in a solid phase, and by reacting them with each other.

A synthesis condition under which the diamine and the acid dianhydride are reacted with each other (synthesis reaction of polyamide acid) is not particularly limited, but for example a temperature condition is preferably 80° C. or lower, more preferably ranges from 0 to 50° C., in order to suppress drastic rise in the viscosity of the reaction solution. Further, reaction time may be arbitrarily set within a range of from 30 minutes to 50 hours.

The organic solvent used in the synthesis reaction of the polyimide acid is not particularly limited as long as the organic solvent is organic polar solvent. Particularly, as the organic polar solvent, it is preferable to select organic polar solvent which can dissolve polyamide acid and whose boiling point is low.

With generation of polyamide acid which is caused by promotion of reaction between the diamine and acid dianhydride, the viscosity of the reaction solution rises. Further, as will be described later, polyamide acid solution obtained by synthesizing polyamide acid is heated under a reduced pressure, and thus obtained resultant is imidized at the same time as removal of the organic solvent. Thus, it is advantageous in terms of production steps to select organic polar solvent which can dissolve polyamide acid and whose boiling point is low.

Specific examples of the organic polar solvent include: formamide solvent such as N,N-dimethylformamide; acetamide solvent such as N,N-dimethylacetamide; pyrrolidone solvent such as N-methyl-2-pyrrolidone and N-vinyl-2-pyrrolidone; ether solvent such as tetrahydrofuran, dioxane, and dioxolan; and the like. These organic polar solvents may be independently used, or a suitable combination of two or more kinds may be used.

Further, an average molecular weight of polyamide acid to be synthesized is preferably within a range of from 1000 to 100000. When the average molecular weight is less than 1000, also a molecular weight of the polyimide resin finally generated by using polyamide acid becomes lower. Thus, even when the polyimide resin is used without any modification, the obtained photosensitive film layer is likely to be brittle. While, when the average molecular weight exceeds 100000, the viscosity of the obtained polyamide acid solution is likely to rise. As a result, the easiness to treat the polyamide acid solution may drop.

<Material 1 for Polyimide Resin having a Hydroxyl Group: Diamine>

The diamine used to synthesize the polyamide acid is not particularly limited. However, in order to realize the water system development, it is preferable that diamine having one or more hydroxyl groups in its molecule is used as at least a part of the material. Further, in terms of the heat resistance and the chemical resistance, it is preferable that aromatic diamine having one or more aromatic rings in its molecule is used as at least a part of the material. Further, it is more preferable that aromatic diamine having one or more hydroxyl groups in its molecule is used as at least a part of the material. On this account, it is possible to give the heat resistance and the water system developing property to the obtained photosensitive dry film resist. As will be detailed later, the water system development means a condition under which it is possible to carry out the development with alkaline aqueous solution.

The diamine favorably used to synthesize the polyamide acid in the present invention is not particularly limited as long as the diamine is aromatic diamine having one or more hydroxy hydrophilic groups in its molecule. However, it is particularly preferable to use aromatic diamine represented by the following formula (8). 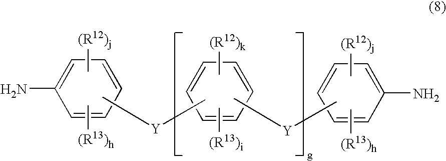
where R¹² represents a hydroxyl group or a carboxyl group, and R¹³ represents a hydrogen atom, an alkyl group containing 1 to 9 carbon atoms in its molecule, an alkoxy group containing 1 to 10 carbon atoms in its molecule, or —COOR³ (R³ represents a hydrogen atom or an alkyl group containing 1 to 9 carbon atoms in its molecule), and Y represents —O—, —CO—, —COO—, —SO₂—, —(single bond), —CH₂—, —C(CH₃)₂—, or —C(CF₃)₂—, and each of j and h is an integer not less than 0 which is under such condition that j+h=4, and each of k and i is an integer not less than 0 which is under such condition that k+i=4, and g is any one of integers 0 to 10.

Specific examples of the aromatic diamine having a carboxyl group include: diamino benzoic acid such as 3,5-diamino benzoic acid; carboxy biphenyl compounds such as 3,3′-diamino-4,4′-dicarboxybiphenyl, 4,4′-diamino-2,2′, and 5,5′-tetracarboxybiphenyl; carboxydiphenyl alkanes such as 4,4′-diamino-3,3′-dicarboxydiphenylmethane and 3,3′-diamino-4,4′-dicarboxydiphenylmethane; carboxy diphenylether compounds such as 4,4′-diamino-2,2′ and 5,5′-tetracarboxydiphenylether; diphenylsulfone compounds such as 3,3′-diamino-4,4′-dicarboxydiphenylsulfone; bis(hydroxy phenoxy)biphenyl compounds such as 2,2-bis[4-(4-amino-3-carboxyphenyl)phenyl]propane; bis[(-carboxyphenoxy)phenyl]sulfone compounds such as 2,2-bis[4-(4-amino-3-carboxy phenoxy)phenyl]sulfone; and the like.

An example of a constitutional formula of the aromatic diamine having a carboxyl group particularly preferably used in the present invention is the following compound group. Of course, the present invention is not limited to these compounds.

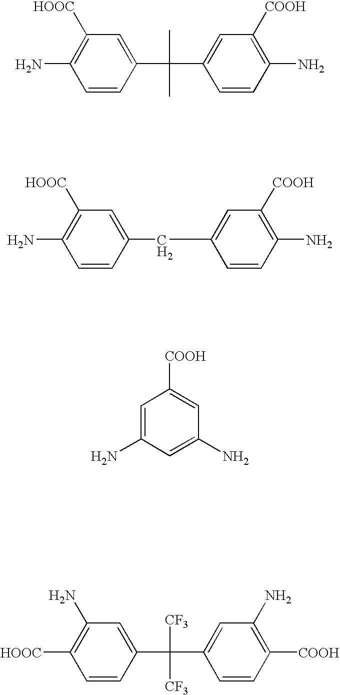

Further, the aforementioned aromatic diamine having a hydroxyl group is not particularly limited. However, specific examples of the aromatic diamine include compounds such as 2,2′-diaminobisphenol A, 2,2′-bis(3-amino-4-hydroxyphenyl)hexafluoropropane, bis(2-hydroxy-3-amino-5-methylphenyl)methane, 2,6-di{(2-hydroxy-3-amino-5-methylphenyl)methyl}-4-methylphenol, 2,6-di{(2-hydroxy-3-amino-5-methypphenyl)methyl}-4-hydroxybenzoic acid propyl, and the like.

An example of a constitutional formula of the aromatic diamine having a hydroxyl group particularly preferably used in the present invention is the following compound group. Of course, the present invention is not limited to these compounds.

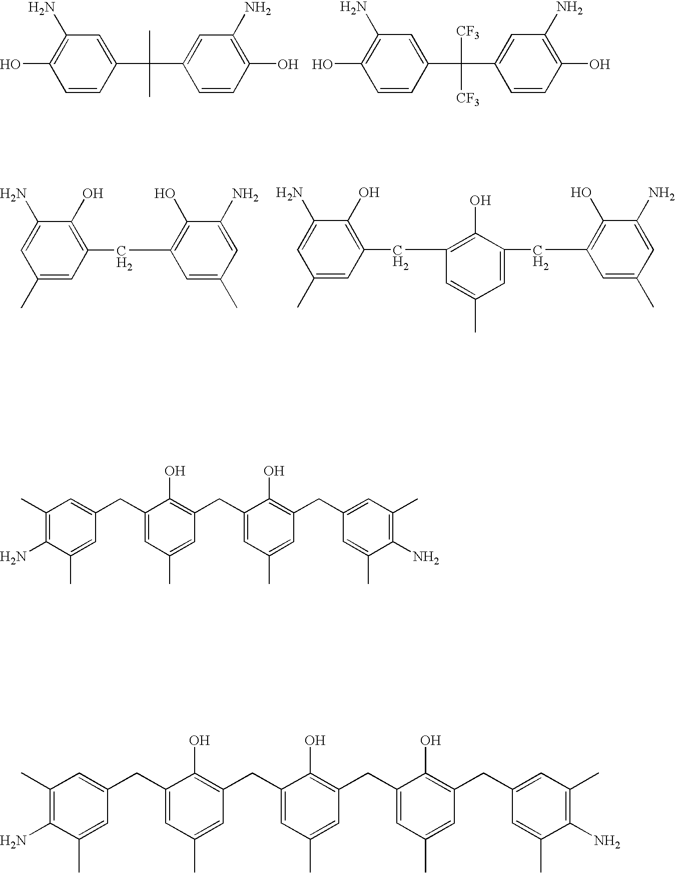

Further, in the present invention, not only the aromatic diamine having a hydroxy hydrophilic group but also other diamine may be simultaneously used as a part of the material. Specific examples of other diamine include compounds such as bis[4-(3-amino phenoxy)phenyl]sulfone, reactive silicone (silicon diamine) having an amino group in each end of its siloxane structure, [bis(4-amino-3-carboxy)phenyl]methane, and the like. However, other diamine is not particularly limited. Particularly, it is preferable to use silicon diamine since it is possible to drop the elastic mudulus of the film. Such other diamine may be independently used, or a suitable combination of two or more kinds may be used.

<Material 2 for Hydroxy Poyimide Resin: Acid Dianhydride>

The acid dianhydride used to synthesize the polyimide acid is not particularly limited as long as the acid dianhydride has a carboxyl group, that is, as long as the acid dianhydride is carboxylic acid dianhydride. However, it is preferable to use acid dianhydride having 1 to 4 aromatic rings or alicyclic acid dianhydride in order to improve the heat resistance. Further, in order to obtain a polyimide resin whose solubility with respect to organic solvent is high, it is preferable to use at least a part of acid dianhydride having two or more aromatic rings, and it is more preferable to use at least a part of acid dianhydride having four or more aromatic rings.

The acid dianhydride is not particularly limited as long as the acid dianhydride is carboxylic acid dianhydride, but specific examples of the acid dianhydride include: aliphatic or alicyclic tetracarboxylatedianhydride such as butanetetracarboxylatedianhydride and 1,2,3,4-cyclobutanetetracarboxylatedianhydride; aromatictetracarboxylatedianhydride such as pyromellitic acid dianhydride, oxydiphthalic acid dianhydride, biphenyl-,5,3′,5′-tetracarboxylatedianhydride, 3,3′,4,4′-benzophenonetetracarboxyladianhydride, and 3,3′,4,4′-biphenylsulfonetetracarboxylatedianhydride; and aliphatictetracarboxylicdianhydride having aromatic rings such as 1,3,3a,4,5,9b-hexahydro-2, 5-dioxo-3-furanyl)-naptho[1,2-c]furan-1, and 3-dione, and the like. The acid dianhydride may be independently used, or a suitable combination of two or more kinds may be used.

As the acid dianhydride, particularly, it is preferable to use a part of the acid dianhydride, having two or more aromatic rings, thereby obtaining higher heat resistance. Specific examples of the acid dianhydride, having two or more aromatic rings include 2,2′-bis(4-hydroxyphenyl)propane dibenzoate-3,3′,4,4′-tetra carboxylate dianhydride, 2,3′,3,4′-biphenylether tetra carboxylate dianhydride, and 3,4,4′-biphenylether tetra carboxylate dianhydride.

In case of synthesizing polyamide acid by using the diamine and the acid dianhydride, at least one kind of the diamine and at least one kind of the acid dianhydride are reacted with each other. That is, for example, a diamine component containing an phenolic derivative having an amino group (diamine containing a hydroxyl group) as at least a part thereof and the acid dianhydride are used so as to carry out polymerization reaction in the organic solvent as described above, thereby obtaining polyamide acid containing one or more hydroxyl group in its molecular chain.

At this time, one kind of diamine and one kind of acid dianhydride are substantially equal with each other in terms of mol, so that it is possible to obtain polyamide acid containing one kind of acid dianhydride component and one kind of diamine component; Further, in case of using two or more kinds of acid dianhydride components and two or more kinds of diamine components, a molar ratio of a total amount of plural diamine components and a molar ratio of a total amount of plural acid dianhydride components are adjusted to be equal with each other in terms of mol, thereby intentionally obtaining a polyamide acid copolymer.

<Imidization of Polyamide Acid>

The polyimide resin having a hydroxyl group used in the present invention is obtained by imidizing the polyamide acid having been synthesized in the foregoing manner. The polyamide acid is imidized by carrying out dehydration ring closure. The dehydration ring closure can be carried out, for example, by (i) an azeotropy process using an azeotropic solvent, (ii) a thermal process, or (iii) a chemical process.

The azeotropy process using azeotropic solvent is specifically such that: an azeotropic solvent such as toluene and xylene is added to polyamide acid solution and thus obtained resultant is heated, thereby positively exclude water to the outside the system.

The thermal process for causing the dehydration ring closure may be carried out by heating the polyamide acid solution. Alternatively, it may be so arranged that: the polyamide acid solution is made to flow in a spreading manner on or is applied to a film-shape support such as a glass plate, a metal plate, a PET (polyethylene terephthalate), and the like, and then the film-shape support is heated at a temperature ranging from 80° C. to 300° C. Further, it is possible to carry out the dehydration ring closure with respect to polyamide acid by performing such an operation that: the polyamide acid solution is poured directly into a container having been subjected to a mold releasing process such as coating with a fluorine resin, and the container is dried by heating under a reduced pressure. The dehydration ring closure is carried out with respect to polyamide acid in accordance with the thermal process, so that it is possible to obtain the polyimide resin.

Note that, a heating time in each process varies depending on an amount of the polyamide acid solution to be subjected to the dehydration ring closure and a temperature at which the polyamide acid solution is heated. Generally, it is preferable to heat the polyamide acid solution for a period of time ranging from one minute to five hours after the process temperature has reached the maximum temperature.

While, the chemical process for causing the dehydration ring closure may be carried out by performing such operation that: a dehydrating agent and, if necessary, tertiary amine whose amount is suitable as a catalyst are added to the polyamide solution, and thus obtained resultant is heated (the resultant is imidized). Note that, this heating process is a process based on the foregoing thermal process. On this account, it is possible to obtain the polyimide resin.

As the dehydrating agent used in the chemical process, acid anhydride such as acetic anhydride and propionic acid anhydride is generally used, but the dehydrating agent is not particularly limited. Further, as the tertiary amine, it is possible to use pyridine, isoquinoline, triethylamine, trimethylamine, imidazole, picoline, and the like, but the tertiary amine is not limited to these compounds.

Note that, the polyimide resin used in the present invention has a phenolic hydroxyl group, so that the acid anhydrate added as the dehydrating agent may react with the hydroxyl group. Therefore, in terms of stoichiometry, it is preferable to set an amount of the acid anhydride used to a minimum amount required in imidizing the solution.

In the precursor soluble polyimide resins obtained in the foregoing manner, a weight-average molecular weight of each carboxyl group of the precursor soluble polyimide resin having a carboxyl group (hereinafter, this weight-average molecular weight is referred to as a carboxyl group equivalent) is preferably 5000 or less, more preferably 3000 or less, most preferably 1000 or less. Further, a weight-average molecular weight of each hydroxyl group of the precursor soluble polyimide resin having a hydroxyl group (hereinafter, this weight-average molecular weight is referred to as a hydroxyl equivalent) is preferably 5000 or less, more preferably 3000 or less, most preferably 1000 or less.

In case where the carboxyl group equivalent or the hydroxyl equivalent exceeds 5000, when the photosensitive dry film resist is produced, it is likely to be difficult to realize the water system developing property of the photosensitive dry film resist using the soluble polyimide resin (A-1-3). The carboxyl group equivalent or the hydroxyl equivalent of the precursor soluble polyimide resin is calculated in accordance with a weight ratio between a molecular weight of material for the precursor soluble polyimide resin and an amount of the charged material.

<Denaturalization of Precursor Soluble Polyimide Resin>

The soluble polyimide resin (A-1-3) used as the base resin component (A) contains a polymerizable functional group so as to cause cross-linking reaction between the soluble polyimide resin (A-1-3) and the (meth)acryls compound (B), or so as to cause cross-linking reaction between molecules -of the soluble polyimide resin, in the exposure process described below (A-1-3). The polymerizable functional group can be synthesized by reacting the precursor soluble polyimide resin with a compound having the polymerizable functional group and by denaturalizing thus obtained resultant.

The polymerizable functional group is not particularly limited. However, in terms of easiness to obtain a material and reactivity, it is preferable to use at least one or more kinds of functional groups selected from a vinyl group, an acrylyl group, and a methacrylic group. Of course, the soluble polyimide resin (A-1-3) used in the present invention may include not only the aforementioned functional groups but also other functional group having a carbon-carbon unsaturated bond.

The denaturalization method is not particularly limited as long as not only the polymerizable functional group but also a functional group which can react with a hydroxyl group and/or a carboxyl group contained in the precursor soluble polyimide resin is included as the compound having the polymerizable functional group. Specifically, for example, it is possible to use a compound, having an epoxy group in its molecule, which has at least one or more functional groups selected from a vinyl group, an acrylyl group, and a methacrylic group. The compound is not particularly limited, but specific examples thereof include glycidyl methacrylate, glycidyl acrylate, glycidyl vinyl ether, allyl glycidyl ether, and the like.

Further, a specific example of a compound (other than the vinyl group, the acrylyl group, and the methacrylic group) having a carbon-carbon unsaturated bond is a compound having an epoxy group in its molecule and having a carbon-carbon triple bond. The compound is not particularly limited, but specific examples thereof include propargyl glycidyl ether, glycidyl propionate, ethynyl glycidyl ether, and the like.

Thus obtained soluble polyimide resin (A-1-3) has favorable curing property and adhesiveness.

### (I-4) Polyamide Resin having a Hydroxyl Group

In the present invention, it is possible to use a polyamide resin having a hydroxyl group (this polyamide resin is referred to as a polyamide resin having a hydroxyl group), instead of the polyimide resin having a hydroxyl group, as the base polymer having a hydroxyl group. By using the polyamide resin having a hydroxyl group, it is possible to obtain a photosensitive dry film resist which is superior in an anti-hydrolysis property. Also, a hydroxyl group is contained in its structure, so that it is possible to realize the water system development.

The polyamide resin having a hydroxyl group is not particularly limited. These polyamide resin having a hydroxyl groups may be independently used, or a suitable combination of two or more kinds may be used. Further, in the present invention, the polyimide resin having a hydroxyl group and the polyamide resin having a hydroxyl group may be used together as the base polymer having a hydroxyl group.

(I-5) Photosensitive imide(meth)acryl Siloxane Oligomer (A-3)

In the present invention, it is possible to use photosensitive imide(meth)acryl siloxane oligomer (A-3), instead of the base polymer, as the base resin component (A). The photosensitive imide(meth)acryl siloxane oligomer (A-3) includes an imide structure (—N(CO)₂—), a siloxane (silicone) structure (—SiO—), and a (meth)acryl structure (—CH₂═CR¹⁴(COO—): R¹⁴ is a hydrogen atom or a methyl group), and its polymerization degree is lower than that of general polyimide polymer. Note that, in the following description, imide(meth)acryl siloxane oligomer is referred to as IMASO for convenience in description.

The photosensitive IMASO (A-3) is obtained by reacting imide siloxane oligomer with an epoxy compound having a double bond, and the imide siloxane oligomer is obtained by reacting diamine with tetracarboxyliatedianhydride and by imidizing thus obtained resultant. That is, in the present invention, first, imide siloxane oligomer is synthesized, and thus synthesized imide siloxane oligomer is reacted with an epoxy compound having a double bond, thereby synthesizing the photosensitive IMASO (A-3). Note that, the imide siloxane oligomer is, too, referred to as ISO for convenience in description.

Diamine and tetracarboxylatedianhydride are reacted with each other, so that polyamide acid (polyamic acid) which is a precursor of polyimide is synthesized, and the polyamide acid is imidized, thereby obtaining polyimide. Also the photosensitive IMASO (A-3) in the present invention is synthesized basically in accordance with this process. However, for convenience in making it clearer that the oligomer has lower polymerization degree unlike conventional poyimide, also polyamide acid of the precursor is referred to as amide acid oligomer.

As will be described later, a weight-average molecular weight of the amide acid oligomer preferably ranges from 500 to 50000. When the weight-average molecular weight is within this range, the finally obtained photosensitive IMASO (A-3) can be made into oligomer whose polymerization degree is lower than that of general polyimide polymer.

<Epoxy Compound having Double Bond>

As materials for the photosensitive IMASO (A-3), at least the ISO and the epoxy compound having a double bond are used. As to these materials, first, the epoxy compound is specifically described as follows. Note that, unless particularly mentioned in this description, the “epoxy compound” means the “epoxy compound having a double bond”.

The epoxy compound used in the present invention is not particularly limited as long as the compound includes the double bond and the epoxy structure. However, it is possible to extremely favorably use glycidyl methacrylate, glycidyl acrylate, glycidyl polysiloxane methacrylate, half epoxy(meth)acrylate, or a compound represented by the following group (9) 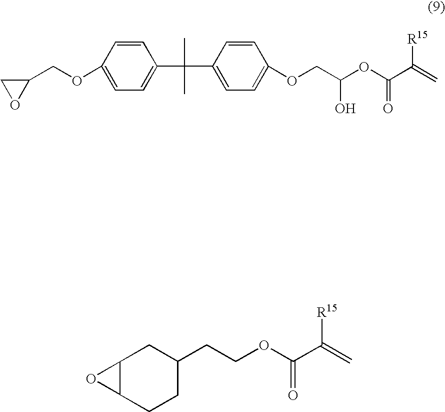
where R¹⁵ represents a hydrogen atom or a methyl group. Note that, the half epoxy(meth)acrylate is, for example, a compound in which about five epoxy groups out of about 10 epoxy groups are substituted by acrylate or methacrylate.

A specific example of the epoxy compound is RIPOKIN 630X-501 (commercial name) made by Showa Highpolymer Co., Ltd.

<Synthesis of Photosensitive IMASO>

It is possible to synthesize the photosensitive IMASO (A-3) by reacting the epoxy compound with ISO, but the synthesis method is not particularly limited, and it is possible to adopt a known method.

The ISO has a reactive functional group with respect to the epoxy group as will be described later. Thus, for example, the epoxy compound is added to the ISO solution or the epoxy compound and other component are added to the ISO solution and evenly mixed so as to react them at a temperature ranging from 40° C. to 120° C., thereby obtaining the photosensitive IMASO (A-3).

An amount of the epoxy compound used is not particularly limited, but it the amount is set to be an equivalent three times as large as an equivalent of the epoxy group with respect to the reactive functional group (COOH or OH) contained in the ISO. Specifically, for example, it is preferable that the amount of the epoxy compound with respect to 100 weight parts of ISO is within a range of from 1 to 80 parts by weight.

The reaction solvent used in reacting the ISO with the epoxy compound is not particularly limited. However, examples of the reaction solvent include N,N-dimethyl acetamide, N,N-diethyl acetamide, N,N-dimethyl formamide, N,N-diethyl formamide, N-methyl-2-pyrrolidone, γ-butyrolactone, diglime solvent (e.g., diethylene glycol dimethyl ether(diglime), triethylene glycol dimethyl ether(triglime), tetraglime, and the like), dioxolan, dioxane, tetrahydrofuran, and the like.

Thus obtained photosensitive IMASO (A-3) may be used in a solution state. Alternatively, it may be so arranged that: the photosensitive IMASO (A-3) is redeposited in poor solvent such as alcohol, and the redeposited IMASO is dried, and the dried IMASO is dissolved in other solvent. Note that, in case of denaturalizing the ISO with the epoxy compound such as glycidyl methacrylate, the ISO may be cross-linked in receiving heat, so that it is preferable to add a radical stabilizer.

<Imide Siloxane Oligomer>

As described above, the ISO serving as other material for the photosensitive IMASO (A-3) is obtained as follows: diamine and tetra carboxylate dianhydride are reacted with each other so as to be amide acid oligomer, and thus obtained amide acid oligomer is imidized, thereby obtaining the ISO.

Generally, polyimide is obtained as follows: diamine in organic solvent and acid dianhydride are reacted with each other so as to be polyamide acid, and thus obtained polyamide acid is made into dehydrated imide; or acid dianhydride and diisocyanate are reacted with each other in solvent. Also amide acid oligomer used in the present invention is obtained by reacting organic solvent diamine and tetracarboxylate dianhydride with each other.

A polymerization condition (synthesis condition/reaction condition) of amide acid oligomer in the present invention is not particularly limited. First, as environment in the polymerization, it is possible to adopt an inert atmosphere such as argon and nitrogen. Further, a method for mixing diamine and tetracarboxylate dianhydride serving as materials may be as follows: in the inert atmosphere, diamine or tetracarboxylate dianhydride is dissolved or diffused in a slurry manner in organic solvent so that the material is added to the organic solvent, or the material is added in a solid state.

A polymerization temperature (reaction temperature) of the amide acid oligomer is not particularly limited, but preferably ranges from −20° C. to 90° C. Further, polymerization time (reaction time) ranges from 30 minutes to 24 hours. Further, a mixture ratio of diamine and tetracarboxylate dianhydride serving as materials is not particularly limited. For example, as will be described, the mixture ratio is suitably set so as to correspond to a kind of diamine used.

The organic solvent used in polymerization of the amide acid oligomer is not particularly limited as long as the solvent is organic polar solvent. However, specific examples of the organic solvent include: sulfoxide solvent such as dimethyl sulfoxide and diethyl sulfoxide; formamide solvent such as N,N-dimethyl formamide and N,N-diethyl formamide; acetamide solvent such as N,N-dimethyl acetamide and N,N-diethyl acetamide; pyrrolidone solvent such as N-methyl-2-pyrrolidone and N-vinyl-2-pyrrolidone; phenol solvent such as phenol, o-, m-, or p-cresol, xylenol, phenol halide, and catechol; ether solvent such as tetrahydrofuran and dioxane; alcohol solvent such as methanol, ethanol, and butanol; cellosolve such as butyl cellosolve or hexamethyl phospholamide, γ-butyrolactone; and the like. These organic polar solvents may be independently used, or a combination of two or more kinds may be used as a mixture.

Further, it is possible to use aromatic carbon hydride such as xylene and toluene concomitantly with the organic polar solvent. That is, it is preferable to use the organic polar solvent as the organic solvent used in polymerization of the amide acid oligomer, but the organic solvent is not particularly limited as long as the organic solvent dissolves the amide acid oligomer.

Note that, in terms of production steps, it is advantageous to select an organic solvent, which dissolves amide acid oligomer and whose boiling point is as low as possible, after synthesizing amide acid oligomer, in order to finally remove the organic solvent.

In polymerization of the amide acid oligomer, the diamine and the tetracarboxylate dianhydride can be reacted with each other by performing any one of random reaction, block reaction, and mixture-recombination reaction of two-kind reaction solution. Further, thus obtained ISO can be used in the subsequent reaction without being isolated from the solution.

As described above, it is preferable that a weight-average molecular weight of the obtained amide acid oligomer ranges from 500 to 50000. When the average molecular weight is less than 500, also a molecular weight of the finally obtained photosensitive IMASO (A-3) becomes too low. Thus, even when the photosensitive IMASO (A-3) is used without any modification, the cured photosensitive resin composition (or the photosensitive dry film resist) is likely to be brittle. While, when the average molecular weight exceeds 50000, since the molecular weight becomes too high, the obtained photosensitive IMASO (A-3) is likely to have lower solubility with respect to the alkaline developer.

<Imidization of Amide Acid Oligomer>

The amide acid oligomer is imidized so as to be ISO. A method for imidizing the amide acid oligomer is not particularly limited, and it is possible to adopt a known method for imidizing the amide acid oligomer.

Generally, when the polyamide acid is imidized, water is generated. The generated water easily hydrolyzes polyamide acid, so that a molecular weight of the obtained polyamide acid drops. Thus, in imidizing the plyamide acid, it is preferable to imidize the polyamide acid while removing generated water.

As a method for imidizing the polyamide acid while removing generated water in this manner, there are generally adopted the following methods: (i) an azeotropic solvent such as toluene and xylene is added so as to remove generated water by azeotropy; (ii) the polyamide acid is imidized while removing water at 100° C. or higher; and (iii) the polyamide acid is chemically imidized by adding aliphatic acid dianhydride such as acetic anhydride and tertiary amine such as triethyl amine, pyridine, picoline, and isoquinoline. Also in imidizing amide acid oligomer of the present invention, it is possible to favorably adopt the methods (i) to (iii).

Further, as a method other than the methods (i) to (iii), it is possible to favorably adopt a method (iv) in which water generated in imidizing the polyamide acid is heated and is subjected to pressure reduction so as to positively exclude the water to the outside of the system. Also in this method, it is possible to suppress hydrolysis of the obtained polyamide acid, thereby preventing the molecular weight from dropping. Further, according to the method (iv), it may be possible to increase the molecular weight of the obtained amide acid oligomer due to the pressure reduction and the heating in imidizing the polyamide acid.

Specifically, when the tetracarboxylate dianhydride serving as the material contains (i) tetracarboxylate whose ring is opened by hydrolysis, (ii) tetracarboxylate dianhydride whose one ring is opened by hydrolysis, (iii) and the like, polymerization reaction of polyamide acid stops. However, according to the method (iv), the pressure reduction and the heating in imidizing the polyamide acid allow acid dianhydride whose ring is opened to close its ring again so as to be acid dianhydride free from any ring closure, so that it is possible to react the diamine and the tetracarboxylate dianhydride remaining in the system with each other while imidizing the polyamide acid. Therefore, it may be possible to increase the molecular weight.

A heating condition in the method for imidizing the polyamide acid is not particularly limited, but preferably ranges from 80° C. to 400° C. Particularly, in order to efficiently imidize the polyamide acid and efficiently remove water, a lower limit of the heating temperature is preferably 100° C. or higher, more preferably 120° C. or higher. While, it is preferable to set the maximum temperature in the heating to be the same or lower than a thermal decomposition temperature of the finally obtained ISO. Generally, the step of imidizing the polyamide acid is substantially completed at a temperature ranging from 250° C. to 350° C. , so that it is possible to set the maximum temperature to be in this range.

In the method for imidizing the polyamide acid, a pressure condition in the pressure reduction is as follows: a smaller pressure is preferable, but any pressure may be adopted as long as it is possible to efficiently remove water generated in imidizing the polyamide acid. Specifically, a pressure in the heating under a reduced pressure ranges from 0.9 to 0.001 atmospheres, preferably from 0.8 to 0.001 atmospheres, more preferably from 0.7 to 0.01 atmospheres.

<Diamine>

Among materials for the ISO, the diamine is not particularly limited, but it is preferable to use plural kinds of compounds. Particularly, it is preferable to use at least siloxane diamine, and it is preferable to use not only the siloxane diamine but also diamine having a phenolic hydroxyl group or diamine having a carboxyl group (—COOH).

Siloxane diamine is used as the diamine, so that it is possible to give superior solvent solubility to the obtained photosensitive IMASO (A-3) and the photosensitive resin composition containing the photosensitive IMASO (A-3), and it is possible to give flexibility to the cured photosensitive resin composition (photosensitive dry film resist). Further, diamine having a phenolic hydroxyl group or a carboxyl group is used, so that it is possible to introduce the phenolic hydroxyl group or the carboxyl group into the structure of the obtained photosensitive IMASO (A-3). Thus, the photosensitive IMASO (A-3) can be made into a soluble IMASO.

<Siloxane Diamine>

The siloxane diamine is not particularly limited as long as the diamine has a siloxane structure. However, it is preferable to use at least diamino polysiloxane represented by the following formula (6) 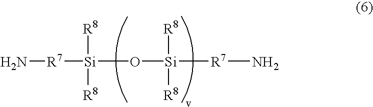
where R⁷ is —CᵤH₂ᵤ— or —C₆H₄—, and R⁸ is a methyl group, an ethyl group, or a phenyl group, and u is any one of integers 1 to 6, and v is any one of integers 2 to 50.

In the foregoing formula (6), as to R⁷ corresponding to —CᵤH₂ᵤ—, u preferably ranges from 2 to 10, particularly preferably from 2 to 5. Further, in the formula (6), v preferably ranges from 4 to 30, more preferably from 5 to 20, particularly preferably from 8 to 15. In variables of the formula (6), particularly a value of v has great influence on properties of the finally obtained photosensitive IMASO (A-3) and the finally obtained photosensitive resin composition. Specifically, when the value of v is too small, the cured photosensitive IMASO (A-3) and the cured photosensitive resin composition are likely to be less flexible. Further, when the value of v is too large, heat resistance of the cured photosensitive IMASO (A-3) and the cured photosensitive resin composition are likely to drop.

In case of using the diamino polysiloxane as the diamine, when a total of the diamine is 100 mol %, a morality of the diamino polysiloxane preferably ranges from 5 to 70 mol %, more preferably from 10 to 50 mol %. When the morality deviates from this range, it may be impossible to give sufficient flexibility and solubility to the photosensitive IMASO (A-3) and the photosensitive resin composition.

<Diamine having a Phenolic Hydroxyl Group a Carboxyl Group>

The diamine having the phenolic hydroxyl group or the carboxyl group is not particularly limited. However, it is preferable to use an aromatic diamine compound represented by the following formula (7) 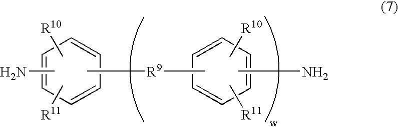
where R⁹ is a direct-bond group or a bivalent group selected from —O—, —S—, —CO—, —SO₂—, —SO—, —CH₂—, —C(CH₃)₂—, —O—C₆H₄—O—, —C₆H₄—, and —O—C₆H₄—C(CH₃)₂—C₆H₄—O—, R¹⁰ is —OH or —COOH, and R¹¹ represents a hydrogen atom, a methyl group, or a halogen atom, and w is any one of integers 1 to 5.

More specific examples thereof include: diamino phthalic acids such as 2,5-diamino terephthalic acid; carboxy biphenyl compounds such as 3,3 ′-diamino-4,4 ′-dicarboxy biphenyl, 4,4′-diamino-3,3′-dicarboxybiphenyl, 4,4′-diamino-2,2′-dicarboxybiphenyl, and 4,4′-diamino-2,2′,5,5′-tetradicarboxybiphenyl; carboxy diphenylalkanes such as carboxydiphenylmethane such as 3,3′-diamino-4,4′-dicarboxydiphenylmethane, 2,2-bis[3-amino-4-carboxy phenyl]propane, 2,2-bis[4-amino-3-carboxy phenyl]propane, 2,2-bis[3-amino-4-carboxy phenyl]hexafluoropropane, and 4,4′-diamino-2,2′,5,5′-tetracarboxydiphenylmethane; carboxydiphenylether compound such as 3,3′-diamino-4,4′-dicarboxydiphenylether, 4,4′-diamino-3,3′-dicarboxydiphenylether, 4,4′-diamino-2,2′-dicarboxydiphenylether, and 4,4′-diamino-2,2′,5,5′-tetracarboxydiphenylether; diphenyl sulfone compound such as 3,3′-diamino-4,4′-dicarboxydiphenylsulfone, 4,4′-diamino-3,3′-dicarboxydiphenylsulfone, 4,4′-diamino-2,2′-dicarboxydiphenylsulfone, and 4,4′-diamino-2,2′,5,5′-tetracarboxydiphenylsulfone; bis[(carboxy phenyl)phenyl]alkane compounds such as 2,2′-bis[4-(4-amino-3-carboxyphenoxy)phenyl]propane; bis[(carboxy phenoxy)phenyl]sulfone compound such as 2,2-bis[4-(4-amino-3-carboxyphenoxy)phenyl]sulfone; diaminophenols such as 2,4-diaminophenol; hydroxybiphenyl compounds such as hydroxydiphenylmethane such as 3,3′-diamino-4,4′-dihydroxybiphenyl, 4,4′-diamino-3,3′-dihydroxybiphenyl, 4,4′-diamino-2,2′-dihydroxybiphenyl, and 4,4′-diamino-2,2′,5,5′-tetrahydroxybiphenyl; hydroxydiphenyl alkanes such as 3,3′-diamino-4,4′-dihydroxydiphenylmethane, 4,4′-diamino-3,3′-dihydroxydiphenylmethane, 4,4′-diamino-2,2′-dihydroxydiphenylmethane, 2,2-bis[3-amino-4-hydroxyphenyl]propane, 2,2-bis [4-amino-3-hydroxyphenyl]hexafluoropropane, 4,4′-diamino-2,2′, 5,5′-tetrahydroxydiphenylmethane; hydroxydiphenylether compound such as 3,3′-diamino-4,4′-dihydroxydiphenylether, 4,4′-diamino-3,3′-dihydroxydiphenylether, 4,4′-diamino-2,2′-dihydroxydiphenylether, and 4,4′-diamino-2,2′,5,5′-tetrahydroxydiphenylether; diphenylsulfone compound such as 3,3′-diamino-4,4′-dihydroxydiphenylsulfone, 4,4′-diamino-3,3′-dihydroxydiphenylsulfone, 4,4′-diamino-2,2′-dihydroxydiphenylsulfone, and 4,4′-diamino-2,2′,5,5′-tetrahydroxydiphenylsulfone; bis[(hydroxyphenyl)phenyl]alkane compounds such as 2,2-bis[4-(4-amino-3-hydroxyphenoxy)phenyl]propane; bis(hydroxyphenoxy)biphenyl compounds such as 4,4′-bis(4-amino-3-hydroxyphenoxy)biphenyl; bis[(hydroxyphenoxy)phenyl]sulfone compound such as 2,2-bis[4-(4-amino-3-hydroxyphenoxy)sulfone; diaminobenzoic acids such as 3,5-diaminobenzoic acid; bis(hydroxyphenoxy)biphenyl compound such as 4,4′-diamino-3,3′-dihydroxydiphenylmethane, 4,4′-diamino-2,2′-dihydroxydiphenylmethane, 2,2′-bis[3-amino-4-carboxyphenyl]propane, 4,4′-bis(4-amino-3-hydroxyphenoxy)biphenyl; and the like.

Among them, as the diamine having a phenolic hydroxyl group, it is preferable to use diamine represented by the following formula (10) for example. 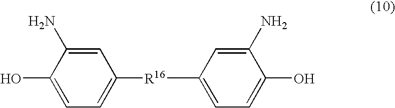
where R¹⁶ is —C(CH₃)₂—, —C(CF₃)₂—, or —CH₂—. It is particularly preferable to use the diamine represented by the formula (10) since it is possible to give the photosensitive resin composition high solubility with respect to alkaline developer.

Further, as the diamine having a carboxyl group, it is preferable to use 3,3′-diamino-4,4′-dicarboxydiphenylmethane or 3,5-diaminobenzoic acid for example. It is easy to industrially obtain these diamines. Thus, it is particularly preferable to use these diamines.

In case of using the diamine having a phenolic hydroxyl group as the diamine, when a total of the diamine is 100 mol %, it is necessary to carry out the reaction so that a total of the tetracarboxylate dianhydride is within a range of from 50 to 95 mol %. In case where a phenolic hydroxyl group exists in a molecule of the obtained photosensitive IMASO (A-3), when its end is acid dianhydride, the acid dianhydride at the end reacts with the phenolic hydroxyl group so as to have a higher molecular weight. As a result, the photosensitive IMASO (A-3) may be insoluble with respect to the solvent. Therefore, in order that the end of the photosensitive IMASO (A-3) serves as an amine end, it is preferable to set a mixture ratio of the diamine and the tetra carboxylic dianhydride within the foregoing range.

While, in case of using the diamine having a carboxyl group as the diamine, when a total of the tetracarboxylate dianhydride is 100 mol %, it is necessary to carry out the reaction so that a total of the tetracarboxylate dianhydride is within a range of from 50 to 95 mol %. In case where a carboxyl group exists in a molecule of the obtained photosensitive IMASO (A-3), when its end is diamine, the diamine at the end reacts with the carboxyl group in imidizing the resultant, so as to have a higher molecular weight. As a result, the photosensitive IMASO (A-3) may be insoluble with respect to the solvent. Therefore, in order that the end of the photosensitive IMASO (A-3) serves as an acid dianhydride end, it is preferable to set a mixture ratio of the diamine and the tetra carboxylic dianhydride within the foregoing range.

<Other Diamine>

As the diamine used in the present invention, it is possible to use a compound (other diamine) other than the siloxane diamine and the diamine having a phenolic hydroxyl group or a carboxyl group.

Specific examples of other diamine include: aromatic diamine such as p-phenylene diamine, m-phenylene diamine, 4,4′-diamino diphenyl methane, 4,4′-diamino phenyl ethane, 4,4′-diamino phenyl ether, 4,4′-didiamino phenyl sulfide, 4,4′-didiamino phenyl sulfone, 1,5-diamino naphthalene, 3,3-dimethyl-4,4′-diamino biphenyl, 5-amino-1-(4′-aminophenyl)-1,3,3-trimethyl indan, 6-amino-1-(4′-amino phenyl)-1,3,3-trimethyl indan, 4,4′-diamino benzanilide, 3,5-diamino-3′-trifluoromethyl benzanilide, 3,5-diamino-4′-trifluoromethyl benzanilide, 3,4′-diamino diphenyl ether, 2,7-diamino fluorene, 2,2-bis (4-aminophenyl) hexafluoropropane, 4,4′-methylene-bis (2-chloro aniline), 2,2′,5,5′-tetra chloro-4,4′-diamino biphenyl, 2,2′-dichloro-4,4′-diamino-5,5′-dimethoxy biphenyl, 3,3′-dimethoxy-4,4′-diamino biphenyl, 4,4′-diamino-2,2′-bis (trifluoromethyl) biphenyl, 2,2-bis [4-(4-amino phenoxy)phenyl]propane, 2,2-bis [4-(4-amino phenoxy)phenyl]hexafluoropropane, 1,4-bis(4-amino phenoxy)benzene, 4,4′-bis(4-amino phenoxy)-biphenyl, 1,3′-bis(4-amino phenoxy)benzene, 9,9-bis(4-amino phenyl)fluorene, 4,4′-(p-phenylene isopropyliden)bisaniline, 4,4′-(m-phenylene isopropyliden)bisaniline, 2,2′-bis [4-(4-amino-2-trifluoromethyl phenoxy)phenyl]hexafluoropropane, and 4,4′-bis[4-(4-amino-2-trifluoromethyl)phenoxyl-octafluorobiphenyl; aromatic diamine having (i) two amino groups coupled to an aromatic ring such as diamino tetraphenyl thiophene and (ii) a hetero atom other than a nitrogen atom of each amino group; aliphatic diamine such as 1,1-methaxylylene diamine, 1,3-propanediamine, tetramethylene diamine, pentamethylene diamine, octamethylene diamine, nanomethylene diamine, 4,4-diamino heptamethylene diamine, 1.4-diamino cyclohexane, isophorone diamine, tetrahydro dicyclopentadienylene diamine, hexahydro-4,7-methanoindanylene dimethylene diamine, tricyclo[6,2,1,02.7]-undecylene dimethyl diamine, and 4,4′-methylenebis(cyclohexylamine); and the like. These diamines may be independently used, or a suitable combination of two or more kinds may be used.

<Tetracarboxylate Dianhydride>

Among the materials for the ISO, tetracarboxylate dianhydride is not particularly limited, but specific examples thereof include aromatic tetracarboxylate dianhydride such as 2,2′-hexafluoropropyliden diphthalate dianhydride, 2,2-bis(4-hydroxy phenyl)propane dibenzoate-3,3′,4,4′-tetracarboxylate dianhydride, 4,4′-bis (3,4-dicarboxy phenoxy)diphenylpropane dianhydride, 3,3′,4,4′-perfluoroisopropyliden diphthalate dianhydride, butane tetracarboxylate dianhydride, 3,3′,4,4′-biphenyl tetracarboxylate dianhydride, 2,2′,3,3′-biphenyl tetracarboxylate dianhydride, 2,3,3′,4′-biphenyl tetracarboxylate dianhydride, 3,3′,4,4′-benzophenone tetracarboxylate dianhydride, bis(3,4-dicarboxyl phenyl)ether dianhydride, 2,3-dicarboxy phenyl (3,4-dicarboxy phenyl) ether dianhydride, pyromellitic acid dianhydride, 2,3,6,7-naphthalene tetracarboxylate dianhydride, 1,2,5,6-naphthalene tetracarboxylate dianhydride, 1,2,4,5-naphthalene tetracarboxylate dianhydride, 1,4,5,8-naphthalene tetracarboxylate dianhydride, 2,2-bis (2,5-dicarboxy phenyl) propane dianhydride, 1,1-bis (2,3-dicarboxy phenyl) ethane dianhydride, 1,1-bis (3,4-dicarboxy phenyl) sulfone dianhydride, and 1,3-bis (3,4-dicarboxy phenyl)-1,1,3,3-tetramethyl disiloxane dianhydride. These tetracarboxylate dianhydrides may be independently used, or a suitable combination of two or more kinds may be used.

Particularly, in order to give the photosensitive resin composition the superior heat resistance and mechanical property under a superior condition, it is preferable to use aromatic tetracarboxylate dianhydride represented by the following group (11) 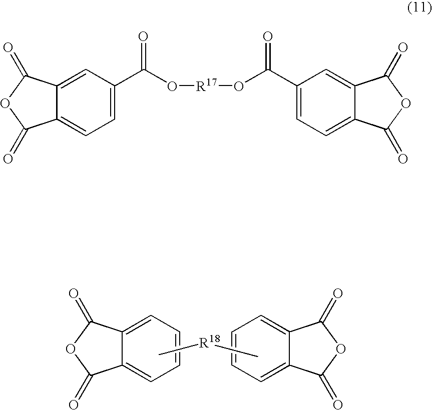
where R¹⁷ represents —CH₂CH₂— or —C₆H₄—C(CH₃)₂—C₆H₄—, and R¹⁸ represents a direct bond or —O—, —CH₂—, —(C═O)—, —C(CH₃)₂—, —C(CF₃)₂—, or —O—C₆H₄—C(CH₃)₂—C₆H₄—O—.

In the present invention, in order to raise the concentration of the photosensitive resin composition by raising the solubility of the photosensitive IMASO (A-3) and in order to improve the heat resistance of the cured insulation film (cover lay film), it is preferable to use the aromatic tetracarboxylate dianhydride of the group (11) and the aromatic tetracarboxylate dianhydride such as 2,3,3′,4′-biphenyl tetracarboxylate dianhydride, 3,3′,4,4′-benzophenone tetracarboxylate dianhydride, bis(3,4-dicarboxyl phenyl) ether dianhydride, 2,3-dicarboxy phenyl(3,4-dicarboxy phenyl)ether dianhydride, 1,3-bis (3,4-dicarboxy phenyl)-1,1,3,3-tetramethyl disiloxane dianhydride, and 2,2′-hexafluoropropyliden diphthalate dianhydride. Particularly, it is more preferable to use 2,3,3′,4′-biphenyl tetracarboxylate dianhydride.

### (II) Component (B): (meth)acryls compound

Next, (meth)acryls compound (B) is described as follows. As described above, the photosensitive resin composition generally contains one or more kinds of polymer component (or oligomer component which can be used as the polymer component) and one or more kinds of oligomer component, but the (meth)acryls compound (B) corresponds to the oligomer component. In the photosensitive resin composition according to the present invention, the (meth)acryls compound (B) is combined with the base resin component (B) so as to be included therein as an essential component.

On this account, it is possible to obtain a film-shape photosensitive material (photosensitive dry film resist) which realizes the water system developing property, and it is possible to drop the viscoelasticity of the photosensitive dry film resist at the time of the heating process, thereby giving the fluidity at the time of thermal lamination.

That is, the photosensitive dry film resist according to the present invention can be subjected to the thermal lamination at a relatively low temperature, so that it is possible to mount uneven portions of a circuit on the photosensitive dry film resist. Therefore, in manufacturing electronic parts such as a print substrate and the like for example, it is possible to carry out the thermal lamination with respect to a polyimide film serving as a base film and a glossy surface of an electrolytic copper foil serving as a conductive layer at 150° C. or lower.

### (II-1) Specific Example of the (meth)acryls Compound (B) in Case of using Base Polymer having a Hydroxyl Group as the Base Resin Component (A)

In the present invention, in case of using a base polymer (i.e., the polyimide resin having a hydroxyl group (A-1) or the polyamide resin having a hydroxyl group (A-2)) as the base resin component (A), the (meth)acryls compound used as the component (B) is at least one kind selected from (meth)acrylic compound (acrylic compound, methacryls compound), epoxy(meth)acrylate, polyester(meth)acrylate, urethane(meth)acrylate, and imide(meth)acrylate. Particularly, in case where a storage stabilization additive (D) is included in the present invention, it is preferable that the component (B) is a compound selected from (meth)acrylic compound, epoxy(meth)acrylate, urethane(meth)acrylate, and imide(meth)acrylate.

Note that, in the present invention, the “(meth)acryl” means “acryl and/or methacryl”. For example, the (meth)acrylic compound includes the acrylic compound and the methacrylic compound. Further, the (meth)acryls compounds may be independently used, or a suitable combination of two or more kinds may be used.

A total weight of the (meth)acryls compound (B) contained in the photosensitive resin composition according to the present invention is not particularly limited. However, particularly, in case of using the polyimide resin having a phenolic hydroxy group (A-1-1) as the base resin component (A), with respect to 100 parts by weight of the base resin component, an amount of the (meth)acryls compound preferably ranges from 0 to 100 parts by weight, more preferably from 0 to 80 parts by weight, still more preferably from 0 to 50 parts by weight.

Further, in case of using the photosensitive polyimide resin (A-1-2) as the base resin component (A), with respect to 100 parts by weight of the base resin component, an amount of the (meth)acryls compound preferably ranges from 1 to 100 parts by weight, more preferably from 1 to 80 parts by weight, still more preferably from 1 to 50 parts by weight.

Alternatively, in case of using the soluble polyimide resin (A-1-3) as the base resin component (A), with respect to 100 parts by weight of the base resin component, an amount of the (meth)acryls compound preferably ranges from 1 to 100 parts by weight, more preferably from 5 to 80 parts by weight, still more preferably from 10 to 50 parts by weight.

When the (meth)acryls compound whose amount exceeds 100 parts by weight is contained in 100 parts by weight of the base resin component, the heat resistance of the obtained photosensitive dry film resist drops, so that the (meth)acryls compound may exude at the time of the lamination. While, a lower limit of the amount of the (meth)acryls compound contained is not particularly limited, and is set so as to correspond to properties to be realized in each photosensitive resin composition.

Particularly, it is preferable that: the photosensitive resin composition according to the present invention contains a (meth)acrylic compound having at least one or more epoxy groups and one or more (meth)acryl groups in its molecule (for convenience in description, this (meth)acrylic compound is referred to as an epoxy (meth)acrylic compound). The (meth)acrylic compound is used, so that it is possible to improve the photosensitive dry film resist in terms of the anti-hydrolysis property and the adhesive strength with respect to the copper foil.

The epoxy(meth)acrylic compound is not particularly limited, but examples thereof include: glycidyl compound such as glycidyl methacrylate; epoxy acrylate such as NK oligo EA-1010 and EA-6310 (both of which are commercial names: products of SHIN-NAKAMURA CHEMICAL CO., LTD.); and the like.

Further, it is preferable that the (meth)acryls compound used in the present invention is epoxy(meth)acrylate having at least two hydroxyl groups in its molecule, and it is preferable that the (meth)acryls compound used in the present invention is epoxy(meth)acrylate having at least four hydroxyl groups in its molecule. Such epoxy(meth)acrylate is used, so that the photosensitive dry film resist has higher solubility with respect to the alkaline aqueous solution, thereby realizing shorter developing time.

The epoxy(meth)acrylate having at least two hydroxyl groups in its molecule is not particularly limited, but examples thereof include: bisphenol A type epoxy acrylate such as LIPOXY SP-2600 (commercial name: product of Showa Highpolymer Co., Ltd.), NK oligo EA-1020 and NK oligo EA-6340 (both of which are commercial names: products of SHIN-NAKAMURA CHEMICAL CO., LTD.), KARAYAD R-280 and KARAYAD R-190 (both of which are commercial names: products of Nippon Kayaku Co., Ltd.), and Ebercryl 600 and Ebercryl 3700 (both of which are commercial names: products of DAICEL-UCB Company LTD.); denaturalized bisphenol A type epoxy acrylate such as Ebercryl 3200, Ebercryl 3500, Ebercryl 3701, and Ebercryl 3703 (all of which are commercial names: products of DAICEL-UCB Company LTD.); phenolnovolak epoxy acrylate such as NK oligo EA-6320 and NK oligo EA-6340; denaturalized 1,6-hexanediol acrylate such as KARAYAD R-167 and MAX-2104 (both of which are commercial names: products of Nippon Kayaku Co., Ltd.), and denacol acrylate DA-212 (commercial name: Nagase Chemical Industries Co., Ltd.); denaturalized phthalate diacrylate such as denacol acrylate DA-721 (commercial name: product of Nagase Chemical Industries Co., Ltd.); cresol novolak epoxy acrylate such as NK oligo EA-1020 (commercial name: product of SHIN-NAKAMURA CHEMICAL CO., LTD.); and the like.

As the (meth)acryls compound used in the present invention, it is possible to use not only the epoxy(meth)acrylate and the (meth)acryls compound having a hydroxyl group but also polyester(meth)acrylate, urethane(meth)acrylate, imide(meth)acrylate, and other (meth)acryls compound, and the like.

First, by using polyester(meth)acrylate, it is possible to give the flexibility to the obtained photosensitive dry film resist. The polyester(meth)acrylate used in the present invention is not particularly limited, but examples thereof include ARONIX M-5300, ARONIX M-6100, and ARONIX M-7100 (all of which are commercial names: product of TOAGOSEI CO., LTD.), and the like.

Further, by using urethane(meth)acrylaye, it is possible to give the flexibility to the obtained photosensitive dry film. The urethane(meth)acrylate used in the present invention is not specifically particularly limited, but examples thereof include ARONIX M-1100 and ARONIX M-1310 (both of which are commercial names: products of TOAGOSEI CO., LTD.), KARAYAD UX-4101 (commercial name: product of Nippon Kayaku Co., Ltd.), and the like.

Alternatively, by using imide(meth)acrylaye, it is possible to improve the adhesiveness of the substrate (polyimide film, copper foil, and the like) with which the obtained photosensitive dry film resist is combined. The imide(meth)acrylate used in the present invention is not specifically particularly limited, but examples thereof include ARONIX TO-1534, ARONIX TO-1429, and ARONIX TO-1428 (all of which are commercial names: products of TOAGOSEI CO., LTD.).

Further, other (meth)acrylic compound which can be used in the present invention is not particularly limited. However, in order to improve cross-linked density based on light emission which will be described later, it is preferable to use a multifunctional (meth)acryls compound having at least two carbon-carbon double bonds. Further, in order to give the heat resistance to the obtained photosensitive dry film resist, it is preferable to use a (meth)acryls compound having at least one aromatic ring and/or one heterocycle in its molecule.

The (meth)acryls compound having at least one aromatic ring and/or one heterocycle in its molecule and having at least two carbon-carbon double bonds is not particularly limited, but examples thereof include: bisphenol A EO denaturalized di(meth)acrylate such as ARONIX M-210 and ARONIX M-211B (both of which are commercial names: products of TOAGOSEI CO., LTD.), NK ester ABE-300, NK ester A-BPE-4, NK ester A-BPE-10, NK ester A-BPE-20, NK ester A-BPE-30, NK ester BPE-100, and NK ester BPE-200 (all of which are commercial names: products of SHIN-NAKAMURA CHEMICAL CO., LTD.); bisphenol F EO denaturalized (n=2 to 20) di(meth)acrylate such as ARONIX M-208 (commercial name: product of TOAGOSEI CO., LTD.);. bisphenol A PO denaturalized (n=2 to 20) di(meth)acrylate such as denacol acrylate DA-250 (commercial name: Nagase Chemical Industries Co., Ltd.) and BISCOAT #540 (commercial name: product of Osaka Organic Chemical Industry Ltd.); phthalate PO denaturalized diacrylate such as denacol acrylate DA-721 (commercial name: Nagase Chemical Industries Co., Ltd.); and the like.

Further, as the (meth)acryls compound having no aromatic ring and having at least two carbon-carbon double bonds, for example, it is possible to use: isocyanuric acid EO denaturalized diacrylate such as ARONIX M-215 (commercial name: product of TOAGOSEI CO., LTD.); and isocyanuric acid EO denaturalized triacrylate such as ARONIX M-315 (commercial name: product of TOAGOSEI CO., LTD.) and NK ester A-9300. Note that, the “EO denaturalized” means that there is an ethylene oxide denaturalized portion, and the “PO denaturalized” means that there is a propylene oxide denaturalized portion.

Among the (meth)acryls compounds, it is particularly preferable to use a (meth)acryls compound in which the number of recurring units (—(CH₂CH₂O)—) of an ethylene-oxide denaturalized (EO denaturalized) portion in its molecule or the number of recurring units (—(CH(CH₃)CH₂O)—) of a propylene oxide denaturalized (PO denaturalized) portion in its molecule is 10 or more. Due to 10 or more recurring units described above, it is possible to give thermal fluidity to the obtained photosensitive dry film resist at the time of lamination, thereby improving the solubility with respect to the basic aqueous solution (that is, improving the water developing property).

The (meth)acrylic compound having 10 or more recurring units of an EO denaturalized portion in its molecule or 10 or more recurring units of a PO denaturalized portion in its molecule is not particularly limited, but examples thereof include: bisphenol A EO denaturalized di(meth)acrylate such as NK ester A-BPE-10, NK ester A-BPE-20, NK ester A-B PE-30, NK ester A-BPE-100, and NK ester A-BPE-200 (all of which are commercial names: products of SHIN-NAKAMURA CHEMICAL CO.,. LTD.); bisphenol F EO denaturalized (n=10 to 20) di(meth)acrylate; bisphenol A PO denaturalized (n=10 to 20) di(meth)acrylate; and the like.

With respect to a total weight of all the (meth)acryls compounds contained in the photosensitive resin composition according to the present invention, an amount of the (meth)acryls compound having 10 or more recurring units of an EO denaturalized portion in its molecule or 10 or more recurring units of a PO denaturalized portion in its molecule is preferably at least 10 parts by weight, more preferably 20 parts by weight or more.

### (II-2) Specific Example of (meth)acryls Compound (B) in Case of using Photosensitive IMASO (A-3) as Base Resin Component (A)

In the present invention, in case of using the photosensitive IMASO (A-3) as the base resin component (A), the (meth)acryls compound used as the component (B) is a (meth)acryls compound having two or more unsaturated double bonds (B-1) (for convenience in description, this (meth)acryls compound is referred to as an polyunsaturated (meth)acryls compound). The polyunsaturated (meth)acrylic compound (B-1) is not particularly limited, but specific examples thereof include bisphenol F EO denaturalized (n=2 to 50) diacrylate, bisphenol A EO denaturalized (n=2 to 50) diacrylate, bisphenol S EO denaturalized (n=2 to 50) diacrylate, 1,6-hexandiol diacrylate, neopentylglycol diacrylate, ethyleneglycol diacrylate, pentaerythritol diacrylate, trimethylolpropane triacrylate, pentaerythritol triacrylate, dipentaerythritol hexa acrylate, tetramethylol propane tetra acrylate, tetraethyleneglycol diacrylate, 1,6-hexanediol dimethacrylate, neopentylglycol dimethacrylate, ethyleneglycol dimethacrylate, pentaerythritol dimethacrylate, trimethylol propane trimethacrylate, pentaerythritol trimethacrylate, dipentaerythritol hexamethacrylate, tetramethylol propane tetramethacrylate, tetraethyleneglycol dimethacrylate, methoxydiethyleneglycol methacrylate, methoxypolyethyleneglycol methacrylate, β-metachroyl oxyethyl hydrogen phthalate, β-metachroyl oxyethyl hydrogen succinate, 3-chloro-2-hydroxypropyl methacrylate, steallyl methacrylate, phenoxyethyl acrylate, phenoxydiethyleneglycol acrylate, phenoxypolyethyleneglycol acrylate, β-acryloyloxtethyl hydrogen succinate, lauryl acrylate, ethyleneglycol dimethacrylate, diethyleneglycol dimethacrylate, triethyleneglycol dimethacrylate, polyethyleneglycol dimethacrylate, 1,3-buthyleneglycol dimethacrylate, 1,6-hexanediol dimethacrylate, neopentylglycol dimethacrylate, polypropyleneglycol dimethacrylate, 2-hydroxy-1,3 dimethachroxypropane, 2,2-bis [4-(methachroxyethoxy)phenyl]propane, 2,2-bis [4-(methachroxy diethoxy)phenyl]propane, 2,2-bis[[4-(methachroxy polyethoxy)phenyl]propane, polyethyleneglycol dichrylate, tripropyleneglycol diacrylate, polypropyleneglycol diacrylate, 2,2-bis [4-(acryloxy diethoxy)phenyl]propane, 2,2-bis [4-(acryloxy polyethoxy)phenyl]propane, 2-hydroxy-1-acryloxy3-methachloxy propane, trimethylol propane trimethacrylate, tetramethylol methane triacrylate, tetramethyrol methane tetraacrylate, methoxy dipropyleneglycol methacrylate, methoxytriethyleneglycol acrylate, nonylphenoxypolyethyleneglycol acrylate, nonylphenoxypolypropyleneglycol acrylate, 1-acryloyloxypropyl-2-phthalate, isosteallyl acrylate, polyoxyethylenealkylether acrylate, nonylphenoxyethyleneglycol acrylate, polypropyleneglycol dimethacrylate, 1,4-butanediol dimethacrylate, 3-methyl-1,5-pentanediol dimethacrylate, 1,6-mexanediol dimethacrylate, 1,9-nonanediol methacrylate, 2,4-diethyl-1,5-pentanediol dimethacrylate, 1,4-cyclohexanedimethanol dimethacrylate, dipropyleneglycol diacrylate, tricyclodecanedimethanol diacrylate, 2,2-hydrogenerated bis[4-(acryloxy polyethoxy)phenyl]propane, 2,2′-bis[4-(acryloxy-polypropoxy)phenyl]propane, 2,2-bis[4-(acryloxy polyethoxy)phenyl]propane, 2,4-diethyl-1,5-pentanediol diacrylate, ethoxylated tothymethylolpropane triacrylate, propoxylated tothymethylolpropane triacrylate, isocyanuric acid tri(ethaneacrylate), pentathritol tetra acrylate, ethoxylated pentathritol tetra acrylate, propoxylated pentathritol tetra acrylate, ditrimethylolpropane tetra acrylate, dipentaerythritol polyacrylate, isocyanuric acid triallyl, glycidyl methacrylate, glycidyl allylether, 1,3,5-triacryloylhexahydro-s-triazine, triallyll,3,5-benzenecarboxylate, triallyl amine, triallyl citrate, triallyl phosphate, allobarbital, diallyl amine, diallyl dimethyl silane, diallyl disulfide, diallyl ether, zallylcyallate, diallyl isophthalate, diallyl telephtalate, 1,3-diallyloxy-2-propanol, diallyl sulfide diallyl maleate, 4,4′-isopropyliden diphenol dimethacrylate, 4,4′-isopropyliden diphenol diacrylate, and the like.

The compounds exemplified as the polyunsaturated (meth)acryls compound (B-1) may be independently used, or a suitable combination of two or more kinds may be used. Alternatively, in order to improve the cross-linked density, it is particularly preferable to use a bifunctional or further multifunctional monomer.

Further, in case where the photosensitive resin composition according to the present invention uses the photosensitive IMASO (A-3) as the base resin component (A), it is preferable to use, as a copolymerizable monomer, bisphenol F EO denaturalized diacrylate, bisphenol A EO denaturalized diacrylate, bisphenol S EO denaturalized diacrylate, bisphenol F EO denaturalized dimathacrylate, bisphenol A EO denaturalized dimethacrylate, bisphenol S EO denaturalized dimethacrylate, and the like, since each of these monomers allows the photosensitive dry film resist obtained by using the photosensitive resin composition to have the flexibility after being cured.

Particularly, in the copolymerizable monomer, the number of recurring units of denaturalized EO contained in a single molecule of diacrylate or methacrylate preferably ranges from 2 to 50, more preferably from 2 to 40. When the number of recurring units of EO is within the foregoing range, the obtained photosensitive resin composition or photosensitive dry film resist has higher solubility with respect to the basic aqueous solution, so that the developing time is reduced. Note that, it is not preferable that the number of recurring units of EO is 50 or more, because the heat resistance is likely to drop under this condition.

Further, in the photosensitive resin composition according to the present invention, a ratio of the polyunsaturated (meth)acryls compound (B-1) contained is not particularly limited. However, with respect to 100 parts by weight of the photosensitive IMASO (A-3), the amount of the polyunsaturated (meth)acryls compound (B-1) contained preferably ranges from 5to 200 parts by weight, more preferably from 30 to 150 parts by weight.

It is not preferable that the amount of the. polyunsaturated (meth)acryls compound (B-1) contained is less than 5 parts by weight because a temperature at which the photosensitive dry film resist used as the photosensitive resin composition is combined with the substrate rises. While, it is not preferable that the amount of the polyunsaturated (meth)acryls compound (B-1) contained exceeds 200 parts by weight because the heat resistance of the photosensitive dry film resist is likely to drop.

### (III) Accessory Component (C)

Next, the accessory component (C) is specifically described as follows. In the photosensitive resin composition, the base resin component (A) and the (meth)acryls compound are essential components, but the photosensitive resin composition according to the present invention may contain a component other than these essential components. As the component other than the essential components, it is possible to use a component which allows the photosensitive dry film resist to have properties such as adhesiveness and heat resistance and to be less damaged upon being bent.

The component other than the essential components is not particularly limited. For example, in the present invention, it is possible to use: at least one kind of photoreaction initiator (C-1), sensitizer, and photopolymerization assistant; and at least one kind selected from flame retardant (C-2), epoxy resin (C-3), curing accelerator (C-4), and/or curing agent. In the present invention, the substances of these groups are generically referred to as “accessory component (C)” so as to distinguish them from the essential components. Note that, in the present invention, the “accessory component (C)” means “other component” other than the essential components, so that the “accessory component (C)” and the “other component” are identical with each other.

Particularly in case where the base resin component (A) is the photosensitive polyimide resin (A-1-2), it is preferable that at least one kind of the photoreaction initiator (C-1), the sensitizer, and the photopolymerization assistant is contained as the accessory component (C). Further, in case where the base resin component (A) is the photosensitive IMASO (A-3), it is preferable that the flame retardant (C-2) is contained as the accessory component (C).

Note that, also the storage stabilization additive (D) described later is an accessory component in a broad sense. However, in the present invention, the storage stability is regarded as an important property for realizing simplification of a process for manufacturing a print wiring substrate, so that the storage stabilization additive (D) is distinguished from the accessory component (C).

### (III-1) Photoreaction Initiator (C-1), Sensitizer, and Photopolymerization Assistant

In order to give the developing property to the obtained photosensitive dry film resist, the photosensitive resin composition according to the present invention may contain, as the accessory component (C), at least one kind selected from the photoreaction initiator (C-1), the sensitizer, and the photopolymerization assistant. Note that, for convenience in description, these substances are generically referred to as “developing property improving additive”. By adding the developing property improving additive, it is possible to promote cross-linking reaction or polymerization reaction in an exposed region of the photosensitive dry film resist in case where the photosensitive dry film resist is exposed. Thus, the exposed region and an unexposed region can be sufficiently differentiated from each other in terms of the photosensitive dry film resist's solubility with respect to the basic aqueous solution. Therefore, the exposed photosensitive dry film resist allows a favorable pattern to be obtained, so that it is possible to obtain the superior developing property.

<In Case of using Base Polymer having a Hydroxyl Group as Base Resin Component (A)>

First, in case of using the base polymer having a hydroxyl group as the base resin component (A), it is possible to favorably use the photoreaction initiator and/or the sensitizer as the developing property improving additive (C-1). Among them, the photoreaction initiator is not particularly limited, but specific examples thereof include radical generating agent, photocation generating agent, photobase generating agent, photoacid generating agent, and the like.

The radical generating agent is not particularly limited, but it is preferable to use an agent which generates a radical in response to light whose wavelength is as large as a g line. Examples thereof include: ketone compound such as 2,2-dimethoxy-1,2-diphenylethane-1-one and 2-hydroxy-2-methyl-1-phenyl-propane-1-one; phosphon oxide compound such as bis(2,4,6-trimethyl benzoyl)-phenylphosphon oxide and bis(2,6-dimethoxy benzoyl)-2,4,4-trimethyl-penthylphosphin oxide; titanocen compound such as bis(2,4-cyclopentadien-1-yl)-bis(2,6-difluoro-3-(1H-pyrrole-1-yl)-phenyl)titanium; and the like. Particularly, it is preferable to use a phosphon oxide compound or a titanocen compound whose sensitivity is high.

Further, the photocation generating agent is not particularly limited, but examples thereof include diphenyl iodonium saline such as diphenyl iodonium salt of dimethoxy anthraquinone sulphone; trphnyl sulphonium saline; pyrylinium saline; triphenyl onium saline; diazonium; and the like. Note that, not only the foregoing saline but also an alicyclic epoxy or vinyl ether compound having a high cation-curing property may be mixed.

Further, the photobase generating agent is not particularly limited, but examples thereof include: a benzylalcohol-urethane compound obtained by reacting nitro benzylalcohol or dinitro benzylalcohol with isocyanate; a phenylalcohol-urethane compound obtained by reacting nitro-1-phenylethylalcohol or dinitro-1-phenylethylalcohol with isocyanate; a propanol-urethane compound obtained by reacting dimethoxy-2-phenyl-2-propanol with isocyanate; and the like.

Further, the photoacid generating agent is not particularly limited, but examples thereof include: a compound which allows generation of sulfonic acid such as iodonium salt, sulfonium salt, and onium salt; a compound which allows generation of carboxylic acid such as naphthoquinone diazide; and the like. Alternatively, it is preferable to use compounds such as diazonium salt and bis(trichloromethyl)triazine because each of these compounds allows generation of a sulfone group in response to irradiation of light.

While, the sensitizer is not particularly limited, but examples thereof include Michler's keton, bis-4,4′-diethylamino benzophenone, 3,3′-carbonylbis(7-diethylamino)coumarin, 2-(p-dimethylamino styryl) quinoline, 4-(p-dimethylamino styryl) quinoline, and the like.

The photoreaction initiators and/or the sensitizers may be independently used, or a suitable combination of two or more kinds may be used. For example, in case of using the radical generating agent and the sensitizer in combination, it is possible to favorably use a combination of (i) peroxide such as bis(2,4,6-trimethyl benzoyl) phenylphosphinoxide and (ii) 3,3′,4,4′-tetra (t-butylperoxycarbonyl)benzophenone, in order to effectively increase the sensitivity.

In the photosensitive resin composition according to the present invention, in case of using the base polymeras the base resin component (A), a content (amount) of the photoreaction initiator and/or the sensitizer is not particularly limited. However, with respect to the essential components, i.e., 100 parts by weight (total weight) of the base resin component (A) and the (meth)acryls compound (B), the amount of the photoreaction initiator and/or the sensitizer preferably ranges from 0.001 to 10 parts by weight, more preferably from 0.01 to 10 parts by weight. When the amount of the photoreaction initiator and/or the sensitizer is less than 0.001 parts by weight with respect to 100 parts by weight (total weight) of the essential components, or when the amount exceeds 10 parts by weight, it is impossible to obtain the sensitization effect, so that this may have bad influence on the developing property. Thus, this is not preferable.

<In case of using Photosensitive IMASO (A-3) as Base Resin Component (A)>

Next, in case of using the photosensitive IMASO (A-3) as the base resin component (A), it is possible to favorably use, as the developing property improving additive, at least one kind selected from the photoreaction initiator, the sensitizer, and the photopolymerization assistant. Among them, the photoreaction initiator is not particularly limited, but a specific example thereof is a compound (the radical generating agent) which generates a radical in response to light whose wavelength is as large as a g line.

A more specific example of the radical generating agent used in case of using the photosensitive IMASO (A-3) is an acylphosphinoxide compound represented by each of the following formulas (α·β) 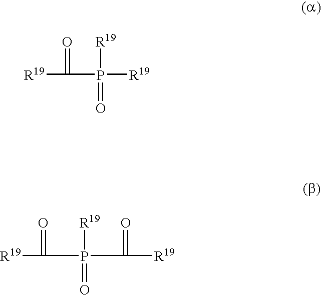
where R¹⁹ represents C₆H₅—, C₆H₄(CH₃)—, C₆H₃(CH₃)₂—, C₆H₂(CH₃)₃—, (CH₃)₃C—, C₆H₃Cl₂—, methoxy group, or ethoxy group.

The radical generated by the acylphosphinoxide compound reacts with a reaction group (vinyl, acryloyl, methacryloyl, allyl, and the like) having a double bond so as to promote the cross-linking. Particularly, it is preferable to use an acylphosphinoxide compound represented by the formula (β) since the acylphosphinoxide compound allows four radicals to be generated by a splitting (note that, the acylphosphinoxide compound represented by the formula (α) allows generation of two radicals).

The photoreaction initiator is not particularly limited, but specific examples thereof include bis(2,4,6-trimethyl benzoyl)-phenylphosphinoxide, 3,3′,4,4′-tetra (t-butylperoxy carbonyl)benzophenone, 2,2-dimethoxy-1,2-diphenylmethane-1-one, bis(η5-2,4-cyclopentanediene-1-yl)bis(2,6-difluoro-3-(1H-pyrrole-1-yl)-bis(2,6-difluoro-3-(1H-pyrrole-1-yl)-phenyl)titanium.

Further, in the acylphosphinoxide compound, various kinds of peroxide can be used as the radical initiator in combination with the sensitizer described later. Particularly, it is preferable to use 3,3′,4,4′-tetra(t-butylperoxycarbonyl)benzophenon in combination with the sensitizer.

An amount of the photoreaction initiator blended is not particularly limited as long as it is possible to give the photosensitivity (developing property). However, with respect to 100 parts by weight of the photosensitive IMASO (A-3), the amount of the photoreaction initiator blended preferably ranges from 0.001 to 10 parts by weight, more preferably from 0.01 to 10 parts by weight. When the amount of the photoreaction initiator blended deviates from these ranges, it may be impossible to realize the sufficient photosensitivity.

Further, in case of using the photosensitive IMASO (A-3) as the base resin component (A), the sensitizer is blended as the developing property improving additive (C-1), so that it is possible to achieve the desired photosensitivity. Specific examples of the sensitizer include: Michler's keton, bis-4,47-diethylaminobenzophenon, benzophenon, camphor quinone, benzyl, 4,4′-dimethylaminobenzyl, 3,5-bis(diethylamino benzylidene)-N-methyl-4-pipelidone, 3,5-bis(dimethylamino benzylidene)-N-methyl-4-pipelidone, 3,5-bis(diethylamino benzylidene)-N-methyl-4-pipelidone, 3,3′-carboriylbis(7-diethylamino)coumarin, riboflavintetrabutylate, 2-methyl-1-[4-(methylthio)phenyl]-2-morpholinopropane-1-one, 2,4-dimethylthioxanthene, 2,4-diethylthioxanthene, 2,4-diisopropylthioxanthene, 3,5-dimethylthioxanthene, 3,5-diisopropylthioxanthene, 1-phenyl-2-(ethoxycarbonyl)oxyiminopropane-1-one, benzoin ether, benzoinisopropylether, benzanthrone, 5-nitroacenaphthene, 2-nitrofluorene, anthrone, 1,2-benzanthraquinone, 1-phenyl-5-mercapto-1H-tetrazole, thioxanthene-9-one, 10-thioxanthenone, 3-acetylindole, 2,6-di(p-dimethylaminobenzal)-4-carboxycyclohexanone, 2,6-di(p-dimethylaminobenzal)-4-hydroxycyclohexanone, 2,6-di(p-diethylaminobenzal)-4-carboxycyclohexanone, 2,6-di(p-diethylaminobenzal)-4-hydroxycyclohexanone, 4,6-dimethyl-7-ethylaminocoumarin, 7-diethylamino-4-methylcoumarin, 7-diethylamino-4-methylcoumarin, 7-diethylamino-3-(1-methylbenzoimidazolyl)coumarin, 3-(2-benzoimidazolyl)-7-diethylaminocoumarin, 3-(2-benzothiazolyl)-7-diethylaminocoumarin, 2-(p-dimethylaminostyryl)benzoxazole, 2-(p-dimethylaminostilyl)quinoline, 4-(p-dimethylaminostilyl)quinoline, 2-(p-dimethylaminostilyl)benzothiazole, 2-(p-dimethylaminostilyl)-3,3-dimethyl-3H-indole, and the like, but the sensitizer is not limited to them. These sensitizers may be independently used, or a suitable combination of two or more kinds may be used.

An amount of the sensitizer blended is not particularly limited as long as it is possible to exhibit the sensitization effect. Specifically, with respect to 100 parts by weight of the photosensitive IMASO (A-3), the amount of the sensitizer blended preferably ranges from 0.1 to 50 parts by weight, more preferably from 0.3 to 20 parts by weight. It is not preferable that the amount deviates from the foregoing ranges because it is impossible to obtain the sensitization effect and this may have a bad influence on the developing property.

Further, in case of using the photosensitive IMASO (A-3) as the base resin component (A), the photopolymerization assistant is blended as the developing property improving additive (C-1), so that it is possible to achieve the practical sensitivity. Specific examples of the photopolymerization assistant include 4-diethylaminoethylbenzoate, 4-dimethylaminoethylbenzoate, 4-diethylaminopropylbenzoate, 4-dimethylaminopropylbenzoate, 4-dimethylaminoisoamylebenzoate, N-phenylglycine, N-methyl-N-phenylglycine, N-(4-cyanophenyl)glycine, 4-dimethylaminobenzonitryl, ethyleneglycoldithioglycolate, ethyleneglycol di (3-mercaptopropionate), trimethylolpropanethioglycolate, trimethylolpropane tri(3-mercaptopropionate), pentaerythritoltetrathioglycolate, pentaerythritol tetra (3-mercaptopropionate), trimethylofethanetrithioglycolate, trimethylolpropanetrithioglycolate, trimethylolethane tri(3-mercaptopropionate), dipentaerythritolhexa(3-mercaptopropionate), thioglycolic acid, α-mercaptopropionic acid, t-butylperoxybenzoate, t-butylperoxymethoxybenzoate, t-butylperoxynitrobenzoate, t-butylperoxyethylbenzoate, phenylisopropylperoxybenzoate, di t-butyldiperoxyisophthalate, tri t-butyltriperoxytrimellitate, tri t-butyltriperoxytritrimesitate, tetra t-butyltetraperoxypyromellitate, 2,5-dimethyl-2,5-di(benzoylperoxy)hexane, 3,3′,4,4′-tetra(t-butylperoxycarbonyl)benzophenone, 3,3,4,4′-tetra(t-amylperoxycarbonyl)benzophenone, 3,3′,4,4′-tetra(t-hexylperoxycarbonyl)benzophenone, 2,6-di(p-azidobenzal)-4-hydroxycyclohexanone, 2,6-di(p-azidobenzal)-4-carboxycyclohexanone, 2,6-di(p-azidobenzal)-4-methoxycyclohexanone, 2,6-di(p-azidobenzal)-4-hydroxycyclohexanone, 3,5-di(p-azidobenzal)-1-methyl-4-piperidone, 3,5-di(p-azidobenzal)-4-piperidone, 3,5-di(p-azidobenzal)-N-acetyl-4-piperidone, 3,5-di(p-azidobenzal)-N-methocycarbonyl-4-piperidone, 2,6-di(p-azidobenzal)-4-hydroxycyclohexanone, 3,6-di(m-azidobenzal)-4-carboxycyclohexanone, 2,6-di(m-azidobenzal)-4-methoxycyclohexanone, 2,6-di(m-azidobenzal)-4-hydroxycyclohexanone, 3,5-di(m-azidobenzal)-N-methyl-4-piperidone, 3,5-di(m-azidobenzal)-4-piperidone, 3,5-di(m-azidobenzal)-N-acetyl-4-piperidone, 3,5-di(m-azidobenzal)-N-methoxycarbonyl-4-piperidone, 2,6-di(p-azidecinnamyliden)-4-hydroxycyclohexanone, 2,6-di(p-azidecinnamyliden)-4-carboxycyclohexanone, 2,6-di(p-azidecinnamyliden)-4-cyclohexanone, 3,5-di(p-azidecinnamyliden)-N-methyl-4-piperidone, 4,4′-diazidochalcone, 3,3′-diazidochalcone, 3,4′-diazidochalcone, 4,3′-diazidochalcone, 1,3-diphenyl-1,2,3-propanetrione-2-(o-acetyl)oxime, 1,3-diphenyl-1,2,3-propanetrione-2-(o-n-propylcarbonyl)oxime, 1,3-diphenyl-1,2,3-propanetrione-2-(o-methoxycarbonyl)oxime, 1,3-diphenyl-1,2,3-propanetrione-2-(o-ethoxycarbonyl)oxime, 1,3-diphenyl-1,2,3-propanetrione-2-(o-benzoyl)oxime, 1,3-diphenyl-1,2,3-propanetrione-2-(o-phenyloxycarbonyl)oxime, 1,3-bis(p-methylphenyl)-1,2,3-propanetrione-2-(o-benzoyl)oxime, 1,3-bis(p-methoxyphenyl)-1,2,3-propanetrione-2-(o-ethoxycarbonyl)oxime, 1-(p-methoxyphenyl)-3-(p-nitrophenyl)-1,2,3-propanetrione-2-(o-phenyloxycarbonyl)oxime, and the like, but the photopolymerization assistant is not limited to them. Further, as another assistant, it is possible to use trialkylamines such as triethylamine, tributylamine, triethernolamine, and the like. These photopolymerization assistants may be independently used, or a suitable combination of two or more kinds may be used.

An amount of the photopolymerization assistant blended is not particularly limited as long as it is possible to exhibit the practical photosensitivity. Specifically, with respect to 100 parts by weight of the photosensitive IMASO (A-3), the amount of the photopolymerization assistant blended preferably ranges from 0.1 to 50 parts by weight, more preferably from 0.3 to 20 parts by weight. It is not preferable that the amount deviates from the foregoing ranges because it is impossible to obtain the desired sensitization effect and this may have a bad influence on the developing property.

### (III-2) Flame Retardant (C-2)

In order to give the flame retardancy to the cured photosensitive dry film resist, the photosensitive resin composition according to the present invention may contain the frame retardant as the accessory component (C-2). The frame retardant is not particularly limited, but examples thereof include: a phosphoric compound such as phosphate ester, condensed phosphate ester, and phosphorous-nitrogenous compound; a halogenous compound such as bromic organic compound; a siloxane (silicone) compound having a siloxane structure; and the like. These frame retardants may be independently used, or a suitable combination of two or more kinds may be used.

<Phosphoric Compound>

The phosphoric compound used in the present invention is not particularly limited. However, in order to effectively give the flame retardancy, an amount of phosphorus contained is preferably 5.0 wt % or more, more preferably 7.0 wt % or more.

Specific examples of the phosphoric compound include: a phosphoric compound such as phosphine, phosphineoxide, phosphagen compound, phosphate ester (including condensed phosphate ester), and phosphite ester; a phosphorous-nitrogenous compound having a phosphorus atom and a nitrogen atom in its molecule; and the like. Particularly, in case of using the photosensitive IMASO (A-3) as the base resin component (A), among the compounds, it is more preferable to use phosphineoxide or phosphate ester (including condensed phosphate ester) in terms of compatibility with respect to the photosensitive IMASO.

Generally, the phosphoric compound may be hydrolyzed under a pressure with humidity, so that it is possible to favorably use a compound having an ester structure since the compound can give the flame retardancy to the obtained photosensitive resin composition and photosensitive dry film resist and since the compound itself has an anti-hydrolysis property.

Specific examples thereof include: phosphate ester such as TPP (triphenylphosphate), TCP (tricresyl phosphate), TXP (trixylenyl phosphate), CDP (cresyl diphenyl phophate), and PX-110 (cledyl2,6-xylenyphosphate) (all of which are commercial names: products of DAIHACHI CHEMICAL INDUSTRY CO., LTD.); non-halogenous condensed phosphate ester such as CR-733S (resorcinoldiphosphate), CR-741, CR-747, and PX-200) (all of which are commercial names: products of DAIHACHI CHEMICAL INDUSTRY CO., LTD.); phosphate (meth)acrylate such as BISCOAT V3PA (commercial name: product of Osaka Organic Chemical Industry Ltd.) and MR-260 (commercial name: product of DAIHACHI CHEMICAL INDUSTRY CO., LTD.); phosphite ester such as phosphite triphenylester; and the like.

Further, when the bromic compound and the phosphorous compound are used together also in case of using not the phosphorous compound having the ester structure but other phosphorous compound, it is possible to realize both the flame retardancy and the anti-hydrolysis property.

<Halogenous Compound>

The halogenous compound used as the flame retardant is not particularly limited. However, in order to effectively give the flame retardancy, an amount of halogen contained is preferably 15 wt % or more, more preferably 20 wt % or more, still more preferably 30 wt % or more, particularly preferably 40 wt % or more, most preferably 50 wt % or more. In order to improve the flame retardancy, a larger amount of halogen is more preferable.

As the halogen contained in the halogenous compound, particularly, an organic compound having chlorine or bromine is generally used. However, in order to give the flame retardancy, it is preferable to use a compound having bromine (bromic organic compound). Specific examples of the bromic organic compound include: a bormic monomer (particularly, a bromic(meth)acryls compound) such as NEW FRONTIER BR-30, BR-30M, BR-31, and BR-42M (all of which are commercial names: products of Dai-ichi Kogyo Seiyaku Co., Ltd.); bromic aromatic triazine such as PYROGUARD SR-245 (commercial name: product of Dai-ichi Kogyo Seiyaku Co., Ltd.); bromic aromatic polymer such as PYROGUARD SR-250 and SR-400A (both of which are commercial names: products of Dai-ichi Kogyo Seiyaku Co., Ltd.); a bromic aromatic compound such as PYROGUARD SR-990A (commercial name: product of Dai-ichi Kogyo Seiyaku Co., Ltd.); and the like, but the bromic organic compound is not particularly limited.

Further, the flame retardant may be a compound which serves as both the halogenous compound and the phosphorus compound. That is, it is possible to use a phosphorus compound having a halogen atom in its molecule. Specific examples of such compound include halogen phosphate ester and condensed phosphate ester having halogen atom, e.g., CLP (tris(2-chloroethyl)phophate), TMCPP (tris(chloropropyl)phosphate, CRP (tris(dichloropropyl)phosphate, CR-900 (tris(tribromoneopenthyl)phosphate) (all of which are commercial names: products of DAIHACHI CHEMICAL INDUSTRY CO., LTD.), but the compound is not particularly limited.

<Siloxane Compound>

The siloxane compound (silicone compound) used as the flame retardant is not particularly limited. However, in order to effectively give not only the flame retardancy but also the heat resistance, it is preferable to use an organopolysiloxane compound having aromatic rings at a high ratio. With respect to all the organic substitutional groups, the organopolysiloxane compound contains 10% or more of phenyl groups, preferably 20% or more of phenyl groups, more preferably 25% or more of phenyl groups. As the amount of phenyl groups contained is smaller, the flame retardance effect decreases. As the amount of phenyl groups contained is larger, the flame retardance effect increases. Therefore, it is preferable to use such organopolysiloxane compound.

Further, in case of using an organopolysiloxane compound having a small amount of phenyl groups as the flame retardant, its dispersibility and compatibility with respect to the base resin component (A) and the (meth)acryls compound (B) are likely to drop. Thus, in case of making the photosensitive resin composition according to the present invention into a film shape, only a less transparent film in which plural components different from each other in terms of a refraction are separated from each other or only an opaque film is likely to be obtained. Further, in case of using the organopolysiloxane compound having a small amount of phenyl groups, unless the amount of the compound added is increased, it is difficult to obtain the sufficient flame retardance effect. Adversely, when the amount of the compound added is increased, the obtained photosensitive dry film resist is likely to significantly deteriorate in terms of properties such as mechanical strength after being cured.

When the organopolysiloxane compound is used as the flame retardant, it is possible to realize the flame retardancy of the photosensitive resin composition without generating any harmful gas at the time of combustion. In case of the photosensitive resin composition having a halogenous compound, it is possible to realize the flame retardancy, but harmful halogenous gas disadvantageously occurs at the time of combustion.

A structure of the organopolysiloxane is generally a combination of a trifunctional siloxane unit (T unit), a difunctional siloxane unit (D unit), and a tetrafunctional siloxane unit (Q unit). However, an example of a preferable combination of the organosiloxane compound favorably used as the flame retardant in the present invention is a system containing D unit, e.g., a T/D system, a T/D/Q system, and a D/Q system. These combinations realize the favorable flame retardancy.

However, in any combination, the D unit has to be contained so as to be within a range of from 10 to 80 mol %, and it is preferable that the D unit is contained so as to be within a range of from 10 to 70 mol %. When the amount of the D unit contained is less than 10 mol %, the organopolysiloxane compound has less flexibility. As a result, it is impossible to obtain the sufficient flame retardancy. Further, when the amount of the D unit contained exceeds 80 mol %, its dispersibility and solubility with respect to the base resin component (A) drop, and the photosensitive resin composition deteriorates in terms of its appearance, optical transparency, and strength.

Taking into consideration a preferable amount of the D unit contained, an amount of the T unit contained in the T/D system ranges from 30 to 90 mol %, and an amount of the T unit contained in the T/D/Q system or the D/Q system ranges from 0 to 89.99 mol %, preferably from 10 to 79.99 mol %, and an amount of the Q unit contained in T/D/Q system or the D/Q system ranges from 0.01 to 50 mol %.

As long as the space can be used freely to some extent, it is more advantageous to have a larger amount of a Q unit whose oxidation degree is high to realize flame retardancy. However, when a ratio of the Q unit contained in the organopolysiloxane compound exceeds 60 mol %, the organopolysiloxane compound excessively exhibits a characteristic of inorganic fine particles, so that its dispersibility with respect to the photosensitive IMASO (A) drops. Therefore, in case of the T/D/Q system or the D/Q system, it is necessary to suppress the ratio of the Q unit to be the upper limit or a lower value.

Taking into consideration balance of the flame retardancy, the easiness to process, a performance of the molded product, in terms of a preferable range of the amount of the siloxane unit contained, it is particularly preferable to select a compound in which an amount of the T unit ranges from 40 to 80 wt % with respect to a total weight of a phenylsiloxane contained in the organopolysiloxane compound.

Here, as to the preferable siloxane unit, specific examples of the trifunctional siloxane unit (T unit) include C₆H₅SiO_{3/2} and CH₃SiO_{3/2}, and specific examples of the difunctional siloxane unit (D unit) include (C₆H₅)₂SiO_{2/2}, (CH₃)C₆H₅SiO_{2/2}, and (CH₃)₂SiO_{2/2}.

Among the siloxane units, a dimethylsiloxane unit ((CH₃)₂SiO_{2/2}) serving as the D unit which gives the flexibility gives the flexibility to the silicone resin very effectively. However, when the dimethylsiloxane unit is excessively contained, the flame retardancy is likely to drop. Thus, it is not preferable to add a large amount of the dimethylsiloxane unit. Therefore, it is preferable to suppress the amount of the dimethylsiloxane unit to be 60 mol % or less in the D unit.

Further, among the siloxane units, the most preferable unit is the methylphenyl siloxane unit ((CH₃)C₆H₅SiO_{2/2}) since the methylphenyl siloxane unit can give the flexibility and can increase the amount of the phenyl groups contained.

While, the diphenyl siloxane unit ((C₆H₅)₂SiO_{2/2}) is superior in keeping the amount of the phenyl groups high, but the diphenyl siloxane unit has such a structure that phenyl groups having large volumes get together closely on a single Si. Thus, when a large amount of the diphenyl siloxane units is blended, an organosiloxane molecule has a structure whose steric exclusion is significant. The structure whose steric exclusion is significant drops the degree of spacial freedom of the siloxane frame, so that aromatic rings whose coupling results in activation of the flame retardance mechanism have difficulty in overlapping with each other. As a result, the flame retardance effect of the organopolysiloxane compound may drop.

For the foregoing reasons, the D unit contained in the organopolysiloxane compound is used so as to satisfy the foregoing ranges, and it is preferable that the methylphenyl siloxane unit is mainly contained.

In case where the organopolysiloxane compound includes the phenyl siloxane structure, its average molecular weight preferably ranges from 300 to 50000, more preferably from 400 to 30000. It is not preferable that the average molecular weight is less than 300 since the organopolysiloxane compound may exude when the photosensitive resin composition is in the stage state B. While, when the average molecular weight exceeds 50000, the photosensitive resin composition has lower solubility with respect to the developer, and the developing time is longer, so that the easiness to process may drop.

It is possible to produce the organopolysiloxane compound in accordance with a known method. For example, organochlorosilane and/or organoalcoxysilane which can form each of the siloxane units in accordance with hydrolysis condensation reaction, or a partial hydrolysis condensed substance thereof (these substances are generically referred to as a silane compound) is used as the material, and excessive water whose amount is sufficient to hydrolyze all the hydrolytic groups (a chloro group, an alcoxy group, and the like) of the silane compound and an organic solvent which can dissolve the silane compound and the generated organopolysiloxane compound are mixed so as to prepare a mixture solution, and the silane compound is added to and is mixed with the mixture solution, and hydrolysis condensation reaction is carried out with respect to the resultant, thereby obtaining the organopolysiloxane compound.

In order to obtain the organopolysiloxane compound having a desired weight-average molecular weight, conditions such as a reaction temperature, reaction time, water, and an amount of organic solvent to be blended are adjusted. In use, thus obtained organopolysiloxane compound may be made in a powder state after removing unnecessary organic solvent.

More specific examples of the organopolysiloxane compound include KF50-100S, KF54, KF56, HIVAC F4, HIVAC F5, X-22-1824B, KR^{211,} and KR311 (all of which are commercial names: products of Shin-Etsu Silicone Co., Ltd.). These compounds may be independently used, or a suitable combination of two or more kinds may be used.

<Amount of Flame Retardant Contained>

In the photosensitive resin composition according to the present invention, an amount of the flame retardant contained (an amount of the flame retardant added) is not particularly limited. However, in case of using the base polymer as the base resin component (A), with respect to 100 parts by weight (total weight) of the essential components, i.e., the base resin component (A) and the (meth)acryls compound (B), the amount of the flame retardant preferably ranges from 1 to 100 parts by weight, more preferably from 1 to 50 parts by weight, particularly preferably from 1 to 40 parts by weight.

It is not preferable that the amount of the flame retardant is less than 1 part by weight with respect to 100 parts by weight (total weight) of the essential components since it is impossible to obtain the sufficient flame retardant effect. While, when the amount of the flame retardant exceeds 100 parts by weight, the photosensitive dry film resist in the B stage (half-cured) state is likely to be cloggy, and the resin is likely to exude at the time of thermal pressure. Moreover, this may have a bad influence on properties of the cured product. Thus, it is not preferable that the amount of the flame retardant exceeds 100 parts by weight.

While, in case of using the photosensitive IMASO (A-3) as the base resin component (A), with respect to 100 parts by weight of the photosensitive IMASO (A-3) and 5 to 200 parts by weight of the (meth)acryls compound. (B), the amount of the flame retardant preferably ranges from 5 to 200 parts by weight, more preferably from 5 to 50 parts by weight. In other words, with respect to a total weight of the photosensitive IMASO (A-3) and the (meth)acryls compound (B), the amount of the flame retardant preferably ranges from 5 to 200 wt %, more preferably from 5 to 50 wt %.

When the amount of the flame retardant contained is less than 5 wt %, it is likely to be difficult to give the flame retardancy to the cured photosensitive dry film resist. While, when the amount of the flame retardant contained exceeds 200 wt %, the mechanical property of the cured photosensitive dry film resist drops, so that the photocuring property is likely to drop. Thus, it is not preferable that the amount of the flame retardant contained exceeds 200 wt %.

Further, in case of using the halogenous compound as the flame retardant, it is preferable to add antimony trioxide and/or antimony pentoxide. Each antimony oxide draws halogen atoms from the flame retardant at a temperature range at which thermal decomposition of plastic begins, thereby forming antimony halide. Thus, it is possible to increase the flame retardant effect in a synergistic manner. With respect to a total weight of the photosensitive IMASO (A-3), the (meth)acryls compound (B), and the flame retardant (halogenous compound), an amount of the antimony oxide added preferably ranges from 0.1 to 10 wt %, more preferably from 1 to 6 wt %.

The antimony oxide such as the antimony trioxide and the antimony pentoxide is white powder which is not dissolved in the organic solvent. Thus, it is preferable that a particle diameter of the powder is 100 μm or less. When the particle diameter exceeds 100 μm, the added photosensitive resin composition becomes milky-colored. Thus, although it is possible to give the flame retardant effect to the obtained photosensitive dry film resist or the like, its transparency and developing property are likely to drop. Further, when the particle diameter of the antimony oxide powder is 50 μm or less, preferably 10 μm or less, more preferably 5 μm or less, it is possible to improve the flame retardant effect without losing the transparency of the obtained photosensitive dry film resist or the like.

Examples of antimony pentoxide whose particle diameter is 50 μm or less include Sunepoch NA-3181, NA-4800, NA-1300, and NA-1070L (all of which are commercial names: products of Nissan Chemical Industries, Ltd.).

The antimony oxide may be mixed in the photosensitive resin composition so that the antimony oxide is in a powder state. Alternatively, when the powder precipitates in the photosensitive resin composition, it may be so arranged that: the powder is dispersed in the organic solvent, and thus obtained resultant is made in a sol state, and is mixed. A specific example of a method for realizing the sol state is as follows: the antimony oxide powder and the dispersant are added to the organic solvent so as to form a network, thereby preventing the powder from precipitating. As the dispersant, it is possible to favorably use a mixture of vapor phase silica (silicon dioxide) and alumina (aluminum trioxide). It is preferable to add the dispersant so that its amount is twice to five times as large as a total weight of the antimony oxide.

### (III-3) Epoxy Resin (C-3)

The photosensitive resin composition according to the present invention may contain the epoxy resin (C-3) as the accessory component (C). When the photosensitive resin composition according to the present invention contains the epoxy resin, the obtained photosensitive dry film resist can obtain higher adhesiveness with respect to a copper foil, a polyimide film, and the like.

The epoxy resin used in the present invention is not particularly limited as long as the resin contains an epoxy group in its molecule. Specific examples thereof include: a bisphenol A type epoxy resin such as Epikote 828, 834, 1001, 1002, 1003, 1004, 1005, 1007, 1010, and 1100L (all of which are commercial names: products of Japan Epoxy Resins Co., Ltd.); a brominated bisphenol A type epoxy resin such as Epikote 5050, 5051, and 5051H (all of which are commercial names: products of Japan Epoxy Resins Co., Ltd.); an o-cresolnovolak-type epoxy resin such as ESCN-220L, 220F, 220H, 220HH, 180H65, and 180S65 (all of which are commercial names: products of Japan Epoxy Resins Co., Ltd.); a novolak type epoxy resin such as 1032H60 (commercial name: product of Japan Epoxy Resins Co., Ltd.: trihydroxyphenylmethanenovolak type), EPPN-502H (commercial name: product of Nippon Kayaku Co., Ltd.: trihydroxyphenylmethanenovolak type), ESN-375 and ESN-185 (both of which are commercial names: products of Nippon Steel Chemical Group: naphthalenearalkylnovolak type), and 157S70 (commercial name: product of Japan Epoxy Resins Co., Ltd.: bisphenol A novolak type); bisphenol type epoxy resin such as YX4000H (commercial name: product of Japan Epoxy Resins Co., Ltd.); and the like.

Further, it is possible to use not only the main kinds of epoxy resins but also a bisphenol A glycidyl ether type epoxy resin, a bisphenol F glycidyl ether type epoxy resin, novolak glycidyl ether type epoxy resin, a glycidyl ester type epoxy resin, a glycidyl ester type epoxy resin, a glycidyl amine type epoxy resin, a cyclic fatty epoxy resin, an aromatic epoxy resin, a halogenous epoxy resin, and the like.

Particularly, in case of using the photosensitive IMASO (A-3) as the base resin component (A), it is possible to use not only the main kinds of epoxy resins but also a glycidyl amine type epoxy resin as a main kind of the epoxy resin. Specific examples of the glycidyl amine type epoxy resin include tetraphenylolethane 1031S (commercial name: product of Japan Epoxy Resins Co., Ltd.), YGD414S (commercial name: product of Tohto Kasei CO., Ltd.), trishydroxyphenylmethane EPPN502H (commercial name: Nippon Kasei Chemical Co., Ltd.), special bisphenol VG3101L (commercial name: product of Mitsui Chemicals. Inc.), special naphthol NC7000 (commercial name: product of Nippon Kayaku Co., Ltd.), TETRAD-X and TETRAD-C (both of which are commercial names: products of MITSUBISHI GAS CHEMICAL COMPANY. INC., and the like.

In the photosensitive resin composition according to the present invention, the various epoxy resins may be independently used, or a suitable combination of two or more kinds may be used.

In the photosensitive resin composition according to the present invention, an amount of the epoxy resin contained (an amount of the epoxy resin added) is not particularly limited. However, with respect to 100 parts by weight of the component (A) (base polymer), the amount of the epoxy resin preferably ranges from 1 to 100 parts by weight, more preferably from 1 to 50 parts by weight, particularly preferably from 2 to 30 parts by weight.

It is not preferable that the amount of the epoxy resin is less than 1 part by weight with respect to 100 parts by weight of the component (A) since the adhesiveness of the obtained photosensitive dry film resist drops. While, it is not preferable that the amount of the epoxy resin exceeds 100 parts by weight since this may cause the heat resistance of the photosensitive dry film resist to drop and may cause the photosensitive dry film resist to be susceptible to damage upon being bent.

Further, in case of using the photosensitive IMASO (A-3) as the base resin component (A), the epoxy resin and a compound having a double bond and a triple bond in its molecule can be mixed in use. The compound is not particularly limited, but specific examples thereof include allyl glycidyl ether, glycidyl acrylate, glycidyl methacrylate, glycidyl vinyl ether, propargyl glycidyl ether, glycidyl propiolate, ethynyl glycidyl ether, and the like.

Further, in case of using the photosensitive IMASO (A-3) as the base resin component (A), it is possible to blend not only the epoxy resin but also: a thermosetting resin such as an acryl resin; and a thermoplastic resin such as polyester, polyamide, polyurethane, and polycarbonate. Further, it is preferable to blend bismaleimide, bisallylnadiimide, a phenolic resin, a cyanate resin, and the like, as a thermosetting resin other than the epoxy resin, since each of these substances gives a more favorable property.

### (III-4) Curing Accelerator and/or Curing Agent (C-4)

In the photosensitive resin composition according to the present invention, in case of using the epoxy resin (C-3) as the accessory component (C), the curing accelerator and/or curing agent (C-4) may be added to the photosensitive resin composition in order to efficiently cure the obtained photosensitive dry film resist. It is preferable to blend these agents since use of these agents results in a cured product having a more preferable property.

The curing accelerator and/or curing agent (C-4) are not particularly limited as long as each agent allows the epoxy resin to be efficiently cured. For example, it is possible to use an imidazol compound, acid anhydride, tertiary amines, hydrazines, aromatic amines(4,4′-diaminodiphenylmethane, 4,4′-diaminodiphenylsulfone, and the like), phenols, triphenylphosphines, organic peroxide, and the like. Further, various coupling agents may be used. These curing accelerators and/or curing agents may be independently used, or a suitable combination of two or more kinds may be used.

In the photosensitive resin composition according to the present invention, an amount of the curing accelerator and/or curing agent contained (an amount of the curing accelerator and/or curing agent added) is not particularly limited. However, with respect to 100 parts by weight of the component (A) (base resin component), the amount of the curing accelerator and/or curing agent preferably ranges from 0.1 to 20 parts by weight, more preferably from 1 to 20 parts by weight, and particularly preferably from 0.5 to 15 parts by weight. It is not preferable that the amount of the curing accelerator and/or curing agent is less than 0.1 parts by weight with respect to 100 parts by weight of the component (A) since it is impossible to sufficiently cure the epoxy resin under this condition. While, it is not preferable that the amount exceeds 20 parts by weight since the heat resistance may drop under this condition.

Note that, it is needless to say that: in the photosensitive resin composition according to the present invention, the photoreaction initiator (C-1), the sensitizer, the photopolymerization assistant, the flame retardant (C-2), the epoxy resin (C-3), the curing accelerator (C-4), and the component other than the curing agent may be contained as the accessory component (C) in accordance with use of the photosensitive resin composition and/or the obtained photosensitive dry film resist.

### (IV) Storage Stabilization Additive (D)

In the photosensitive resin composition according to the present invention, in order to improve the storage stability, it is preferable to further add the storage stabilization additive (D). By adding the storage stabilization additive (D), it is possible to prevent or suppress cross-linking reaction of a polymerizable functional group (e.g., a vinyl group, an acryl group, a methacryl group, and the like) of the base resin component (A) (particularly, the soluble polyimide resin (A-1-3)) and/or the (meth)acryls compound (B) while storing the photosensitive resin composition or the photosensitive dry film resist. Note that, as described above, it is needless to say that also the storage stabilization additive may be contained as an accessory component in the broad sense, but the storage stabilization additive is treated separately from the accessory component (C) for convenience in description.

The storage stabilization additive (D) is not particularly limited as long as the additive inhibits the cross linking reaction of the polymerizable functional group. However, a specific example thereof is at least one kind of additive selected from polymerization inhibitor, stabilizer, and oxidation inhibitor.

The polymerization inhibitor is not particularly limited as long as the inhibitor is generally used as polymerization inhibitor and polymerization retardant or is known inhibitor. Likewise, the stabilizer is not particularly limited as long as the stabilizer is generally used as heat stabilizer and light stabilizer or is known stabilizer. Likewise, the oxidization inhibitor is not particularly limited as long as the inhibitor is generally used as oxidization inhibitor and radical trapping agent or is known inhibitor.

The polymerization inhibitor, the stabilizer, and the oxidization inhibitor are not necessarily respective compounds. For example, there is a case where a single compound may be used as both the polymerization inhibitor and the oxidization inhibitor. Thus, the additive used as the storage stabilization additive (D) will be specifically exemplified without categorizing the additive into the polymerization inhibitor, the stabilizer, and the oxidization inhibitor.

Specific examples of the storage stabilization additive (D) include: a hydroquinone compound such as hydroquinone, methyl hydroquinone, 2,5-di-t-butylhydroquinone, t-butylhydroquinone, 2,5-bis(1,1,3,3-tetramethylbutyl)hydroquinone (DOHQ (commercial name): product of Wako Pure Chemical Industries, Ltd.), and 2,5-bis (1,1-dimethylbutyl)hydroquinone (DHHQ (commercial name): product of Wako Pure Chemical Industries, Ltd.); a benzoquinone compound such as p-benzoquinone, methyl-p-benzoquinone, t-butylbenzoquinone, and 2,5-diphenyl-p-benzoquinone; a hindered phenolic compound such as pentaerythritol tetrakis[3-(3,5-di-t-butyl-4-hydroxyphenyl)propionate] (IRGANOX 1010 (commercial name): product of Ciba Specialty Chemicals), N,N′-hexane-1,6-diylbis[3-(3,5-di-t-butyl-4-hydroxyphenyl)propione amide] (IRGANOX 1098 (commercial name): product of Ciba Specialty Chemicals), 1,3,5-tris(3,5-di-t-butyl-4-hydroxybenzyl)-1,3,5-triazine2,4,6 (1H, 3H, 5H)-trione (IRGANOX 3114 (commercial name): product of Ciba Specialty Chemicals), and hydroxyphenolbenzotriazole (ADEKA AO-20 (commercial name): product of Asahi Denka Co., Ltd.); a benzotriazole compound such as 2-(2H-benzotriazole-2-yl)-p-cresol (TINUVIN P (commercial name): product of Ciba Specialty Chemicals); a nitrosamine compound such as N-nitrosphenylhydroxylamine (Q-1300 (commercial name: product of Wako Pure Chemical Industries, Ltd.), and N-nitrosphenylhydroxyaminealuminum salt (Q-1301 (commercial name: product of Wako Pure Chemical Industries, Ltd.); an organic sulfur compound such as phenothiazine, dithiabenzoylsulfide, and dibenzyltetrasulfide; a hindered amine compound such as bis(1,2,2,6,6-pentamethyl-4-piperidyl)[{3,5-bis(1,1-dimethylethyl)4-hydroxyphenyl}methyl]butylmalonate (IRGANOX 144 (commercial name): product of Ciba Specialty Chemicals); aromatic amine such as p-phenylenediamine (paramine: common name), and N,N-diphenyl-p-phenylenediamine; a phosphorus compound such as tris (2,4-di-t-butylphenyl)phosphite (IRGANOX 168 (commercial name): product of Ciba Specialty Chemicals), tetrakis(2,4-di-t-butylphenyl)[1,1-biphenyl]-4,4′-diylbisphosphonate (IRGANOX P-EPQ (commercial name): product of Ciba Specialty Chemicals); and the like, but the storage stabilization additive (D) is not limited to them. These compounds may be independently used, or a suitable combination of two or more kinds may be used.

Among the compounds exemplified above, particularly in terms of the heat stability, it is preferable to use at least any one of the hydroquinone compound, the hindered phenolic compound, the nitrosamine compound, and the aromatic amine.

By using each of these compounds as the storage stabilization additive (D), it is possible to prevent the cross linking reaction of the polymerizable functional group. Thus, even in case where the photosensitive resin composition is stored as varnish for example, it is possible to suppress rise of the viscosity. Therefore, even in case where the photosensitive resin composition is stored as the photosensitive dry film resist, it is possible to improve the storage stability. In addition, when each of the compounds is used, it is possible not only to improve the storage stability but also to prevent oxidization, so that it is possible to prevent deterioration of the photosensitive resin composition. As a result, it is possible to improve long-term heat resistance and anti-hydrolysis property of the photosensitive dry film resist made from the photosensitive resin composition.

### (V) Method for Preparing Photosensitive Resin Composition

Next, a method for preparing the photosensitive resin composition is specifically described as follows. The photosensitive resin composition according to the present invention is a mixture (composition) obtained by mixing the base resin component (the component (A)), the (meth)acryls compound (the component (B)), the accessory component (the component (C)), and the storage stabilization additive (the component (D)) at an arbitrary ratio. Among them, the essential components are the components (A) and (B). The component (C) and/or the component (D) are added as required. How these components are blended is not particularly limited. Note that, a solution obtained by evenly dissolving or dispersing the photosensitive resin composition according to the present invention in an organic solvent is referred to as an organic solvent solution of the photosensitive resin composition (for convenience in description, the solution is referred to as a photosensitive resin composition solution or a photosensitive resin composition varnish as required).

A specific method for preparing the photosensitive resin composition is not particularly limited, but it is preferable to adopt a method in which the components (A) to (D) are added to the organic solvent as required and these components are dissolved or dispersed so as to prepare the photosensitive resin composition solution. According to this method, it is possible to evenly mix these component with each other in the organic solvent. Further, in producing the photosensitive dry film resist described later, it is possible to use the photosensitive resin composition in a solution (varnish) state. Thus, this arrangement has an advantage such as convenience in applying and drying the photosensitive resin composition.

A condition under which the components (A) to (D) are added to the organic solvent as required and are dissolved or dispersed, that is, a condition under which the photosensitive resin composition solution is prepared is not particularly limited, and it is possible to adopt a temperature condition, a stirring condition, and a similar condition, under which the components can be sufficiently dissolved or dispersed.

<In Case of using Base Polymer as Base Resin Component (A)>

The organic solvent is not particularly limited as long as the organic solvent can dissolve components contained in the photosensitive resin composition. Specifically, in case where the component (A) is a base polymer having a hydroxyl group, that is, in case where the component (A) is the polyimide resin having a hydroxyl group (A-1) or the polyamide resin having a hydroxyl group (A-2), for example, it is possible to favorably use: ether solvent such as dioxolane, dioxane, and tetrahydrofuran; ketone solvent such as acetone and methylethylketone; alcohol solvent such as methylalcohol and ethylalcohol; and the like. These organic solvents may be independently used, or a suitable combination of two or more kinds may be used. Note that, in the subsequent step, the organic solvent is removed, so that it is advantageous to select, as the organic solvent, a solvent whose boiling point is as low as possible in terms of the production steps.

Here, in case where the storage stabilization additive (D) is contained, it is important to adjust the viscosity of the photosensitive resin composition solution (varnish). Specifically, in measuring the viscosity of the varnish of the photosensitive resin composition, the varnish is prepared so that its solid content weight ratio (Sc) is 30%, and its viscosity is measured by a B type viscometer. The viscosity of the varnish according to the present invention preferably ranges from 2 to 20 poise. When the viscosity is less than 2 poise, it may be difficult to have a desired thickness of the photosensitive dry film resist. While, when the viscosity exceeds 20 poise, the treatability of the varnish drops, so that easiness to process is likely to drop.

In the varnish of the photosensitive resin composition according to the present invention, when the viscosity right after the preparation (initial viscosity A₀) and the viscosity of the varnish having been left for 7 days at a room temperature (viscosity A₁ after 7 days) are compared with each other, it is preferable that a rising rate of the viscosity A₁ after 7 days is preferably 0% or more to 20% or less. When the rising rate of the viscosity of the varnish exceeds 20%, the treatability of the varnish drops, and an applying/drying condition under which the varnish is applied to the support film so as to produce the photosensitive dry film resist varies, so that such viscosity is not preferable in terms of the productivity. While, when the rising rate is less than 0%, that is, when the viscosity of the varnish having been left for 7 days drops, an applying/drying condition under which the varnish is applied to the support film so as to produce the photosensitive dry film resist varies, so that such viscosity is not preferable in terms of the productivity.

Note that, the room temperature is a normal temperature range (normal temperature) at which neither heating nor cooling is carried out. In the present invention, this temperature is defined as a range from 15 to 25° C.

<In Case of using the Photosensitive IMASO (A-3)>

In case where the component (A) is the photosensitive IMASO (A-3), it is preferable to use an aprotic solar solvent, as the organic solvent used to produce the photosensitive resin composition, in terms of the solubility. Specific examples of the preferable aprotic solar solvent include N-methyl-2-pyrrolidone, N-acetyl-2-pyrrolidone, N-benzyl-2-pyrrolidone, N,N-dimethylformamide, N,N-dimethylacetamide, dimethylsulfoxide, hexamethylphosphortriamide, N-acetyl-ε-caprolactam, dimethylimidazolidinone, diethyleneglycoldimethylether, triethyleneglycoldimethylether, γ-butyrolactone, dioxane, dioxolane, tetrahydrofuran, chloroform, methylene chloride, and the like. These organic solvents may be independently used, or a suitable combination of two or more kinds may be used.

The organic solvent may be obtained by leaving the solvent, used in the synthesis reaction of the photosensitive IMASO (A-3) (or ISO), as a residue, or may be obtained by newly adding to the photosensitive IMASO (A-3) that has been isolated. Further, in order to improve the easiness to apply the solvent, a solvent such as toluene, xylene, diethylketone, methoxybenzene, cyclopentanone, and the like, may be mixed so as not to give bad influence on the solubility of the components such as the photosensitive IMASO (A-3) and the like.

A preferable example of the photosensitive resin composition according to the present invention is as follows: 2,2′-hexafluoropropylidenediphthalic acid dianhydride, 2,3,3′,4′-biphenyltetracarboxylic dianhydride, or acid dianhydride represented by the group (11) is used as a main component of the tetracarboxylic dianhydride, and aromatic diamine having an amino group in an m-position, diamine having a sulfonic acid, or siloxane diamine represented by the formula (6) is used as a part of the diamine component so as to obtain the photosensitive IMASO (A-3), and thus obtained photosensitive IMASO (A-3) is contained.

The photosensitive IMASO (A-3) has much higher solubility with respect to the organic solvent, so that the photosensitive IMASO (A-3) can be dissolved in a solvent having a low boiling point such as 120° C. or lower like (i) an ether solvent such as dioxane, dioxolane, and tetrahydrofuran and (ii) a halogenous solvent such as chloroform and methylene chloride. Particularly, in applying and drying the photosensitive resin composition, it is advantageous to use the solvent having a low boiling point such as 120° C. or lower since it is possible to prevent heat polymerization of the (meth)acryls compound (B).

### (VI) Photosensitive Dry Film Resist and Production Method Thereof

Next, the photosensitive dry film resist according to the present invention and the production method thereof are described as follows. The photosensitive dry film resist according to the present invention is not particularly limited as long as the photosensitive dry film resist is made from the photosensitive resin composition. However, as will be described later, for example, it is possible to adopt: a single layer structure having only a photosensitive resin composition layer; a two-layer structure (two-layer sheet) having a support film and a photosensitive resin composition layer; a three-layer structure (three-layer sheet) having a protective film, a photosensitive resin composition layer, and a support film, which are laminated in this order; and the like.

That is, the present invention may be arranged as a laminate, having a layer constituted of the photosensitive dry film resist, which includes at least either a protective film for protecting a surface of the photosensitive dry film resist or a support film for supporting the photosensitive dry film resist. Further, a single film may be used as both the support film and the protective film.

The production method of the photosensitive dry film resist is not particularly limited. However, it is preferable to adopt a production method in which the photosensitive resin composition solution is evenly applied to and dried on the support film. According to this method, the organic solvent contained in the photosensitive resin composition solution is removed by drying, so that it is possible to obtain the photosensitive dry film resist obtained by forming the photosensitive resin composition into a film shape.

In thus obtained photosensitive dry film resist, the photosensitive resin composition is kept in a half-cured state (B stage). Therefore, in case of carrying out thermocompression bonding such as thermal lamination, the photosensitive dry film resist can exhibit proper fluidity. On this account, it is possible to favorably mount the pattern circuit of the print wiring substrate. Further, after mounting the pattern circuit, an exposure process, a thermocompression bonding process, and heating cure are carried out, thereby completely curing the mounted pattern circuit.

<Applying and Drying of Photosensitive Resin Composition>

A method for applying the photosensitive resin composition solution is not particularly limited, and it is possible to adopt various known methods. Specifically, for example, it is possible to adopt: a method in which the photosensitive resin composition solution is applied by using coating means such as a bar coater or the like; and a method in which the photosensitive resin composition solution is applied by using spraying means such as various sprays. Further, the thickness of the photosensitive resin composition solution layer formed by the application is not particularly limited, and the thickness of the dried layer is set so as to correspond to a purpose of use. For example, as will be described in Examples, it is preferable to set the thickness of the dried layer to be within a range from 20 μm to 25 μmin manufacturing a print substrate.

A method for drying the layer obtained by applying the photosensitive resin composition solution is not particularly limited, but it is preferable to carry out heating and/or hot blast. A drying temperature at which the heating and/or the hot blast are carried out is set so that curing groups (for example, a (meth)acryl group, an epoxy group, a double bond, a triple bond, and the like) contained in the photosensitive resin composition do not react. Specifically, the drying temperature is 180° C. or lower, preferably 150° C. or lower, more preferably 120° C. or lower, particularly preferably 100° C. or lower. Further, it is preferable to decrease the drying time to the extent that the organic solvent can be removed.

<Support Film>

A material for the support film is not particularly limited, but it is possible to use, as the material, various commercial films such as a polyethyleneterephthalate (PET) film, a polyphenylenesulfide film, and a polyimide film. Among the foregoing support films, the PET film is widely used since the PET film has proper heat resistance and can be obtained at relatively low cost. Note that, in a junction between the support film and the photosensitive dry film resist, it is possible to carry out surface treatment in order to improve the adhesiveness and fissility.

The thickness of the support film is not particularly limited, but preferably ranges from 5 μm to 50 μm, more preferably from 10 μm to 30 μm. When the thickness of the support film is less than 5 μm, the support film wrinkles, so that the operability is likely to drop. Therefore, the support film with the thickness of less than 5 μm is not preferable. Further, when the thickness of the-support film exceeds 50 μm, it is difficult to wind the photosensitive dry film resist. Therefore, the support film with the thickness exceeding 50 μm is not preferable.

<Formation of Epoxy Resin Layer>

In the photosensitive dry film resist produced in the foregoing manner, an epoxy resin layer may be further formed on a surface thereof. The epoxy resin layer is provided in order to improve the adhesiveness with respect to the copper foil. The epoxy resin layer is formed so as to be in a thin layer shape by using an organic solvent solution obtained by dissolving an epoxy resin. Note that, the organic solvent solution may further contain a curing agent.

A specific method for forming the epoxy resin layer on the surface of the photosensitive dry film resist is not particularly limited. However, it is possible to adopt any one of the following two methods. That is, it is possible to adopt any one of: (i) a method in which the organic solvent solution obtained by dissolving the epoxy resin is applied directly to the surface of the photosensitive dry film resist using a bar coater or the like, and is dried so as to form the epoxy resin layer; and (ii) a method in which the organic solvent solution obtained by dissolving the epoxy resin is applied to and is dried in the protective film, and the protective film having the epoxy resin layer on its surface is laminated on the photosensitive dry film resist, and then the protective film is exfoliated so as to transcribe the epoxy resin layer to the side of the photosensitive dry film resist.

In the present invention, any one of the foregoing methods may be adopted. According to the method (ii), when the heat resistance of the protective film is low, it is preferable that a drying temperature causes the organic solvent to evaporate and is not too high. The drying temperature in this case is preferably 100° C. or lower, more preferably 80° C. or lower.

<Protective Film>

As described above, the photosensitive dry film resist according to the present invention may be provided with the protective film. The protective film is laminated on the surface (surface-to-be-bonded) of the photosensitive dry film resist. The protective film is combined to the photosensitive dry film resist, so that it is possible to prevent foreign substances and dusts in the air from adhering to a surface-to-be-bonded of the photosensitive dry film resist and it is possible to prevent the quality thereof from being dropped by the drying.

It is preferable that the protective film is exfoliated at the time of use of the photosensitive dry film resist. That is, in case where the photosensitive dry film resist according to the present invention is provided with the protective film, it is preferable to laminate the protective film which can be exfoliated at the time of use. Further, it is preferable that the protective film has the junction with respect to the photosensitive dry film resist, the junction having proper adhesiveness at the time of storage and having high fissility.

A method or an arrangement for laminating the protective film so that the protective film can be exfoliated is not particularly limited. For example, it is possible to favorably adopt a method in which the protective film is laminated on the surface-to-be-bonded of the photosensitive dry film resist at a temperature ranging from 10° C. to 50° C. When the lamination is carried out at this temperature range, it is possible to exfoliate the protective film at the time of use. In contrast, when the temperature at which the lamination is carried out exceeds 50° C., the protective film thermally expands, so that the laminated protective film is wrinkled and curled.

A material for the protective film is not particularly limited, but examples thereof include a polyethylene film (PE film), a polyethylenevinylalcohol film (EVA film), a “film made of copolymer of polyethylene and ethylenevinylalcohol (hereinafter, referred to as a (PE+EVA) copolymer film)”, a “body obtained by combining the PE film to the (PE+EVA) copolymer film”, or a “film obtained by simultaneously extruding the (PE+EVA) copolymer and polyethylene (a film in which one side is a PE film side and the other side is a (PE+EVA) copolymer film side)”.

The PE film can be obtained at low cost and is superior in a surface smoothness property. Further, the (PE+EVA) copolymer film has proper adhesiveness and fissility with respect to the photosensitive dry film resist. By using the protective film, it is possible to improve the smoothness property when a three-layer sheet including three layers of a protection layer, a photosensitive dry film resist (layer of photosensitive resin composition), and a support film is winded into a roll shape.

<Specific Example of Laminate>

As described above, the photosensitive dry film resist according to the present invention may be treated as a single film (a single layer structure constituted merely of a layer of the photosensitive dry film resist the photosensitive resin composition) obtained by applying the photosensitive resin composition solution (varnish) to a support body such as metal and PET and exfoliating the varnish having been dried, but can be treated also as a laminate including the photosensitive dry film resist.

Specifically, the photosensitive dry film resist can be used as a laminate of: (i) a sheet merely laminated on the support film such as PET (a two-layer structure two-layer sheet constituted of the support film and the photosensitive resin composition layer); (ii) a three-layer structure (three-layer sheet) in which the protective film, the photosensitive resin composition layer, and the support film are laminated in this order; and (iii) a structure further including an epoxy resin layer.

That is, the present invention includes a laminate, having a layer constituted of the photosensitive dry film resist, which includes at least either a protective film for protecting a surface of the photosensitive dry film resist or a support film for supporting the photosensitive dry film resist and further includes an epoxy resin layer as required.

### (VII) Use of the Present Invention

As described above, the photosensitive resin composition and the photosensitive dry film resist according to the present invention realizes characteristics such as: (1) realization and improvement of the water system development; (2) improvement of utility as an imidized film; (3) improvement of properties after being cured; and (4) a simpler production process of a print wiring substrate.

Conventionally, in production of the photosensitive resin composition and the photosensitive dry film resist each of which allows the water system development, a technique in which a base polymer having a carboxyl group is used has been adopted. However, this technique raises such a problem that: the heat resistance, the electric insulation property, and the anti-alkali property of the obtained photosensitive resin composition the photosensitive dry film resist drop, and the obtained photosensitive resin composition the obtained photosensitive dry film resist are more likely to be damaged upon being bent. Further, as the base polymer having a hydroxyl group, a base polymer using a photosensitive polyimide resin composition having a phenol ring is known. However, in terms of practical use, this raises such a problem that: the heat resistance, the electric insulation property, the anti-alkali property, and the film remaining ratio are low, and a developing process window is narrow.

In contrast, the present invention uses any one of the polyimide resin having a hydroxyl group (A-1), the polyamide resin having a hydroxyl group (A-2), and the photosensitive IMASO (A-3), as the base resin component (A), and uses the (meth)acryls compound (B) as the oligomer component. Thus, it is possible to effectively solve the conventional problem (it is not possible to realize both the water developing property and other properties), so that it is possible to carry out the water system development and it is possible to obtain a favorable pattern shape at the time of development. As a result, for example, in case of manufacturing a print substrate by using the photosensitive resin composition or the photosensitive dry film resist according to the present invention, this facilitates the manufacture thereof.

Use of the photosensitive resin composition and the photosensitive dry film resist according to the present invention is not particularly limited, but the photosensitive resin composition and the photosensitive dry film resist according to the present invention is typically used in a print wiring substrate (print substrate) on which electronic parts are installed as described above. Thus, the present invention includes a print substrate obtained by using the photosensitive resin composition or the photosensitive dry film resist.

### EXAMPLE 1

### Of Print Wiring Substrate: in Case of Using a Flexible Copper Plate on which a Circuit is Drawn

An example of the print wiring substrate according to the present invention is a print wiring substrate obtained by forming the aforementioned photosensitive dry film resist as an insulating protection layer (insulating protection film). As a more specific example, the following description explains a case of a copper foil of a pattern circuit (hereinafter, this copper foil is referred to as a flexible copper plate having a circuit), but the present invention is not limited to this. Also in case of forming a multi-layer print wiring substrate, it is possible to form an interlayer insulation layer by means of the same technique.

First, the protective film is exfoliated from the three-layer sheet having the protective film, the photosensitive dry film resist, and the support film. In the following description, the two-layer sheet from which the protective film has been exfoliated is referred to as a “photosensitive dry film resist having a support film”. Further, the flexible copper plate having a circuit is covered by the photosensitive dry film resist having a support film, and the photosensitive dry film resist and the flexible copper plate are combined with each other by thermal compression so as to be positioned opposite to each other. As the thermal compression, a thermal press process, a lamination process (thermal lamination process), a thermal roll lamination process, or the like are carried out, and the thermal compression is not particularly limited.

In case of combining the photosensitive dry film resist to the flexible copper plate by means of the thermal lamination process or the thermal roll lamination process (hereinafter, both the processes are referred to merely as a lamination process), a process temperature is not less than a lower limit temperature at which the lamination process can be carried out (hereinafter, the lower limit temperature is referred to as a thermal pressure executable temperature). Specifically, the process temperature preferably ranges from 50° C. to 150° C., more preferably from 60° C. to 120° C., still more preferably from 80° C. to 120° C.

When the process temperature exceeds 150° C., cross-linking reaction of photosensitive reaction groups contained in the photosensitive dry film resist occurs at the time of the lamination process, so that the photosensitive dry film resist is progressively cured. Thus, it is not preferable that the process temperature exceeds 150° C. While, when the process temperature is less than 50° C., the fluidity of the photosensitive dry film resist is low, so that it is difficult to mount the pattern circuit. Further, when the process temperature is less than 50° C., the adhesiveness between the photosensitive dry film resist and a copper circuit or a base film of the flexible copper plate having a circuit may drop.

Due to the thermal compression, the photosensitive dry film resist is laminated on the flexible copper plate having a circuit, and the support film is laminated, thereby obtaining a print substrate precursor (for convenience in description, referred to as a laminated intermediate). Next, the pattern exposure and the development are carried out to the laminated intermediate. In carrying out the pattern exposure and the development, a photomask pattern is disposed on the support film of the laminated intermediate, and an exposure process is carried out through the photomask. Thereafter, the support film is exfoliated and the development process is carried out, thereby forming a hole (via) corresponding to the photomask pattern.

Note that, in the foregoing example, the support film is exfoliated after the exposure process. In order to protect the photosensitive dry film resist, it is preferable to carry out the exfoliation after the exposure process has been completed. However, the timing of the exfoliation of the support film is not limited to this stage, and the exfoliation may be carried out after combining the photosensitive dry film resist having a support film to the flexible copper plate having a circuit, that is, before carrying out the exposure process.

As a light source used in the exposure, it is preferable to use a light source which effectively emits light whose wavelength ranges from 300 to 430 nm. This is because the photoreaction initiator contained in the photosensitive dry film resist generally functions by absorbing light whose wavelength is 450 nm or less.

<Developer>

After the exposure process, the development process is subsequently carried out. As the developer used in the development process, a basic solution in which a basic compound has been dissolved is used. As a solvent which dissolves the basic compound, any solvent may be used as long as the solvent can dissolve the basic compound, and water or an organic solvent may be used. Particularly, in the present invention, it is preferable to use at least water, and it is more preferable to use only water in terms of an environmental problem.

As described above, each of the photosensitive resin composition and the photosensitive dry film resist according to the present invention has a water system developing property. The water system development is development carried out with a basic aqueous solution (alkaline aqueous solution) in which a basic compound is dissolved, and the water system developing property means that it is possible to carry out the water development. In other words, the photosensitive dry film resist of the present invention exhibits solubility (alkali solubility) with respect to the basic aqueous solution in the B stage (half-cured) state, so that it is possible to carry out the water system development. Thus, it is preferable that the developer used to carry out the development process in the present invention is a basic aqueous solution using at least water as a solvent. By realizing the water system developing property, the photosensitive dry film resist according to the present invention can improve the photosensitivity.

The basic compound used in the developer is not particularly limited, but specific examples thereof include: alkaline metal or alkaline earth metal hydroxide or alkaline earth metal carbonate, such as sodium hydroxide, potassium hydroxide, ammonium hydroxide, sodium carbonate, potassium carbonate, ammonium carbonate, sodium hydrogen carbonate, and potassium hydrogen carbonate; ammonium ion hydroxide or ammonium ion carbonate, such as ammonium hydrogen carbonate, tetramethylammoniumhydroxide, tetraethylammoniumhydroxide, tetrapropylammoniumhydroxide, and tetraisopropylammoniumhydroxide; and compounds such as aminomethanol, 2-aminoethanol, 3-aminopropanol, 2-aminopropanol, methylamine, ethylamine, propylamine, isopropylamine, dimethylamine, diethylamine, dipropylamine, diisopropylamine, trimethylamine, triethylamine, tripropylamine, triisopropylamine, 2-dimethylaminoethanol, 3-dimethylamino-1-propanol, 4-dimethylamino-1-butanol, 5-dimethylamino-1-pentanol, 6-dimethylamino-1-hexanol, 2-dimethylamino-2-methyl-1-propanol, 3-dimethylamino-2,2-dimethyl-1-propanol, 2-diethylaminoethanol, 3-diethylamino-1-propanol, 2-diisopropylaminoethanol, 2-di-n-butylaminoethanol, 2-(2-dimethylaminoethoxy)ethanol, 2-(2-diethylaminoethoxy)ethanol, 1-dimethylamino-2-propanol, 1-diethylamino-2-propanol, N-methyldiethanolamine, N-ethyldiethanolamine, N-n-butyldiethanolamine, N-t-butyldiethanolamine, N-lauryldiethanolamine, 3-diethylamino-1,2-propanediol, triethanolamine, triisopropanolamine, N-methylethanolamine, N-ethylethanolamine, N-n-butylethanolamine, N-t-butylethanolamine, diethanolamine, diisopropanolamine, 2-2-aminoethanol, 3-amino-1-propanol, 4-amino-1-butanol, 6-amino-1-hexanol, 1-amino-2-propanol, 2-amino-2,2-dimethyl-1-propanol, 1-aminobutanol, 2-amino-1-butanol, N-(2-aminoethyl)ethanolamine, 2-amino-2-methyl-1,3-propanediol, 2-amino-2-ethyl-1,3-propanediol, 3-amino-1,2-propanediol, and 2-amino-2-hydroxymethyl-1,3-propanediolamine. However, any other compound may be used as long as the compound is soluble in water or alcohol and the solution is basic. These basic compounds may be independently used, or a suitable combination of two or more kinds may be used.

A concentration of the basic compound contained in the basic solution preferably ranges from 0.1 to 10 wt %. In terms of an anti-alkali property of the photosensitive dry film resist, the concentration more preferably ranges from 0. 1 to 5 wt %.

<Developing Method>

In manufacturing the print substrate, a specific method for carrying out the development process (developing method) is not particularly limited. However, for example, it is possible to adopt: a method in which a developing sample (a laminated intermediate from which the support film has been removed) is placed into developer (basic solution) and the developer is stirred; a method in which the developer is sprayed to the developing sample; and a similar method. Among them, it is more preferable to spray the developer.

A specific example of a method for spraying the developer is as follows: in case where 1 wt % of sodium hydroxide whose temperature is 40° C. is used as the developer and a spray developing device is used as the developing means, time required in dissolution at a spray pressure of 0.85 MPa is 180 seconds or less. The spray developing device is not particularly limited as long as the device sprays the developer to the sample.

Further, developing time, i.e., time taken to form a predetermined pattern on the photosensitive dry film resist is not particularly limited, but the developing time is preferably 180 seconds or less, more preferably 90 seconds or less, most preferably 60 seconds or less. When the developing time exceeds 180 seconds, the developing time is too long, so that the productivity is likely to drop. Note that, generally, the developing time is set to be the same or twice as large as time taken to dissolve the photosensitive dry film resist in the basic aqueous solution.

Further, in case where the photosensitive dry film resist (photosensitive resin composition) contains the storage stabilization additive (D), it is preferable that a lower limit of the developing time (i.e., dissolving time) is 20 seconds or more. Thus, it is preferable that the developing time ranges from 20 to 180 seconds. When the developing time is less than 20 seconds, it is necessary to form a favorable pattern in shorter time, so that the workability may drop.

Here, in order to set up a standard of the developing time, time taken to dissolve the photosensitive dry film resist in the B stage (half-cured) state is measured. Specifically, for example, an unexposed sample obtained by combining the photosensitive dry film resist to a lustrous surface of the copper foil is subjected to the spraying development by using sodium hydroxide aqueous solution whose concentration is 1% (liquid temperature is 40° C.) as the developer at a spray pressure of 0.85 MPa. It is preferable that the spraying development causes the photosensitive dry film resist to be dissolved and removed in 180 seconds or less. When the time taken to dissolve and remove the photosensitive dry film resist exceeds 180 seconds, the workability drops.

Further, in case where the photosensitive dry film resist (photosensitive resin composition) contains the storage stabilization additive (D), variation of the time taken to dissolve the photosensitive dry film resist, having been left for 7 days at a room temperature, in the alkali is preferably within a range of ±20%, more preferably within a range of ±10%. When the variation of the dissolving time deviates from the range of ±20%, the developing time for efficiently forming a favorable pattern changes in the developing step described later, so that this is not preferable in terms of the productivity.

As described above, after carrying out the exposure and developing processes, the heating cure is carried out with respect to the photosensitive dry film resist. On this account, it is possible to completely cure the photosensitive dry film resist. As a result, thus cured photosensitive dry film resist serves as an insulating protection film of the print substrate.

Further, in case of forming a multi-layer print wiring substrate, a protective layer of the print wiring substrate is used as an interlayer insulation layer, and sputtering or dipping is carried out with respect to the interlayer insulation layer or a copper foil is combined to the interlayer insulation layer, and then a pattern circuit is formed thereon, so as to laminate the photosensitive dry film resist as described above. On this account, it is possible to produce the multi-layer print wiring substrate.

<Example of Production Method of FPC>

A method for producing the FPC by combining the photosensitive dry film resist to the FPC (for example, a copper foil having a circuit, and the like) is specifically described as follows.

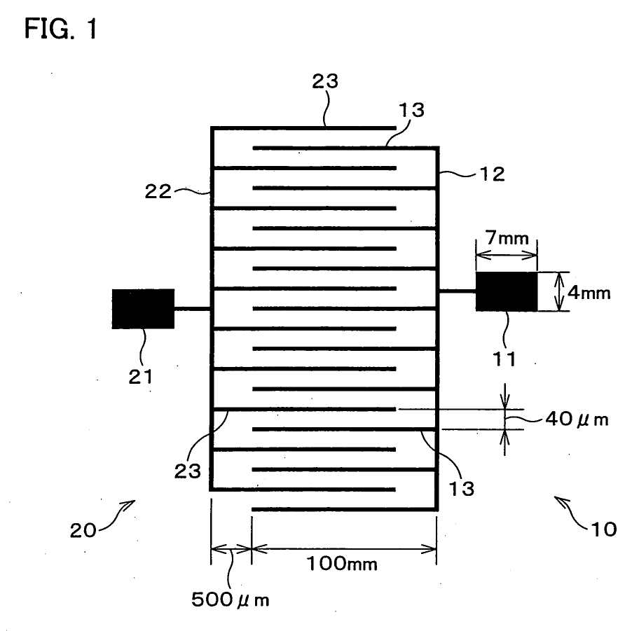

First, in advance, there is formed a copper foil having a circuit which copper foil has a predetermined pattern made of an electric conductor such as a copper foil or the like. An example of the circuit is, as shown in FIG. 1, a copper pattern circuit having a shape in which two minute comb-shaped circuits 10 and 20 are opposite to each other and are interdigitated (comb-shaped pattern).

In the example shown in FIG. 1, the comb-shaped circuit 10 includes an electrode terminal 11 and comb-shaped lines 12 and 13, and the comb-shaped circuit 20 includes an electrode terminal 21 and comb-shaped lines 22 and 23. Note that, as to the lines 12, 13, 22, and 23, for convenience in description, each of the limes 12 and 22 corresponding to ridges of the combs is referred to as a “trunk line”, and each of the lines 13 and 23 corresponding to tooth of the combs is referred to as a “brunch line”.

The trunk line 12 or 22 is connected to the electrode terminal 11 or 21, and is formed along a direction perpendicular to a direction in which the comb-shaped circuits 10 and 20 are opposite to each other. Further, a plurality of brunch lines 12 or 23 corresponding to the tooth of the comb are formed so as to extend from the trunk line 12 or 22 and protrude outward. These brunch lines 13 or 23 extend in a direction in which the brunch lines 13 are opposite to the comb-shaped circuit 20 or the brunch lines 23 are opposite to the comb-shaped circuit 10, and the brunch lines 13 and 23 are alternately disposed.

Each of the comb-shaped circuits 10 and 20 is formed for example so as to have the following sizes: a size of the electrode terminal 11 or 21 is 7 mm×4 mm, and a length of the brunch line 13 or 23 is 100 mm, and a line width of the brunch line 13 or 23 is 40 μm, and a space width of the brunch line 13 or 23 is 40 μm, and an interval between an end of the brunch line 13 or 23 and the trunk line 22 or 12 opposite thereto is 500 μm.

In this manner, the copper pattern circuit is generally arranged so that an interval between lines adjacent to each other has a several μm length. Note that, for convenience in description, a width of the line 13 or 23 is smaller than a distance between the line 13 and the line 23.

Next, the copper foil having a circuit and the photosensitive dry film resist are made overlap each other so as to combine them to each other by thermal lamination, thermal press, or thermal vacuum lamination. It is preferable to combine them at such a temperature that the epoxy group, the double bond, and the triple bond are not broken by heat. Specifically, the temperature is 180° C. or lower, preferably 150° C. or lower, more preferably 130° C. or lower.

Next, a photomask having a predetermined pattern is made overlap the combined photosensitive dry film resist, and light is irradiated thereto so as to carry out exposure. Thereafter, an unexposed portion is dissolved and removed (developed) with the developer, thereby obtaining a desired pattern. The developing step may be carried out by using a general positive photo resist developing device. Note that, the developer will be described later.

Next, the photosensitive dry film resist having been formed into a predetermined pattern by means of development is rinsed with rinse solution so as to remove the developing solvent. As the rinse solution, for example, it is possible to favorably use methanol, ethanol, isopropylalcohol, and water, which are highly compatible with the developer described later. However, the rinse solution is not limited to them as long as the solvent exhibits a rinsing effect.

After developing and rinsing, the photosensitive dry film resist having been formed into a predetermined pattern is cured by carrying out a heating process at a desired temperature ranging from 20 to 200° C. On this account, a cured cover lay film is formed on the FPC circuit. According to this method, it is possible to form the cover lay film at high definition, and the cover lay film has high heat resistance and is superior in properties such as a mechanical property and the like. In this manner, it is possible to manufacture the FPC by using the photosensitive dry film resist according to the present invention.

<Developer>

As described above, as the developer used in the development, it is possible to favorably use an aqueous solution (alkaline aqueous solution, basic aqueous solution) which is basic. The basic aqueous solution is a solution obtained by dissolving a basic compound (alkaline compound) in water.

Here, in case where the photosensitive resin composition contains the photosensitive IMASO (A-3), the basic aqueous solution may contain a water-soluble organic solvent in order to improve the solubility of the photosensitive resin composition, particularly, the solubility of the photosensitive IMASO (A-3). Specific examples of the water-soluble organic solvent include methanol, ethanol, propanol, isopropylalcohol, N-methyl-2-pyrrolidone, N,N-dimethylformamide, N,N-dimethylacetamide, and the like. Particularly, it is preferable that alcohol is contained therein.

Further, in case where the photosensitive resin composition contains the photosensitive IMASO (A-3), the concentration of the basic compound in the basic aqueous solution is not particularly limited, but it is general that the concentration of the basic compound ranges from 0.1 to 50 wt %. Further, taking into consideration the influence on a support substrate or the like of the FPC at the time of development, the concentration more preferably ranges from 0. 1 to 30 wt %.

Note that, the present embodiment explained the case where the photosensitive dry film resist is used as the insulating protection material or the interlayer insulation material of the print wiring substrate (including the FPC), but it is needless to say that the photosensitive dry film resist can be used for purposes other than the foregoing purposes.

In this way, the present embodiment detailed the present invention by taking specific examples, but the present invention is not limited to the embodiment. The present invention can be variously improved, changed, and modified, on the basis of knowledge of person with ordinary skill in the art, so as not to depart from the scope.

The following more specifically explains the present invention with reference to Examples and Comparative Examples, but the present invention is not limited to them.

First, Examples and Comparative Examples in case of selecting the polyimide resin having a hydroxy group (A-1) as the base resin component (A) are described as follows. In this case, an example where the photosensitive resin composition was prepared, a specific example where the photosensitive dry film resist was produced, and evaluation of properties thereof are as follows.

[Preparation Example of Photosensitive Resin Composition]

The polyimide resin having a hydroxy group (A-1) was dissolved in dioxolane so as to prepare a varnish (solution) of the polyimide resin (A-1) so that its solid content weight % (Sc)=30%. The (meth)acryls compound (B) was added to the varnish, and the accessory component (C) and/or the storage stabilization additive (D) were added, mixed, and stirred, thereby preparing the photosensitive resin composition solution (varnish).

[Preparation Example of Photosensitive Dry Film Resist]

The photosensitive resin composition solution obtained in the foregoing example was applied to the support film so that a thickness of a dried resultant (a thickness of the photosensitive dry film resist) ranged from 20 to 25 μm. As the support film, a PET film (Lumirror (commercial name) produced by TORAY ADVANCED FILM Co., Ltd: its thickness was 25 μm) was used. Thereafter, the applied layer on the support film was dried at 100° C. for two minutes, thereby removing dioxolane. In this manner, a two-layer sheet constituted of the photosensitive dry film resist/PET film (support film) was obtained. Note that, the photosensitive dry film resist layer was in a B stage state.

Subsequently, a polyethylene film (GF-1 (commercial name) produced by TAMAPOLY Co., Ltd: its thickness was 40 μm) was roll-laminated on the photosensitive dry film resist of the two-layer sheet at 20° C. and at a nip pressure of 75000 Pa.m, thereby obtaining a three-layer sheet (laminate sample) having three layers (the protective film, the photosensitive dry film resist, and the PET film).

[Evaluation of Properties of Photosensitive Dry Film Resist]

The photosensitive dry film resist produced in the foregoing manner was evaluated in terms of properties such as (1) alkali solubility, (2) developing property, (3) soldering heat resistance, (4) electric insulation property, (5) weight-average molecular weight, (6) viscosity variation of the photosensitive resin composition varnish, (7) variation of the alkali solubility, and (8) anti-hydrolysis property.

(1) Alkali Solubility (One Evaluation Concerning Water Developing Property)

First, an electrolytic copper foil (product of MITSUI MINING & SMELTING Co., LTD.: its thickness was 38 μm) was subjected to soft etching (the step of removing an antirust from a surface of the copper foil) with 10 wt % of sulfuric acid aqueous solution for one minute, and was rinsed with water, and then the surface was rinsed with ethanol and acetone, and thus rinsed surface was dried. After the protective film was exfoliated from the three-layer sheet, the sheet was laminated on a lustrous surface of the electrolytic copper foil (having been subjected to the soft etching) at 100° C. and at 75000 Pa.m. Subsequently, after exfoliating the PET film, a development process was carried out by using a spray developing device (ES-655D (commercial name) which was an etching machine produced by Sunhayato Corporation), in an unexposed state, with 1 wt % of sodium hydroxide aqueous solution (its temperature was 40° C.), at a spray pressure of 0.85 MPa, for 30 to 120 seconds (Examples 1 to 4 and Comparative Examples 1 and 2), or for 30 to 240 seconds (Examples 5 to 9 and Comparative Examples 5 to 10), or for 20 to 180 seconds (Examples 10 to 14 and Comparative Examples 5 to 10). Thus developed sample was rinsed with distilled water, and the developer was removed, and the sample was dried.

The shortest developing time taken to completely dissolve and remove the photosensitive dry film resist from the copper foil lustrous surface to which the photosensitive dry film resist has been combined was defined as a dissolving time in the B stage state. In Examples 1 to 4 and Comparative Examples 1 and 2, the photosensitive dry film resist whose dissolving time in the B stage state was 60 seconds or less, was regarded as being appropriate, and the photosensitive dry film resist whose dissolving time in the B stage state was more than 60 seconds, was regarded as being inappropriate. Further, in Examples 5 to 9 and Comparative Examples 3 and 4, the photosensitive dry film resist whose dissolving time in the B stage state was 180 seconds or less, was regarded as being appropriate, and the photosensitive dry film resist whose dissolving time in the B stage state was more than 180 seconds, was regarded as being inappropriate. Further, in Examples 10 to 14 and Comparative Examples 5 to 10, the photosensitive dry film resist whose dissolving time in the B stage state was a range from 20 to 180 seconds, was regarded as being appropriate. The photosensitive dry film resist whose dissolving time in the B stage state was less than 20 seconds or more than 180 seconds, was regarded as being inappropriate.

(2) Developing Property (One Evaluation Concerning Water Developing Property)

In the same method as the foregoing evaluation (1), after exfoliating the protective film from the three-layer sheet, the photosensitive dry film resist was laminated on the lustrous surface of the electrolytic copper foil (having been subjected to the soft etching) at 100° C. and at 75000 Pa.m. A mask pattern on which a minute square of 100×100 μm and a minute square of 200×200 μm had been formed was placed on the laminate sample, and the laminate sample was exposed to 300 mJ/cm² of light whose wavelength was 400 nm.

After exfoliating the PET film from the laminate sample, a development process was carried out by using a spray developing device (ES-655D (commercial name) which was an etching machine produced by Sunhayato Corporation), with 1 wt % of sodium hydroxide aqueous solution (its temperature was 40° C.), at a spray pressure of 0.85 MPa, for 30 to 60 seconds (Examples 1 to 4 and Comparative Examples 1 and 2), or for 30 to 180 seconds (Examples 5 to 14 and Comparative Examples 3 to 10). Thus developed sample was rinsed with distilled water, and the developer was removed, and the sample was dried. Then, the resultant was observed through an optical microscope. When the square of 200×200 μm was developed, the photosensitive dry film resist was regarded as being appropriate.

(3) Soldering Heat Resistance

An electrolytic copper foil (product of MITSUI MINING & SMELTING Co., LTD: its thickness was 35 μm) was cut into 5×5 cm, and was subjected to soft etching with 10 wt % of sulfuric acid aqueous solution for one minute, and was rinsed with water, and then the surface was rinsed with ethanol and acetone, and thus rinsed surface was dried. Next, the protective film was exfoliated from the three-layer sheet having been cut into 4×4 cm, and the sheet was made to overlap and was laminated on a lustrous surface of the electrolytic copper foil (having been subjected to the soft etching) at 100° C. and at 75000Pa.m. A surface of the photosensitive dry film resist of the laminate sample was exposed to 300 mJ/cm² of light whose wavelength was 400 nm. Thereafter, thermal curing was carried out at 180° C. for two hours, thereby curing the photosensitive dry film resist.

The laminate sample was subjected to humidity conditioning under (i) a normal condition (at 20° C., with relative humidity of 40%, for 24 hours) and (ii) a moisture absorption condition (at 40° C., with relative humidity of 85%, for 48 hours). Thereafter, the laminate sample was dipped in melted solder, whose temperature was 270° C. or higher, for 30 seconds. Then, whether or not swollenness occurred and whether or not exfoliation occurred in an interface between the copper foil and the photosensitive dry film resist were observed.

Further, the temperature of the melted solder was gradually raised so as to check a temperature at which the sample was under an abnormal condition while dipping the sample for 30 seconds per 10° C. A maximum temperature which resulted no abnormal condition was defined as “a 30-second-dipable temperature. When the 30-second-dipable temperature was 300° C. or higher, the photosensitive dry film resist was regarded as being appropriate.

(4) Electric Insulation Property

A copper foil surface of a polyimide-with-copper-foil (ESPANEX (commercial name) produced by Nippon Steel Chemical Group: a thickness of the polyimide film was 25 μm and a thickness of the copper foil was 18 μm) and a resist film (SUNFORT (commercial name) produced by Asahi Kasei Corporation) were used to form such a comb-shaped pattern circuit (pattern circuit) that line/space=50/50 μm, thereby obtaining a flexible copper plate having a circuit. The photosensitive dry film resist of the three-layer sheet from which the protective film had been exfoliated was made to overlap the flexible copper plate having a circuit so as to coat the pattern circuit on the flexible copper plate, and was laminated thereon at 100° C. and at 75000 Pa.m. A surface of the photosensitive dry film resist of the laminate sample was exposed to 300 mj/cm² of light whose wavelength was 400 nm. Thereafter, thermal curing was carried out at 180° C. for two hours, thereby curing the photosensitive dry film resist.

The laminate sample was placed in a faster temperature (& humidity) chamber (Platinous PR-2K (commercial name): product of ESPEC CORP.) whose temperature was 85° C. and relative humidity was 85%, and a voltage of 100V was kept applied between terminals of the pattern circuit, and an interline insulation resistance was measured in every 30 minutes. When a resistance value in 500 hours for which the voltage had been applied was 1.0×10⁸ Ω or more, the photosensitive dry film resist was regarded as being appropriate. When the circuit was short-circuited within 500 hours, the photosensitive dry film resist was regarded as being inappropriate.

(5) Weight-Average Molecular Weight

In Examples 1 to 4 and Comparative Examples 1 and 2, and in Examples 5 to 9 and Comparative Examples 3 and 4, a weight-average molecular weight of the polyimide resin having a phenolic hydroxyl group (A-1-1) or the photosensitive polyimide resin (A-1-2) was measured with a high speed GPC (HLC-8220GPC (commercial name) produced by Tosoh Corporation), and was calculated with a size exclusion chromatography in accordance with conversion based on polyethyleneoxide.

Further, in Examples 10 to 14 and Comparative Examples 5 and 10, a weight-average molecular weight of the soluble polyimide resin (A-1-3) was measured with a high speed GPC (HLC-8220GPC (commercial name) produced by Tosoh Corporation). The measurement was carried out under such condition that: DMF (0.036M LiBr, 0.019M, including phosphate) was used as a developing solvent, and two columns (KD-805-M: commercial name) produced by Shodex was used, and a column temperature was set to 40° C., and a PI (PEO standard) was used as a detector, and a flow rate was set to 0.6ml/min.

(6) Viscosity Variation of Photosensitive Resin Composition Varnish (One Evaluation Concerning Storage Stability)

The photosensitive resin composition varnish was prepared so that its final solid content weight % (Sc)=50% (see Preparation example of photosensitive resin composition). Here, the solid content weight is a total weight of materials other than the organic solvent, that is, a total weight of the base resin component (A), the (meth)acryls compound (B), the accessory component (C), and the storage stabilization additive (D). Even a liquid component is regarded as a solid content.

Right after preparing the varnish, initial viscosity A₀ of the varnish was measured with a B-type viscometer (Type BS: product of Tokyo Keiki Co., Ltd.). Subsequently, the varnish was placed in a glass sample tube with a lid and was stored therein at a room temperature for 7 days, and viscosity A₁ of thus stored varnish was measured with the B-type viscometer in the same manner. An increasing rate (%) of the viscosity was calculated in accordance with such an equation that 100×(A₁−A₀)/A₀.

(7) Variation of Alkali Solubility (One Evaluation Concerning Storage Stability)

In Examples 10 to 14 and Comparative Examples 5 to 10, the dissolving time in the B stage state was measured in the same manner as in the foregoing evaluation (1), and the dissolving time was defined as an initial value t₀. Next, the same photosensitive dry film resist with it three-layered was left at room temperature for 7 days, and the dissolving time t₁ was measured in the same manner as in the foregoing evaluation (1). Variation (%) of the dissolving time was calculated in accordance with such an equation that 100×(t₁−t₀)/t₀. When the variation was within a range of ±20%, the photosensitive dry film resist was regarded as being appropriate. When the variation deviated from the range of ±20%, the photosensitive dry film resist was regarded as being inappropriate.

(8) Anti-Hydrolysis Property

A copper foil surface of a polyimide-film-with-copper-foil (ESPANEX (commercial name) produced by Nippon Steel Chemical Group: a thickness of the polyimide film was 25 μm and a thickness of the copper foil was 18 μm) and a resist film (SUNFORT (commercial name) produced by Asahi Kasei Corporation) were used to form a comb-shaped pattern circuit (pattern circuit) in which 20 lines were disposed in parallel at such an interval that line/space=50/50 μm, thereby obtaining a flexible copper plate having a circuit. The photosensitive dry film resist of the three-layer sheet from which the protective film had been exfoliated was made to overlap the flexible copper plate having a circuit so as to coat the pattern circuit on the flexible copper plate, and was laminated thereon at 100° C. and at 75000 Pa.m. A surface of the photosensitive dry film resist of the laminate sample was exposed to 300 mJ/cm² of light whose wavelength was 400 nm. Thereafter, thermal curing was carried out at 180° C. for two hours, thereby curing the photosensitive dry film resist.

The laminate sample was cut into 2×2 cm, and was placed in a pressure cooker test machine (pressure cooker test machine produced by HIRAYAMA MANUFACTURING CORPORATION: model number: PC305S), and an anti-hydrolysis test was carried out at 121° C., with 2 atmospheres, for 24 hours. After carrying out the test, the laminate sample was retrieved, and droplets on its surface were wiped out. Thereafter, abnormal points of the photosensitive dry film resist and color variation or the like of a copper line coated by the photosensitive dry film resist were observed through eyes or through a microscope.

When the photosensitive dry film resist was free from any color variation and deterioration even after being placed in the pressure cooker test machine and when the copper line was free from any color variation, the photosensitive dry film resist was regarded as being appropriate. When the photosensitive dry film resist was opaque, or when the photosensitive dry film resist was brittle, or when the photosensitive dry film resist was exfoliated from the flexible copper plate having a circuit upon bending the laminate sample, or when the color of the copper line varied to brown or a similar color, the photosensitive dry film resist was regarded as being inappropriate.

### EXAMPLE 1

<Synthesis of Polyimide Resin having a Phenolic Hydroxyl Group (A-1-1)>

As materials for the polyimide resin having a hydroxyl group, there were used: (2,2′-bis(hydroxyphenyl)propanedibenzoate)-3,3′,4,4′-tetra carboxylate dianhydride (ESDA); diamine represented by the following formula

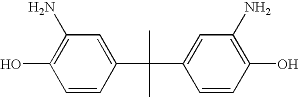

2,2′-diaminobisphenol A (DAM-1 (commercial name) produced by Gun Ei Chemical Industry Co., Ltd.); and silicondiamine (KF-8010 (commercial name) produced by Shin-Etsu Chemical Co., Ltd.). Note that, in the following description, 2,2′-diaminobisphenol A and silicondiamine are referred to by commercial names for convenience in description. Further, as the polymerization solvent, N,N′-dimethylformamide (DMF) was used.

69.7 g (0.27mol) of DAM-1 and 100 g of DMF were placed in a 500 ml separable flask provided with a stirrer, and the mixture was stirred, thereby preparing a DMF solution made of DAM-1. Next, 24.9 g (0.03 mol) of KF-8010 was added to the DMF solution, and the mixture was stirred until it became even, thereby preparing DMF solution of DAM-1 and K-F8010. Subsequently, 173 g (0.3 mol) of ESDA was dissolved in 300 g of DMF, and the mixture was added to the DMF solution, and the resultant was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 241.0 g of polyimide resin having a phenolic hydroxyl group.

A hydroxyl equivalent of the polyimide resin having a phenolic hydroxyl group was 475, and a weight-average molecular weight of the polyimide resin was 25000. Further, 50 g or more of the polyimide resin was dissolved in 100 g (20° C.) of tetrahydrofuran.

<Production of Photosensitive Dry Film Resist>

15 g of the polyimide resin having a phenolic hydroxyl group was dissolved in 35 g of dioxolane, thereby preparing such varnish (solution) that its solid content weight % (Sc)=30%. Next, the following components were mixed so as to prepare an organic solvent solution of photosensitive resin composition, thereby producing the photosensitive dry film resist in the B stage state (see Production Example).

Polyimide resin having a Phenolic hydroxyl group (A-1-1) the foregoing polyimide resin solution (in accordance with conversion based on a solid content): 50 parts by weight

(meth)acryls compound (B) bisphenol A EO denaturalized (recurring unit of an ethyleneoxide denaturalized portion: m+n≈4) diacrylate (ARONIX M-211B (commercial name) produced by TOAGOSEI CO., LTD.): 40 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4-cyclopentadien-1-yl)-bis(2,6′-difluoro-3-(1H-pyrrole-1-yl)-phenyl)titanium (IRGACURE 784 (commercial name) produced by Ciba Specialty Chemicals): 1 part by weight

<Evaluation of Properties>

The obtained photosensitive dry film resist was evaluated in terms of the aforementioned properties. As a result, the dissolving time of the photosensitive dry film resist in the B stage state was 30 seconds, so that the photosensitive dry film resist was regarded as being appropriate in the alkali solubility. Further, a hole of 100×100 μm and a hole of 200×200 μm were developed, so that the photosensitive dry film resist was regarded as being appropriate in the developing property. Further, under both (i) the normal condition and (ii) the moisture absorption condition, the 30-second-dipable temperature was 320° C., so that the photosensitive dry film resist was regarded as being appropriate in the soldering heat resistance. Further, the electric insulation property was 6.55×10⁸ Ω, so that the photosensitive dry film resist was regarded as being appropriate in the electric insulation property.

### EXAMPLE 2

<Synthesis of Polyimide Resin having a Phenolic Hydroxyl Group (A-1-1)>

As materials for the polyimide resin having a hydroxyl group, there were used: the ESDA; a phenol derivative having an amino group (DAM-R1 (commercial name) produced by Gun Ei Chemical Industry Co., Ltd.) represented by the following formula 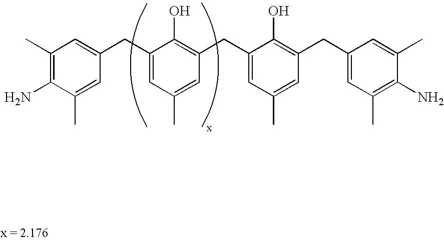
; and silicondiamine (KF-8010 (commercial name) produced by Shin-Etsu Chemical Co., Ltd.). Note that, in the following description, the phenol derivative and silicondiamine are referred to by commercial names for convenience in description. Further, as the polymerization solvent, DMF was used.

185 g (0.27 mol) of DAM-R1 and 100 g of DMF were placed in a 500 ml separable flask provided with a stirrer, and the mixture was stirred, thereby preparing a DMF solution made of DAM-R1. Next, 24.9 g (0.03 mol) of KF-8010 was added to the DMF solution, and the mixture was intensely stirred until it became even, thereby preparing DMF solution of DAM-R1 and KF-8010. Subsequently, 173 g (0.3 mol) of ESDA was dissolved in 300 g of DMF, and the mixture was added to the DMF solution, and the resultant was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 345 g of polyimide resin having a phenolic hydroxyl group.

A hydroxyl equivalent of the polyimide resin was 418, and a weight-average molecular weight of the polyimide resin having a phenolic hydroxyl group was 32000. Further, 50 g or more of the polyimide resin was dissolved in 10 g (20° C.) of tetrahydrofuran.

<Production of Photosensitive Dry Film Resist>

15 g of the polyimide resin having a phenolic hydroxyl group was dissolved in 35 g of dioxolane, thereby preparing such varnish (solution) that its solid content weight % (Sc)=30%. Next, the following components were mixed so as to prepare a photosensitive resin composition solution, thereby producing a photosensitive dry film resist in the B stage state (see Production Example).

Polyimide resin having a phenolic hydroxyl group (A-1-1) the foregoing polyimide resin solution (in accordance with conversion based on a solid content): 60 parts by weight

(meth)acryls compound (B) bisphenol A EO denaturalized (recurring unit of an ethyleneoxide denaturalized portion: m+n=30) diacrylate (NK ester A-BPE-30 (commercial name) produced by SHIN-NAKAMURA CHEMICAL CO., LTD.): 20 parts by weight bisphenol A EO denaturalized (recurring unit of an ethyleneoxide denaturalized portion: m+n=10) diacrylate (NK ester A-BPE-10 (commercial name) produced by SHIN-NAKAMURA CHEMICAL CO., LTD.): 20 parts by weight

Optical reaction initiator (accessory component) (C-1) bis(2,4,6-trimethylbenzoyl)-phenylphosphineoxide (IRGACURE 819 (commercial name) produced by Ciba Specialty Chemicals): 1 part by weight

<Evaluation of Properties>

The obtained photosensitive dry film resist was evaluated in terms of the aforementioned properties. As a result, the dissolving time of the photosensitive dry film resist in the B stage state was 60 seconds, so that the photosensitive dry film resist was regarded as being appropriate in the alkali solubility. Further, a hole of 200×200 μm was developed, so that the photosensitive dry film resist was regarded as being appropriate in the developing property. Further, under both (i) the normal condition and (ii) the moisture absorption condition, the 30-second-dipable temperature was 330° C., so that the photosensitive dry film resist was regarded as appropriate in the soldering heat resistance. Further, the photosensitive dry film resist was 1.30×10⁸Ω, so that the electric insulation property was regarded as being appropriate in the electric insulation property.

### EXAMPLE 3

<Synthesis of Polyimide Resin having a Phenolic Hydroxy Group (A-1-1)>

As materials for polyimide, there were used: the ESDA; 2,2′-bis(3-amino-4-hydroxyphenyl)hexafluoropropane (hereinafter, referred to as bis-AP-AF) represented by the following formula 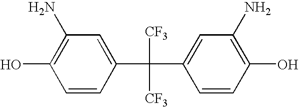
; and silicondiamine KF-8010. Further, as the polymerization solvent, DMF was used.

76.9 g (0.21 mol) of bis-AP-AF and 100 g of DMF were placed in a 500 ml separable flask provided with a stirrer, and the mixture was stirred, thereby preparing a DMF solution made of bis-AP-AF. Next, 74.7 g (0.09 mol) of KF-8010 was added to the DMF solution, and the mixture was intensely stirred until it became even, thereby preparing DMF solution of bis-AP-AF and KF-8010. Subsequently, 173 g (0.30 mol) of ESDA was dissolved in 300 g of DMF, and the mixture was added to the DMF solution, and the resultant was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 285.6 g of polyimide resin having a phenolic hydroxyl group.

A hydroxyl equivalent of the polyimide having a phenolic hydroxyl group resin was 745, and a weight-average molecular weight of the polyimide resin was 45000. Further, 50 g or more of the polyimide resin was dissolved in 100 g (20° C.) of tetrahydrofuran.

<Production of Photosensitive Dry Film Resist>

15 g of the polyimide resin having a phenolic hydroxyl group was dissolved in 35 g of dioxolane, thereby preparing such varnish (solution) that its solid content weight % (Sc)=30%. Next, the following components were mixed so as to prepare a photosensitive resin composition solution, thereby producing a photosensitive dry film resist in the B stage state (see Production Example).

Polyimide resin having a phenolic hydroxyl group (A-1-1) the foregoing polyimide resin solution (in accordance with conversion based on a solid content): 60 parts by weight

(meth)acryls compound (B) diglycidylmethacrylate: 5 parts by weight epoxyacrylate (NK oligo EA-1010 (commercial name) produced by SHIN-NAKAMURA CHEMICAL CO., LTD.): 25 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4,6-trimethylbenzoyl)-phenylphosphineoxide (IRGACURE 819 (commercial name) produced by Ciba Specialty Chemicals): 1 part by weight Curing agent (accessory component) (C-3) 4,4′-diaminodiphenylsulfone (DDS): 3 parts by weight

<Evaluation of Properties>

The obtained photosensitive dry film resist was evaluated in terms of the aforementioned properties. As a result, the dissolving time of the photosensitive dry film resist in the B stage state was 40 seconds, so that the photosensitive dry film resist was regarded as being appropriate in the alkali solubility. Further, a hole of 100×100 μm and a hole of 200×200 μm were developed, so that the photosensitive dry film resist was regarded as being appropriate in the developing property. Further, under both (i) the normal condition and (ii) the moisture absorption condition, the 30-second-dipable temperature was 320° C., so that the photosensitive dry film resist was regarded as being appropriate in the soldering heat resistance. Further, the electric insulation property was 1.30×10⁸Ω, so that the photosensitive dry film resist was regarded as being appropriate in the electric insulation property.

### EXAMPLE 4

<Production of Photosensitive Dry Film Resist>

The following components were mixed so as to prepare an organic solvent solution of a photosensitive resin composition, thereby producing a photosensitive dry film resist in the B stage state (see Production Example).

Polyimide resin having a phenolic hydroxyl group (A-1-1) the polyimide resin solution obtained in Example 3 (in accordance with conversion based on a solid content): 40 parts by weight

(meth)acryls compound (B) epoxyacrylate (NK oligo EA-1010 (commercial name) produced by SHIN-NAKAMURA CHEMICAL CO., LTD.): 10 parts by weight bisphenol A type epoxyacrylate (Ebecryl 3700 (commercial name) produced by DAICEL-UCB Company LTD.): 30 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4,6-trimethylbenzoyl)-phenylphosphineoxide (IRGACURE 819 (commercial name) produced by Ciba Specialty Chemicals): 3 parts by weight

Curing agent (accessory component) (C-3) 4,4′-diaminodiphenylmethane (DDM): 1 part by weight

Epoxy resin (accessory component) (C-4) bisphenol A type epoxy resin (EPIKOTE 828 (commercial name) produced by TOAGOSEI CO., LTD.): 10 parts by weight

<Evaluation of Properties>

The obtained photosensitive dry film resist was evaluated in terms of the aforementioned properties. As a result, the dissolving time of the photosensitive dry film resist in the B stage state was 40 seconds, so that the photosensitive dry film resist was regarded as being appropriate in the alkali solubility. Further, a hole of 100×100 μm and a hole of 200×200 μm were developed, so that the photosensitive dry film resist was regarded as being appropriate in the developing property. Further, under both (i) the normal condition and (ii) the moisture absorption condition, the 30-second-dipable temperature was 330° C., so that the photosensitive dry film resist was regarded as being appropriate in the soldering heat resistance. Further, the photosensitive dry film resist was 2.70×10⁸Ω, so that the electric insulation property was regarded as being appropriate in the electric insulation property.

### COMPARATIVE EXAMPLE 1

<Synthesis of Base Polymer>

The ESDA, bis[4-(3-aminophenoxy)phenyl]sulfone (hereinafter, referred to as BAPS-M), and silicondiamine KF-8010 were used as materials for the polyimide resin. DMF was used as the polymerization solvent, and dioxolane was used as a solvent of thus obtained polyimide resin.

173 g (0.30 mol) of ESDA and 300 g of DMF were placed in a 500 ml separable flask provided with a stirrer, and the mixture was stirred, thereby preparing a DMF solution made of ESDA. Next, 86.5 g (0.20 mol) of BAPS-M was dissolved in 100 g of DNF, and the resultant was added to the DMF solution and was intensely stirred until it became even, thereby preparing DMF solution of ESDA and BAPS-M. 83.5 g (0.10 mol) of KF-8010 was added to the DMF solution and was intensely stirred for one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 315 g of polyimide resin.

Note that, the polyimide resin contained no hydroxyl group in its imide side chain. Further, a weight-average molecular weight of the polyimide resin was 135000. Further, 50 g or more of the polyimide resin was dissolved in 100 g (20° C.) of tetrahydrofuran.

<Production of Photosensitive Dry Film Resist>

15 g of the polyimide resin was dissolved in 35 g of dioxolane, thereby preparing such varnish (solution) that its solid content weight % (Sc)=30%. Next, the photosensitive dry film resist in the B stage state was produced (see Production Example). That is, the photosensitive dry film resist was produced under the same condition as in Example 1 except that the polyimide solution was used instead of the polyimide resin having a hydroxyl group solutions

<Evaluation of Properties>

The obtained photosensitive dry film resist was evaluated in terms of the aforementioned properties. As a result, even though the development process was carried out for 120 seconds, the thickness of the photosensitive dry film resist decreased merely from 25 μm to 22 μm after the development process, and the photosensitive dry film resist remained undissolved on an entire surface of the sample, so that the photosensitive dry film resist was regarded as being inappropriate in the alkali solubility. Further, neither a hole of 100×100 μm nor a hole of 200×200 μm were developed, so that the photosensitive dry film resist was regarded as being inappropriate in the developing property. Further, under both (i) the normal condition and (ii) the moisture absorption condition, the 30-second-dipable temperature was 320° C., so that the photosensitive dry film resist was regarded as being appropriate in the soldering heat resistance. Further, the electric insulation property was 2.88×10⁸Ω, so that the photosensitive dry film resist was regarded as being appropriate in the electric insulation property.

In this way, when the polyimide resin having no hydroxyl group was used as the base polymer (i.e., the base resin component (A)), the soldering heat resistance and the electric insulation property were excellent, but the alkali solubility and the developing property (i.e., the water system developing property) were insufficient.

### COMPARATIVE EXAMPLE 2

<Synthesis of Base Polymer>

Monomers of methylmethacrylate, n-butylmethacrylate, 2-ethylhexylacrylate, and methacrylic acid were used as materials for the polyimide resin. These monomer components were copolymerized in accordance with a known method, thereby obtaining a copolymer having a carboxyl group. Note that, a polymerization ratio of the monomer components in the copolymerization reaction was methylmethacrylate/n-butylmethacrylate/2-ethylhexylacrylate/methacrylic acid=60/10/10/20 (in terms of a weight). Further, a weight-average molecular weight of the polyimide resin was 85000.

<Production of Photosensitive Dry Film Resist>

The photosensitive dry film resist was produced under the same condition as in Example 4 except that the acrylic copolymer synthesized in the foregoing manner was used instead of the polyimide resin having a hydroxyl group of Example 4.

<Evaluation of Properties>

The obtained photosensitive dry film resist was evaluated in terms of the aforementioned properties. As a result, the dissolving time of the photosensitive dry film resist in the B stage state was 30 seconds, so that the photosensitive dry film resist was regarded as being appropriate in the alkali solubility. Further, a hole of 100×100 μm and a hole of 200×200 μm were developed, so that the photosensitive dry film resist was regarded as being appropriate in the developing property. Further, under (i) the normal condition, the 30-second-dipable temperature was 270° C., and under (ii) the moisture absorption condition, the 30-second-dipable temperature was 250° C., so that the photosensitive dry film resist was regarded as being inappropriate the soldering heat resistance. Further, short-circuit occurred after 220 hours for which the voltage had been applied, so that the photosensitive dry film resist was regarded as being inappropriate in the electric insulation property.

In this way, when the acrylic copolymer made of monomer having no aromatic ring was used, the alkali solubility and the developing property (water system developing property) were excellent, but the soldering heat resistance and the electric insulation property were insufficient.

### EXAMPLE 5

<Synthesis of Photosensitive Polyimide Resin (A-1-2)>

69.7 g (0.27 mol) of DAM-1 and 10 g of DMF were placed in a 500 ml separable flask provided with a stirrer, and the mixture was stirred, thereby preparing a DMF solution made of DAM-1. Next, 24.9 g (0.03 mol) of KF-8010 was added thereto, and the resultant was intensely stirred until it became even, thereby preparing DMF solution of DAM-1 and KF-8010. Subsequently, 173 g (0.30 mol) of ESDA was dissolved in 300 g of DMF, and the resultant was added to the DMF solution, and the mixture was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 241.0 g of polyimide resin having a hydroxyl group.

Next, 100 g of the hydroxy polyimide was dissolved in 200 g of DMF, and 15.1 g (0.11 mol) of glycidylmethacrylate (referred to as GMA: product of Wako Pure Chemical Industries, Ltd.), 1.0 g (0.01 mol) of triethylamine (Wako Pure Chemical Industries, Ltd.) were added thereto. Further, 0.1 g of N-nitrosophenylhydroxylamine aluminum salt (Q-1301 (commercial name) produced by Wako Pure Chemical Industries, Ltd.: hereinafter, referred by the commercial name) was added thereto as a polymerization inhibitor, and the mixture was stirred at 80° C. for five hours. Thus obtained polyimide solution was poured into 1000 ml of methanol, and a deposited resin was crushed by a mixer. Thereafter, thus crushed resin was rinsed with methanol, and the resultant was dried, thereby obtaining 113.4 g of photosensitive polyimide resin (A-1-2). A hydroxyl equivalent of the photosensitive polyimide resin was 1132, and a weight-average molecular weight of the photosensitive polyimide resin was 35000.

<Production of Photosensitive Dry Film Resist>

15 g of the photosensitive polyimide resin was dissolved in 35 g of dioxolane, thereby preparing such varnish (solution) that its solid content weight % (Sc)=30%. Next, the following components were mixed so as to prepare an organic solvent solution of the photosensitive resin composition, thereby producing a photosensitive dry film resist in the B stage state (see Production Example).

Photosensitive polyimide resin (A-1-2) the foregoing photosensitive polyimide resin (in accordance with conversion based on a solid content): 50 parts by weight

(meth)acryls compound (B) bisphenol A EO denaturalized (recurring unit of an ethyleneoxide denaturalized portion: m+n≈4) diacrylate (ARONIX M-21 1 B (commercial name) produced by TOAGOSEI CO., LTD.): 40 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4-cyclopentadiene-1-yl)-bis(2,6′-difluoro-3-(1H-pyrrole-1-yl)-phenyl)titanium (IRGACURE 784 (commercial name) produced by Ciba Specialty Chemicals): 1 part by weight

<Evaluation of Properties>

The obtained photosensitive dry film resist was evaluated in terms of the aforementioned properties. As a result, the dissolving time of the photosensitive dry film resist in the B stage state was 40 seconds, so that the photosensitive dry film resist was regarded as being appropriate in the alkali solubility. Further, a hole of 100×100 μm and a hole of 200×200 μm were developed, so that the photosensitive dry film resist was regarded as being appropriate in the developing property. Further, under both (i) the normal condition and (ii) the moisture absorption condition, the 30-second-dipable temperature was 320° C., so that the photosensitive dry film resist was regarded as being appropriate in the soldering heat resistance. Further, the electric insulation property was 7.13×10⁸Ω, so that the photosensitive dry film resist was regarded as being appropriate in the electric insulation property.

### EXAMPLE 6

<Synthesis of Photosensitive Polyimide Resin (A-1-2)>

100 g of the hydroxy polyimide obtained in Example 5 was dissolved in 100 g of DMF, and 16.9 g (0.11 mol) of methacrylate anhydride (Wako Pure Chemical Industries, Ltd.) and 1.0 g (0.01 mol) of triethylamine (Wako Pure Chemical Industries, Ltd.) were added thereto. Further, the mixture was stirred at a room temperature for three hours and at 50° C. for about one hour. Thus obtained polyimide solution was poured into 1000 ml of methanol, and a deposited resin was crushed by a mixer. Thereafter, thus crushed resin was rinsed with methanol, and the resultant was dried, thereby obtaining 115.9 g of photosensitive polyimide resin (A-1-2). A hydroxyl equivalent of the photosensitive polyimide resin was 1058, and a weight-average molecular weight of the photosensitive polyimide resin was 34000.

<Production of Photosensitive Dry Film Resist>

15 g of the photosensitive polyimide resin was dissolved in 35 g of dioxolane, thereby preparing such varnish (solution) that its solid content weight % (Sc)=30%. Next, the following components were mixed so as to prepare an organic solvent solution of the photosensitive resin composition, thereby producing a photosensitive dry film resist in the B stage state (see Production Example).

Photosensitive polyimide resin (A-1-2) the foregoing photosensitive polyimide resin (in accordance with conversion based on a solid content): 50 parts by weight

(meth)acryls compound (B) bisphenol A EO denaturalized (recurring unit of an ethyleneoxide denaturalized portion: m+n≈4) diacrylate (ARONIX M-211B (commercial name) produced by TOAGOSEI CO., LTD.): 40 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4-cyclopentadiene-1-yl)-bis(2,6′-difluoro-3-(1H-pyrrole-1-yl)-phenyl)titanium (IRGACURE 784 (commercial name) produced by Ciba Specialty Chemicals): 1 part by weight

<Evaluation of Properties>

The obtained photosensitive dry film resist was evaluated in terms of the aforementioned properties. As a result, the dissolving time of the photosensitive dry film resist in the B stage state was 40 seconds, so that the photosensitive dry film resist was regarded as being appropriate in the alkali solubility. Further, a hole of 100×100 μm and a hole of 200×200 μm were developed, so that the photosensitive dry film resist was regarded as being appropriate in the developing property. Further, under both (i) the normal condition and (ii) the moisture absorption condition, the 30-second-dipable temperature was 320° C., so that the photosensitive dry film resist was regarded as being appropriate in the soldering heat resistance. Further, the electric insulation property was 7.55×10⁸Ω, so that the photosensitive dry film resist was regarded as being appropriate in the electric insulation property.

### EXAMPLE 7

<Synthesis of Photosensitive Polyimide Resin (A-1-2)>

As the phenol derivative having an amino group (DAM-R1 (commercial name) produced by Gun Ei Chemical Industry Co., Ltd.), a derivative represented by the following formula was used (this was different from DAM-R1 of Example 2 in terms of a value of x).

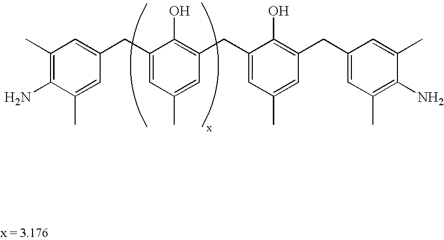

185 g (0.27 mol) of DAM-R1 and 100 g of DMF were placed in a 500 ml separable flask provided with a stirrer, and the mixture was stirred, thereby preparing a DMF solution made of DAM-RI. Next, 24.9 g (0.03 mol) of KF-8010 was added thereto, and the resultant was intensely stirred until it became even, thereby preparing DMF solution of DAM-R1 and FK-8010. Subsequently, 173 g (0.30 mol) of ESDA was dissolved in 300 g of DMF, and the resultant was added to the DMF solution, and the mixture was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 345 g of polyimide resin having a hydroxyl group.

Next, 139.8 g of the hydroxy polyimide was dissolved in 200 g of DMF, and 15.1 g (0.11 mol) of GMA and 1.0 g (0.01 mol) of triethylamine were added thereto. Further, 0.1 g of Q-1301 was added thereto as a polymerization inhibitor. Thereafter, the mixture was stirred at 80° C. for five hours. Thus obtained polyimide solution was poured into 1000 ml of methanol, and a deposited resin was crushed by a mixer. Thereafter, thus crushed resin was rinsed with methanol, and the resultant was dried, thereby obtaining 145.4 g of photosensitive polyimide resin (A-1-2). A hydroxyl equivalent of the photosensitive polyimide resin was 1510, and a weight-average molecular weight of the photosensitive polyimide resin was 28000.

<Production of Photosensitive Dry Film Resist>

7.5 g of the photosensitive polyimide resin and 7.5 g of the photosensitive polyimide resin synthesized in Example 5 were dissolved in 35 g of dioxolane, thereby preparing such varnish (solution) that its solid content weight % (Sc)=30%. Next, the following components were mixed so as to prepare an organic solvent solution of the photosensitive resin composition, thereby producing a photosensitive dry film resist in the B stage state (see Production Example).

Photosensitive polyimide resin (A-1-2) the photosensitive polyimide resin synthesized in this Example (in accordance with conversion based on a solid content): 30 parts by weight the photosensitive polyimide resin synthesized in Example 5 (in accordance with conversion based on a solid content): 30 parts by weight

(meth)acryls compound (B) bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 20 parts by weight bisphenol A EO denaturalized (recurring unit of an ethyleneoxide denaturalized portion: m+n≈10) diacrylate (NK ester A-BPE-10 (commercial name) produced by SHIN-NAKAMURA CHEMICAL CO., LTD.): 20 parts by weight

Optical reaction initiator (accessory component) (C-1) bis(2,4,6-trimethylbenzoyl)-phenylphosphineoxide (IRGACURE 819 (commercial name) produced by Ciba Specialty Chemicals): 1 part by weight

<Evaluation of Properties>

The obtained photosensitive dry film resist was evaluated in terms of the aforementioned properties. As a result, the dissolving time of the photosensitive dry film resist in the B stage state was 60 seconds, so that the photosensitive dry film resist was regarded as being free from any problem in the alkali solubility. Further, a hole of 200×200 μm was developed, so that the photosensitive dry film resist was regarded as being free from any problem in the developing property. Further, under both (i) the normal condition and (ii) the moisture absorption condition, the 30-second-dipable temperature was 340° C., so that the photosensitive dry film resist was regarded as being free from any problem in the soldering heat resistance. Further, the electric insulation property was 1.71×10⁸Ω, so that the photosensitive dry film resist was regarded as being free from any problem in the electric insulation property.

### EXAMPLE 8

<Synthesis of Photosensitive Polyimide Resin (A-1-2)>

76.9 g (0.21 mol) of bis-AP-AF and 100 g of DMF were placed in a 500 ml separable flask provided with a stirrer, and the mixture was stirred, thereby preparing a DMF solution made of bis-AP-AF. Next, 74.7 g (0.09 mol) of KF-8010 was added thereto, and the resultant was intensely stirred until it became even, thereby preparing DMF solution of bis-AP-AF and FK-8010. Subsequently, 173 g (0.30 mol) of ESDA was dissolved in 300 g of DMF, and the resultant was added to the DMF solution, and the mixture was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 285.6 g of polyimide resin having a hydroxyl group.

Next, 111.4 g of the hydroxy polyimide was dissolved in 200 g of DMF, and 15.1 g (0.11 mol) of GMA and 1.0 g (0.01 mol) of triethylamine were added thereto. Further, 0.1 g of Q-1301 was added thereto as a polymerization inhibitor. Thereafter, the mixture was stirred at 80° C. for five hours. Thus obtained polyimide solution was poured into 1000 ml of methanol, and a deposited resin was crushed by a mixer. Thereafter, thus crushed resin was rinsed with methanol, and the resultant was dried, thereby obtaining 120.1 g of photosensitive polyimide resin (A-1-2). A hydroxyl equivalent of the photosensitive polyimide resin was 1240, and a weight-average molecular weight of the photosensitive polyimide resin was 43000.

<Production of Photosensitive Dry Film Resist>

15 g of the photosensitive polyimide resin was dissolved in 35 g of dioxolane, thereby preparing such varnish (solution) that its solid content weight % (Sc)=30%. Next, the following components were mixed so as to prepare an organic solvent solution of the photosensitive resin composition, thereby producing a photosensitive dry film resist in the B stage state (see Production Example).

Photosensitive polyimide resin (A-1-2) the foregoing photosensitive polyimide resin (in accordance with conversion based on a solid content): 60 parts by weight

(meth)acryls compound (B) glycidylmethacrylate: 5 parts by weight epoxyacrylate (NK oligo EA-1010 (commercial name) produced by SHIN-NAKAMURA CHEMICAL CO., LTD.): 25 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4,6-trimethylbenzoyl)phenylphosphineoxide (IRGACURE 819 (commercial name) produced by Ciba Specialty Chemicals): 1 part by weight

curing agent (accessory component) (C-3) 4,4′-diaminodiphenylsulfone (DDS): 3 parts by weight

<Evaluation of Properties>

The obtained photosensitive dry film resist was evaluated in terms of the aforementioned properties. As a result, the dissolving of the photosensitive dry film resist in the B stage state was 40 seconds, so that the photosensitive dry film resist was regarded as being appropriate in the alkali solubility. Further, a hole of 100×100 μm and a hole of 200×200 μm were developed, so that the photosensitive dry film resist was regarded as being appropriate in the developing property. Further, under both (i) the normal condition and (ii) the moisture absorption condition, the 30-second-dipable temperature was 320° C., so that the photosensitive dry film resist was regarded as being appropriate in the soldering heat resistance. Further, the electric insulation property was 1.75×10⁹Ω, so that the photosensitive dry film resist was regarded as being appropriate in the electric insulation property.

### EXAMPLE 9

<Production of Photosensitive Dry Film Resist>

The following components were mixed so as to prepare an organic solvent solution of the photosensitive resin composition, thereby producing a photosensitive dry film resist in the B stage state (see Production Example).

Photosensitive polyimide resin (A-1-2) the photosensitive polyimide resin obtained in Example 8 (in accordance with conversion based on a solid content): 40 parts by weight

(meth)acryls compound (B) epoxyacrylate (NK oligo EA-1010 (commercial name) produced by SHIN-NAKAMURA CHEMICAL CO., LTD.): 10 parts by weight bisphenol A type epoxyacrylate (Ebecryl 3700 (commercial name) produced by DAICEL-UCB Company LTD.): 30 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4,6-trimethylbenzoyl)phenylphosphineoxide (IRGACURE 819 (commercial name) produced by Ciba Specialty Chemicals): 3 parts by weight

Curing agent (accessory component) (C-3) 4,4′-diaminodiphenylmethane (DDM): 1 part by weight

Epoxy resin (accessory component) (C-4) bisphenol A type epoxy resin (Epikote 828 (commercial name) produced by Japan Epoxy Resins Co., Ltd.): 10 parts by weight

<Evaluation of Properties>

The obtained photosensitive dry film resist was evaluated in terms of the aforementioned properties. As a result, the dissolving time of the photosensitive dry film resist in the B stage state was 50 seconds, so that the photosensitive dry film resist was regarded as being appropriate in the alkali solubility. Further, a hole of 100×100 μm and a hole of 200×200 μm were developed, so that the photosensitive dry film resist was regarded as being appropriate in the developing property. Further, under both (i) the normal condition and (ii) the moisture absorption condition, the 30-second-dipable temperature was 330° C., so that the photosensitive dry film resist was regarded as being free appropriate in the soldering heat resistance. Further, the electric insulation property was 3.21×10⁹Ω, so that the photosensitive dry film resist was regarded as being appropriate in the electric insulation property.

### COMPARATIVE EXAMPLE 3

<Synthesis of Base Polymer>

173 g (0.30 mol) of ESDA and 300 g of DMF were placed in a 500 ml separable flask provided with a stirrer, and the mixture was stirred, thereby preparing a DMF solution made of ESDA. Next, 86.5 g (0.20 mol) of BAPS-M was dissolved in 100 g of DNF, and the resultant was added to the DMF solution and was intensely stirred until it became even, thereby preparing DMF solution of ESDA and BAPS-M. 83.5 g (0.10 mol) of KF-8010 was added to the DMF solution and was intensely stirred for one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 315 g of polyimide resin. In the polyimide resin, neither a hydroxyl group nor a photosensitive group was included in its structure.

<Production of Photosensitive Dry Film Resist>

15 g of the polyimide resin was dissolved in 35 g of dioxolane, thereby preparing such varnish (solution) that its solid content weight % (Sc)=30%. Next, the photosensitive dry film resist in the B stage state was produced (see Production Example). That is, the photosensitive dry film resist was produced under the same condition as in Example 5 except that the polyimide solution was used instead of the photosensitive polyimide resin solution (A-1-2) of Example 5.

<Evaluation of Properties>

The obtained photosensitive dry film resist was evaluated in terms of the aforementioned properties. As a result, even though the development process was carried out for 180 seconds, the thickness of the photosensitive dry film resist decreased merely from 25 μm to 22 μm after the development process, and the photosensitive dry film resist remained undissolved on an entire surface of the sample, so that the photosensitive dry film resist was regarded as being inappropriate in its alkali solubility. Further, neither a hole of 100×100 μm nor a hole of 200×200 μm were developed, so that the photosensitive dry film resist was regarded as being inappropriate in the developing property. Further, under both (i) the normal condition and (ii) the moisture absorption condition, the 30-second-dipable temperature was 320° C., so that the photosensitive dry film resist was regarded as being appropriate in the soldering heat resistance. Further, the electric insulation property was 2.88×10¹⁰ Ω.

In this way, when the polyimide resin having no hydroxyl group was used as the base polymer (i.e., the base resin component (A)), the soldering heat resistance and the electric insulation property were excellent, but the alkali solubility and the developing property (i.e., the water system developing property) were insufficient.

### COMPARATIVE EXAMPLE 4

<Synthesis of Base Polymer>

Monomers of methylmethacrylate, n-butylmethacrylate, 2-ethylhexylacrylate, and methacrylic acid were used as materials for the polyimide resin. These monomer components were copolymerized in accordance with a known method, thereby obtaining a copolymer having a carboxyl group. Note that, a polymerization ratio of the monomer components in the copolymerization reaction was methylmethacrylate/n-butylmethacrylate/2-ethylhexylacrylate/methacrylic acid=60/10/10/20 (in terms of a weight).

<Production of Photosensitive Dry Film Resist>

The photosensitive dry film resist was produced under the same condition as in Example 9 except that the acrylic copolymer synthesized in the foregoing manner was used instead of the photosensitive polyimide resin (A-1-2) of Example 9.

<Evaluation of Properties>

The obtained photosensitive dry film resist was evaluated in terms of the aforementioned properties. As a result, the dissolving time of the photosensitive dry film resist in the B stage state was 30 seconds, so that the photosensitive dry film resist was regarded as being free from any problem in the alkali solubility. Further, a hole of 100×100 μm and a hole of 200×200 μm were developed, so that the photosensitive dry film resist was regarded as being appropriate in the developing property. Further, under (i) the normal condition, the 30-second-dipable temperature was 270° C., and under (ii) the moisture absorption condition, the 30-second-dipable temperature was 250° C., so that the photosensitive dry film resist was regarded as being inappropriate in the soldering heat resistance. Further, short-circuit occurred after 220 hours for which the voltage had been applied, so that the photosensitive dry film resist was regarded as being inappropriate in the electric insulation property.

In this way, when the acrylic copolymer made of monomer having no aromatic ring was used, the alkali solubility and the developing property (water system developing property) were excellent, but the soldering heat resistance and the electric insulation property were insufficient.

### EXAMPLE 10

<Synthesis of Soluble Polyimide Resin (A-1-3)>

69.7 g (0.27 mol) of DAM-1 and 100 g of DMF were placed in a 500 ml separable flask provided with a stirrer, and the mixture was stirred, thereby preparing a DMF solution made of DAM-1. Next, 24.9 g (0.03 mol) of KF-8010 was added thereto, and the resultant was intensely stirred until it became even, thereby preparing DMF solution of DAM-1 and KF-8010. Subsequently, 173 g (0.30 mol) of ESDA was dissolved in 300 g of DMF, and the resultant was added to the DMF solution, and the mixture was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 241.0 g of polyimide resin having a hydroxyl group.

A hydroxyl equivalent of the polyimide resin having a hydroxyl group was 475, and a weight-average molecular weight of the polyimide resin having a hydroxyl group was 45000. Further, 50 g or more of the polyimide resin having a hydroxyl group was dissolved in 100 g (20° C.) of tetrahydrofuran.

Next, 60 g of the hydroxy polyimide was dissolved in 140 g of dioxolane, and 10.82 g (0.076 mol) of GMA and 0.38 g (3.8 mol) of triethylamine were added thereto. Further, 0.001 g of Q-1301 was added thereto as a polymerization inhibitor. Thereafter, the mixture was stirred at 60° C. for eight hours. In this manner, there was synthesized a soluble polyimide resin (A-1-3), having a methacryl group in its imide side chain, by denaturalizing hydroxyl group in its polyimide side chain by GMA.

<Production of Photosensitive Dry Film Resist>

15 g of the soluble polyimide resin was dissolved in 35 g of dioxolane, thereby preparing such varnish (solution) that its solid content weight % (Sc)=30%. Next, the following components were mixed so as to prepare an organic solvent solution of the photosensitive resin composition, thereby producing a photosensitive dry film resist in the B stage state (see Production Example).

Soluble polyimide resin (A-1-3) the foregoing soluble polyimide resin (in accordance with conversion based on a solid content): 50 parts by weight

(meth)acryls compound (B) bisphenol A EO denaturalized (recurring unit of an ethyleneoxide denaturalized portion: m+n=4) diacrylate (ARONIX M-211B (commercial name) produced by TOAGOSEI CO., LTD.): 40 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4-cyclopentadien-1-yl)-bis(2,6′-difluoro-3-(1H-pyrrole-1-yl)-phenyl)titanium (IRGACURE 784 (commercial name) produced by Ciba Specialty Chemicals): 0.1 part by weight

Polymerization inhibitor (storage stabilization additive) (D) N-nitrosophenylhydroxylamine aluminum salt (Q-1301 (commercial name) produced by Wako Pure Chemical Industries, Ltd.): 0.0005 parts by weight

<Evaluation of Properties>

The obtained photosensitive dry film resist was evaluated in terms of the aforementioned properties. As a result, the initial viscosity A₀ of the varnish was 7.0 poise, and the viscosity A₁ after 7 days for which the varnish had been left was 8.0 poise, so that the viscosity increasing rate was 14.3%. Thus, the photosensitive dry film resist was regarded as being appropriate in the viscosity variation. The dissolving time initial value t₀ was 30 seconds, and the value t₁ after 7 days for which the varnish had been left was 30 seconds, so that the variation was 0%. Thus, the photosensitive dry film resist was regarded as being appropriate in the variation of the alkali solubility. Further, a hole of 100×100 μm and a hole of 200×200 μm were developed in the developing time of 60 seconds, so that the photosensitive dry film resist was regarded as being appropriate in the developing property. Further, the photosensitive dry film resist was free from any problem in the anti-hydrolysis property. Thus, the photosensitive dry film resist was regarded as being appropriate in the anti-hydrolysis property.

### EXAMPLE 11

<Synthesis of Soluble Polyimide Resin (A-1-3)>

60 g of the hydroxy polyimide obtained in Example 11 was dissolved in 140 g of dioxolane, and 30.50 g of acrylic compound having an epoxy group (NK oligo EA-1010 (commercial name) produced by SHIN-NAKAMURA CHEMICAL CO., LTD.) and 0.38 g (3.8 mmol) of triethylamine were added thereto. Further, 0.001 g of Q-1301 was added thereto as a polymerization inhibitor, and the resultant was stirred at 60° C. for 8 hours. In this manner, there was synthesized a soluble polyimide resin (A-1-3), having an acryl group in its imide side chain, by denaturalizing hydroxyl group in its polyimide side chain.

<Production of Photosensitive Dry Film Resist>

The photosensitive resin composition varnish and the photosensitive dry film resist were produced under the same condition as in Example 10 except that the soluble polyimide denaturalized by NK oligo EA-1010 was used instead of the soluble poyimide resin denaturalized by GMA.

<Evaluation of Properties>

The obtained photosensitive dry film resist was evaluated in terms of the aforementioned properties. As a result, the initial viscosity A₀ of the varnish was 9.0 poise, and the viscosity A₁ after 7 days for which the varnish had been left was 10.0 poise, so that the viscosity increasing rate was 11.1%. Thus, the photosensitive dry film resist was regarded as being appropriate in the viscosity variation. The dissolving time initial value to was 40 seconds, and the value ti after 7 days for which the varnish had been left was 40 seconds, so that the variation was 0%. Thus, the photosensitive dry film resist was regarded as being appropriate in the variation of the alkali solubility. Further, a hole of 100×100 μm and a hole of 200×200 μm were developed in the developing time of 60 seconds, so that the photosensitive dry film resist was regarded as being appropriate in the developing property. Further, the photosensitive dry film resist was free from any problem in the anti-hydrolysis property. Thus, the photosensitive dry film resist was regarded as being appropriate in the anti-hydrolysis property.

### EXAMPLE 12

<Synthesis of Soluble Polyimide Resin (A-1-3)>

Diamine represented by the following formula (MBAA (commercial name) produced by Wakayama Seika Co., Ltd.: hereinafter, this is referred to by the commercial name) was used.

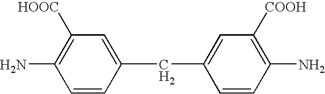

76.9 g (0.21 mol) of MBAA and 100 g of DMF were placed in a 500 ml separable flask provided with a stirrer, and the mixture was stirred, thereby preparing a DMF solution made of MBAA. Next, 74.7 g (0.09 mol) of KF-8010 was added thereto, and the resultant was intensely stirred until it became even, thereby preparing DMF solution of MBAA and FK-8010. Subsequently, 173 g (0.30 mol) of ESDA was dissolved in 300 g of DMF, and the resultant was added to the DMF solution, and the mixture was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 285.6 g of polyimide resin having a hydroxyl group.

A hydroxyl equivalent of the polyimide resin having a hydroxyl group was 745, and a weight-average molecular weight of the polyimide resin having a hydroxyl group was 27000. Further, 50 g or more of the polyimide resin having a hydroxyl group was dissolved in 100 g (20° C.) of tetrahydrofuran.

Next, 60 g of the hydroxy polyimide was dissolved in 140 g of dioxolane, and 30.50 g of acrylic compound having an epoxy group (NK oligo EA-1010 (commercial name) produced by SHIN-NAKAMURA CHEMICAL CO., LTD.) and 0.38 g (3.8 mmol) of triethylamine were added thereto. Further, 0.001 g of Q-1301 was added thereto as a polymerization inhibitor, and the resultant was stirred at 60° C. for 8 hours. In this manner, there was synthesized a soluble polyimide resin (A-1-3), having an acryl group in its imide side chain, by denaturalizing hydroxyl group in its polyimide side chain.

<Production of Photosensitive Dry Film Resist>

15 g of the soluble polyimide resin was dissolved in 35 g of dioxolane, thereby preparing such varnish (solution) that its solid content weight % (Sc)=30%. Next, the following components were mixed so as to prepare an organic solvent solution of the photosensitive resin composition, thereby producing a photosensitive dry film resist in the B stage state (see Production Example).

Soluble polyimide resin (A-1-3) the foregoing soluble polyimide resin (in accordance with conversion based on a solid content): 65 parts by weight

(meth)acryls compound (B) epoxyacrylate (NK oligo EA-1010 (commercial name) produced by SHIN-NAKAMURA CHEMICAL CO., LTD.): 25 parts by weight bisphenol A EO denaturalized (recurring unit of an ethyleneoxide denaturalized portion: m+n=30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4,6-trimethylbenzoyl)phenylphosphineoxide (IRGACURE 819 (commercial name) produced by Ciba Specialty Chemicals): 1 part by weight

Curing agent (accessory component) (C-3) 4,4′-diaminodiphenylsulfone (DDS): 3 parts by weight

Oxidization inhibitor (storage stabilization additive) (D) hydroquinone: 0.5 parts by weight

<Evaluation of Properties>

The obtained photosensitive dry film resist was evaluated in terms of the aforementioned properties. As a result, the initial viscosity A₀ of the varnish was 10.0 poise, and the viscosity Al after 7 days for which the varnish had been left was 10.5 poise, so that the viscosity increasing rate was 5.0%. Thus, the photosensitive dry film resist was regarded as being appropriate in the viscosity variation. The dissolving time initial value to was 60 seconds, and the value t₁ after 7 days for which the varnish had been left was 60 seconds, so that the variation was 0%. Thus, the photosensitive dry film resist was regarded as being appropriate in the variation of the alkali solubility. Further, a hole of 100×100 μm and a hole of 200×200 μm were developed in the developing time of 90 seconds, so that the photosensitive dry film resist was regarded as being appropriate in the developing property. Further, the photosensitive dry film resist was free from any problem in the anti-hydrolysis property. Thus, the photosensitive dry film resist was regarded as being appropriate in the anti-hydrolysis property.

### EXAMPLE 13

<Synthesis of Soluble Polyimide Resin (A-1-3)>

185 g (0.27 mol) of the same DAM-R1 as in Example 2 and 100 g of DMF were placed in a 500 ml separable flask provided with a stirrer, and the mixture was stirred, thereby preparing a DMF solution made of DAM-R1 . Next, 24.9 g (0.03 mol) of KF-8010 was added thereto, and the resultant was intensely stirred until it became even, thereby preparing DMF solution of DAM-R1 and KF-8010. Subsequently, 173 g (0.30 mol) of ESDA was dissolved in 300 g of DMF, and the resultant was added to the DMF solution, and the mixture was intensely stirred for about one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 345 g of polyimide resin having a hydroxyl group.

A hydroxyl equivalent of the polyimide resin having a hydroxyl group was 418, and a weight-average molecular weight of the polyimide resin having a hydroxyl group was 72000. Further, 50 g or more of the polyimide resin having a hydroxyl group was dissolved in 100 g (20° C.) of tetrahydrofuran.

Next, 60 g of the hydroxy polyimide was dissolved in 140 g of dioxolane, and 15.20 g of glycidyl vinyl ether and 0.38 g (3.8 mmol) of triethylamine were added thereto. Further, 0.001 g of Q-1301 was added thereto as a polymerization inhibitor, and the resultant was stirred at 60° C. for 8 hours. In this manner, there was synthesized a soluble polyimide resin (A-1-3), having a vinyl group in its imide side chain, by denaturalizing hydroxyl group in its polyimide side chain.

<Production of Photosensitive Dry Film Resist>

7.5 g of the soluble polyimide resin and 7.5 g of the photosensitive polyimide resin synthesized in Example 12 were dissolved in 35 g of dioxolane, thereby preparing such varnish (solution) that its solid content weight % (Sc)=30%. Next, the following components were mixed so as to prepare an organic solvent solution of the photosensitive resin composition, thereby producing a photosensitive dry film resist in the B stage state (see Production Example).

Soluble polyimide resin (A-1-3) the soluble polyimide resin synthesized in Example 12 (in accordance with conversion based on a solid content): 40 parts by weight the soluble polyimide resin synthesized in the present Example (in accordance with conversion based on a solid content): 20 parts by weight

(meth)acryls compound (B) bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 20 parts by weight bisphenol A EO denaturalized (recurring unit of an ethyleneoxide denaturalized portion: m+n≈10) diacrylate (NK ester A-BPE-10 (commercial name) produced by SHIN-NAKAMURA CHEMICAL CO., LTD.): 20 parts by weight

Optical reaction initiator (accessory component) (C-1) bis(2,4,6-trimethylbenzoyl)phenylphosphineoxide (IRGACURE 819 (commercial name) produced by Ciba Specialty Chemicals): 1 part by weight

Oxidization inhibitor (storage stabilization additive) (D) hexamethylenebis[3-(3,5-di-t-butyl-4-hydroxyphenyl)propionate] (IRGANOX 259 (commercial name) produced by Ciba Specialty Chemicals): 0.5 parts by weight

<Evaluation of Properties>

The obtained photosensitive dry film resist was evaluated in terms of the aforementioned properties. As a result, the initial viscosity A₀ of the varnish was 7.0 poise, and the viscosity A₁ after 7 days for which the varnish had been left was 8.0 poise, so that the viscosity increasing rate was 14.3%. Thus, the photosensitive dry film resist was regarded as being appropriate in the viscosity variation. The dissolving time initial value to was 60 seconds, and the value t₁ after 7 days for which the varnish had been left was 70 seconds, so that the variation was 16.7%. Thus, the photosensitive dry film resist was regarded as being appropriate in the variation of the alkali solubility. Further, a hole of 100×100 μm and a hole of 200×200 μm were developed in the developing time of 90 seconds, so that the photosensitive dry film resist was regarded as being appropriate in the developing property. Further, the photosensitive dry film resist was free from any problem in the anti-hydrolysis property. Thus the photosensitive dry film resist was regarded as being appropriate in the anti-hydrolysis property.

### EXAMPLE 14

<Production of Photosensitive Dry Film Resist>

The following components were mixed so as to prepare an organic solvent solution of a photosensitive resin composition, thereby producing a photosensitive dry film resist in the B stage state (see Production Example).

Soluble polyimide resin (A-1-3) the soluble polyimide resin synthesized in Example 12 (in accordance with conversion based on a solid content): 40 parts by weight

(meth)acryls compound (B) epoxyacrylate (NK oligo EA-1010 (commercial name) produced by SHIN-NAKAMURA CHEMICAL CO., LTD.): 10 parts by weight bisphenol A type epoxyacrylate (Ebecryl 3700 (commercial name) produced by DAICEL-UCB Company LTD.): 30 parts by weight bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 10 parts by weight

Optical reaction initiator (accessory component) (C-1) bis(2,4,6-trimethylbenzoyl)phenylphosphineoxide (IRGACURE 819 (commercial name) produced by Ciba Specialty Chemicals): 3 part by weight

Curing agent (accessory component) (C-3) 4,4′-diaminodiphenylmethane (DDM): 1 part by weight

Epoxy resin (accessory component) (C-4) bisphenol A type epoxy resin (EPIKOTE 828 (commercial name) produced by TOAGOSEI CO., LTD.): 10 parts by weight

Polymerization inhibitor (storage stabilization additive) (D)

N-nitrosophenylhydroxylamine aluminum salt (Q-1301 (commercial name) produced by Wako Pure Chemical Industries, Ltd.): 0.0005 parts by weight

<Evaluation of Properties>

The obtained photosensitive dry film resist was evaluated in terms of the aforementioned properties. As a result, the initial viscosity A₀ of the varnish was 12.0 poise, and the viscosity A₁ after 7 days for which the varnish had been left was 13.0 poise, so that the viscosity increasing rate was 8.3%. Thus, the photosensitive dry film resist was regarded as being appropriate in the viscosity variation. The dissolving time initial value t₀ was 30 seconds, and the value t₁ after 7 days for which the varnish had been left was 30 seconds, so that the variation was 0%. Thus, the photosensitive dry film resist was regarded as being appropriate in the variation of the alkali solubility. Further, a hole of 100×100 μm and a hole of 200×200 μm were developed in the developing time of 60 seconds, so that the photosensitive dry film resist was regarded as being appropriate in the developing property. Further, the photosensitive dry film resist was free from any problem in the anti-hydrolysis property. Thus, the photosensitive dry film resist was regarded as being appropriate in the anti-hydrolysis property.

### COMPARATIVE EXAMPLE 5

<Production of Photosensitive Dry Film Resist>

The photosensitive resin composition varnish and the photosensitive dry film resist were produced under the same condition as in Example 10 except that the polymerization inhibitor (D) was not used.

<Evaluation of Properties>

The obtained photosensitive dry film resist was evaluated in terms of the aforementioned properties. As a result, the initial viscosity A₀ of the varnish was 7.0 poise, and the viscosity A₁ after 7 days for which the varnish had been left was 24.0 poise, so that the viscosity increasing rate was 242.9%. Thus, the photosensitive dry film resist was regarded as being inappropriate in the viscosity variation. The dissolving time initial value t₀ was 30 seconds, and the value t₁ after 7 days for which the varnish had been left was 180 seconds, so that the variation was 500%. Thus, the photosensitive dry film resist was regarded as being inappropriate in the variation of the alkali solubility. While, a hole of 100×100 μm and a hole of 200×200 μm were developed in the developing time of 60 seconds, so that the photosensitive dry film resist was regarded as being appropriate in the developing property. Further, the photosensitive dry film resist was free from any problem in the anti-hydrolysis property. Thus, the photosensitive dry film resist was regarded as being appropriate in the anti-hydrolysis property.

In this way, even in case where the soluble polyimide resin (A-1-3) having a polymerizable functional group and having at least either a carboxyl group or a hydroxyl group was used as the base polymer, when the storage stabilization additive (D) such as polymerization inhibitor was not used, the developing property and the anti-hydrolysis property were excellent, but the viscosity and the dissolving time of the varnish drastically increased. Thus, the storage stability of the varnish and the photosensitive dry film resist significantly dropped.

### COMPARATIVE EXAMPLE 6

<Production of Photosensitive Dry Film Resist>

The varnish of the photosensitive resin composition and the photosensitive dry film resist were produced under the same condition as in Example 12 except that the hydroxy polyimide (not denaturalized) synthesized in Example 12 was used as the base polymer and the polymerization inhibitor (D) was not used.

<Evaluation of Properties>

The obtained photosensitive dry film resist was evaluated in terms of the aforementioned properties. As a result, the initial viscosity A₀ of the varnish was 10.0 poise, and the viscosity A₁ after 7 days for which the varnish had been left was 15.0 poise, so that the viscosity increasing rate was 50.0%. Thus, the photosensitive dry film resist was regarded as being inappropriate in the viscosity variation. The dissolving time initial value to was 60 seconds, and the value t₁ after 7 days for which the varnish had been left was 100 seconds, so that the variation was 66.7%. Thus, the photosensitive dry film resist was regarded as being inappropriate in the variation of the alkali solubility. Furthermore, in the anti-hydrolysis test, the color of the copper line varied to brown or a similar color. Thus, the photosensitive dry film resist was regarded as being inappropriate in the anti-hydrolysis property. While, a hole of 100×100 μm and a hole of 200×200 μm were developed in the developing time of 90 seconds, so that the photosensitive dry film resist was regarded as being appropriate in the developing property.

In this way, when the soluble polyimide resin (A-1-3) having a carboxyl group and having no polymerizable functional group was used as the base polymer and the storage stabilization additive (D) such as polymerization inhibitor was not used, the developing property was excellent. However, the (meth)acryls compound (B) reacted, so that the viscosity and the dissolving time of the varnish increased. Thus, the storage stability of the varnish and the photosensitive dry film resist significantly dropped. Further, also the cured photosensitive dry film resist was inappropriate in the anti-hydrolysis property. However, the viscosity and the dissolving time of the varnish less varied than Comparative Example 5 using the soluble polyimide resin (A-1-3).

### COMPARATIVE EXAMPLE 7

<Synthesis of Base Polymer>

173 g (0.30 mol) of ESDA and 300 g of DMF were placed in a 500 ml separable flask provided with a stirrer, and the mixture was stirred, thereby preparing a DMF solution made of ESDA. Subsequently, 86.5 g (0.20 mol) of BAPS-M was dissolved in 100 g of DMF, and the resultant was added to the DMF solution, and the mixture was intensely stirred until the mixture became even, thereby preparing a DMF solution of ESDA and BAPS-M. 83.5 g (0.10 mol) of KF-8010 was added to the DMF solution, and the resultant was stirred for one hour, thereby obtaining a polyamic acid solution. The polyamic acid solution was placed in a tray coated with fluorocarbon resin and was dried in a vacuum oven at 200° C. under reduced pressure of 660 Pa for two hours. Thereafter, the resultant was retrieved from the vacuum oven, thereby obtaining 315 g of polyimide resin.

50 g or more of the polyimide resin was dissolved in 100 g (20° C.) of tetrahydrofuran, so that this was regarded as the soluble polyimide resin defined in the present invention, but the polyimide resin had neither a hydroxyl group nor a carboxyl group in its imide side chain. Note that, a weight-average molecular weight of the polyimide resin was 45000.

<Production of Photosensitive Dry Film Resist>

The photosensitive resin composition varnish and the photosensitive dry film resist were produced under the same condition as in Example 10 except that the soluble polyimide resin was used as the base polymer.

<Evaluation of Properties>

The obtained photosensitive dry film resist was evaluated in terms of the aforementioned properties. As a result, the initial viscosity A₀ of the varnish was 8.0 poise, and the viscosity A₁ after 7 days for which the varnish had been left was 9.0 poise, so that the viscosity increasing rate was 12.5%. Thus, the photosensitive dry film resist was regarded as being appropriate in the viscosity variation. Further, the photosensitive dry film resist was free from any problem in the anti-hydrolysis property. However, even though the development process was carried out for 180 seconds, the photosensitive dry film resist was not dissolved, so that the photosensitive dry film resist was regarded as inappropriate in the alkali solubility. Further, even though the development process was carried out for 180 seconds, the thickness of the photosensitive dry film resist decreased merely from 25 μm to 22 μm after the development process, and neither a hole of 100×100 μm nor a hole of 200×200 μm were developed, and the photosensitive dry film resist remained undissolved on an entire surface of the sample, so that the photosensitive dry film resist was regarded as being inappropriate in the developing property.

In this way, when the soluble polyimide resin (A-1-3) having no polymerizable functional group and not having a carboxyl group or a hydroxyl group was used as the base polymer, the storage stability of the varnish and the anti-hydrolysis of the cured photosensitive dry film resist were excellent. However, the alkali solubility and the developing property dropped.

### COMPARATIVE EXAMPLE 8

The photosensitive resin composition varnish and the photosensitive dry film resist were produced under the same condition as in Example 7 except that the polymerization inhibitor (D) was not used. A result of evaluation thereof was the same as the evaluation of Comparative Example 7 except that: the initial viscosity A₀ of the varnish was 8.0 poise, and the viscosity A₁ after 7 days for which the varnish had been left was 12.0 poise, so that the viscosity increasing rate was 50.0% and the photosensitive dry film resist was regarded as being inappropriate in the viscosity variation.

In this manner, in case where the soluble polyimide resin having no polymerizable functional group and not having a carboxyl group or a hydroxyl group was used as the base polymer, when the storage stabilization additive (D) such as polymerization inhibitor was not used, the anti-hydrolysis was excellent. However, the (meth)acryls compound (B) reacted, so that the viscosity variation of the varnish increased, and the alkali solubility and the developing property dropped. However, compared with the case where the soluble polyimide resin (A-1-3) described in Comparative Example 5 was used and the storage stabilization additive (D) was not used, the viscosity of the varnish less increased.

### COMPARATIVE EXAMPLE 9

### <Synthesis of Base Polymer>

Monomers of methylmethacrylate, n-butylmethacrylate, 2-ethylhexylacrylate, and methacrylic acid were used as materials for the polyimide resin. These monomer components were copolymerized in accordance with a known method, thereby obtaining a copolymer having a carboxyl group. Note that, a polymerization ratio of the monomer components in the copolymerization reaction was methylmethacrylate/n-butylmethacrylate/2-ethylhexylacrylate/methacrylic acid=60/10/10/20 (in terms of a weight).

<Production of Photosensitive Dry Film Resist>

The photosensitive resin composition varnish and the photosensitive dry film resist were produced under the same condition as in Example 12 except that the acrylic copolymer synthesized in the foregoing manner was used instead of the soluble polyimide resin (A-1-3) as the base polymer.

<Evaluation of Properties>

The obtained photosensitive dry film resist was evaluated in terms of the aforementioned properties. As a result, the initial viscosity A₀ of the varnish was 8.0 poise, and the viscosity A₁ after 7 days for which the varnish had been left was 9.0 poise, so that the viscosity increasing rate was 12.5%. Thus, the photosensitive dry film resist was regarded as being appropriate in the viscosity variation. The dissolving time initial value t₀ was 30 seconds, and the value t₁ after 7 days for which the varnish had been left was 30 seconds, so that the variation was 0%. Thus, the photosensitive dry film resist was regarded as being appropriate in the alkali solubility. Further, a hole of 100×100 μm and a hole of 200×200 μm were developed in the developing time of 40 seconds, so that the photosensitive dry film resist was regarded as being appropriate in the developing property. However, although the copper line was free from any color variation, the photosensitive dry film resist became brittle, so that the photosensitive dry film resist was exfoliated from the flexible copper plate having a circuit upon bending the laminate sample. Thus, the photosensitive dry film resist was regarded as being inappropriate in the anti-hydrolysis property.

In this way, when the acrylic copolymer was used as the base polymer, the dissolving time less varied, and the developing property was excellent, but the anti-hydrolysis property dropped.

### COMPARATIVE EXAMPLE 10

<Production of Photosensitive Dry Film Resist>

The photosensitive resin composition varnish and the photosensitive dry film resist were produced under the same condition as in Example 12 except that the acrylic copolymer synthesized in Comparative Example 9 was used as the base polymer instead of the soluble polyimide resin (A-1-3) of Example 12 and the polymerization inhibitor (D) was not used.

<Evaluation of Properties>

The obtained photosensitive dry film resist was evaluated in terms of the aforementioned properties. As a result, the initial viscosity A₀ of the varnish was 8.0 poise, and the viscosity A₁ after 7 days for which the varnish had been left was 10.0 poise, so that the viscosity increasing rate was 25.0%. Thus, the photosensitive dry film resist was regarded as being inappropriate in the viscosity variation. The dissolving time initial value t₀ was 30 seconds, and the value t₁ after 7 days for which the varnish had been left was 50 seconds, so that the variation was 66.7%. Thus, the photosensitive dry film resist was regarded as being inappropriate in the variation of the alkali solubility. Further, although the copper line was free from any color variation, the photosensitive dry film resist became brittle, so that the photosensitive dry film resist was exfoliated from the flexible copper plate having a circuit upon bending the laminate sample. Thus, the photosensitive dry film resist was regarded as being inappropriate in the anti-hydrolysis property. Note that, a hole of 100×100 μm and a hole of 200×200 μm were developed in the developing time of 40 seconds, so that the photosensitive dry film resist was regarded as being free from any problem in the developing property.

In this way, when the acrylic copolymer was used as the base polymer and no storage stabilization additive (D) was used, the developing property was excellent, but the viscosity and the dissolving time of the varnish greatly varied, so that the anti-hydrolysis property dropped.

Next, the following description will explain Examples and Comparative Examples of a case where the photosensitive imide(meth)acrylsiloxane oligomer (photosensitive IMASO) was selected as the base resin component (A). In this case, properties of the photosensitive resin composition or the photosensitive dry film resist were evaluated as follows. Also, a specific example where the photosensitive IMASO was synthesized is as follows.

[Evaluation of Properties of Photosensitive Dry Film Resist]

The photosensitive resin composition or the photosensitive dry film resist produced in each Example and Comparative Example was evaluated in terms of (1) flame retardancy, (2) developing property, (3) soldering heat resistance, (4) anti-migration property, (5) adhesiveness, (6) insulation resistance, (7) weight-average molecular weight of imide siloxane oligomer (ISO).

(1) Flame Retardancy

In accordance with flame retardancy test standard UL94 for plastic material, the following flame retardancy test was carried out.

With a bar coater, the photosensitive resin composition solution was applied to a polyimide film (25AH film produced by Kanegafuchi Chemical Ind. Co., Ltd.) whose thickness was 25 μm while shielding the photosensitive resin composition solution from light, and the resultant was dried at 60° C. for 5 minutes and 90° C. for 5 minutes so that a thickness of the dried resultant was 25 μm. Next, the dried resultant was exposed to 600 mJ/cm² of light whose wavelength was 400 nm, and the resultant was thermally cured in an oven of 180° C. for two hours. Thus obtained sample was cut into a size of 1.27 cm (width)×12.7 cm (length)×50 μm (thickness) (including the thickness of the polyimide film). In this way, 20 samples were prepared.

Among 20 samples, 10 samples were processed (i) at 23° C. with 50% of relative humidity for 48 hours, and other 10 samples were processed (ii) at 70° C. for 168 hours, and then was cooled in a desiccator containing anhydrous calcium chloride for 4 or more hours.

An upper portion of each sample was clamped so as to be vertically fixed, and a flame of a burner was positioned near to a lower portion of the sample for 10 seconds so that the lower portion caught fire. After 10 seconds, the flame of the burner was separated away from the sample, and time (seconds) taken for the sample to be free from any flame or burning was measured. Under the foregoing condition (i) or (ii), when the sample became free from any frame or burning and realized self extinction within 5 seconds (not more than 10 seconds) after separating the flame of the burner away from the sample, the photosensitive resin composition or the photosensitive dry film resist was regarded as being appropriate. When even a single sample failed in self extinction within 10 seconds or when the flame rose to the clamp in the upper portion of the sample and the burning continued, the photosensitive resin composition or the photosensitive dry film resist was regarded as being inappropriate.

(2) Developing Property

With a bar coater, the photosensitive resin composition solution was applied to an electrolysis copper foil (NDP-3½ oz (commercial name) produced by MITSUI MINING & SMELTING Co., LTD.) whose thickness was 18 μm, and the resultant was dried at 60° C. for 5 minutes and 90° C. for 5 minutes so that a thickness of the dried resultant was 25 μm, thereby producing a laminate. A mask pattern was placed on the photosensitive resin composition of the laminate, and the laminate was exposed to 600 mJ/cm² of light whose wavelength was 400 nm.

Thereafter, a spray developing device (ES-655D (commercial name) which was an etching machine produced by Sunhayato Corporation) was used to develop the laminate in 1% potassium hydroxide aqueous solution (its temperature was 40° C.) at a spray pressure of 0.85 MPa with a residence time of one minute in the developer. A photomask pattern used therein had a minute hole of 100×100 μm. After being developed, the laminate was rinsed with distilled water so as to remove the developer, and was dried. When the hole of 100×100 μm was formed, the laminate was regarded as being appropriate.

(3) Soldering Heat Resistance

First, an electrolytic copper foil (NDP-3½ oz (commercial name) produced by MITSUI MINING & SMELTING Co., LTD.) whose thickness was 18 μm was subjected to soft etching (the step of removing an antirust from a surface of the copper foil) with 10 wt % of sulfuric acid aqueous solution for one minute, and was rinsed with water, and then the surface was rinsed with ethanol and acetone, and thus rinsed surface was dried. With a bar coater, the photosensitive resin composition solution was applied to the electrolysis copper foil, and the resultant was dried at 60° C. for 5 minutes and 90° C. for 5 minutes so that a thickness of the dried resultant was 25 μm, thereby producing a laminate. The photosensitive resin composition of the laminate was exposed to 600 mJ/cm² of light whose wavelength was 400 nm. The laminate subjected to the light exposure was cut into 4 cm×4 cm, and the resultant was thermally cured at 180° C. for two hours, thereby obtaining a sample.

The laminate sample was subjected to humidity conditioning under (i) a normal condition (at 20° C., with relative humidity of 40%, for 24 hours) and (ii) a moisture absorption condition (at 40° C., with relative humidity of 85%, for 48 hours). Thereafter, the laminate sample was dipped in melted solder, whose temperature was 270° C. or higher, for one minute. Then, whether or not swollenness occurred and whether or not exfoliation occurred in an interface between the copper foil and the photosensitive dry film resist were observed. Further, a temperature of the melted solder was gradually raised so as to check a temperature at which the sample was under an abnormal condition while dipping the sample for 30 seconds per 10° C. A maximum temperature which resulted no abnormal condition was defined as a 30-second-dipable temperature.

(4) Anti-Migration Property

In a flexible copper laminate plate (a double-side copper laminate plate obtained by forming copper foils on both sides of a polyimide resin: SC18-25-00WE (commercial name) produced by Nippon Steel Chemical Group), only one side of an etched copper foil was removed, thereby preparing a single-side flexible copper laminate plate. In the single-side flexible copper laminate plate, a comb-shaped pattern circuit shown in FIG. 1 (pattern circuit in which line/space=40/40 μm) was formed, and the photosensitive dry film resist from which the protective film had been exfoliated was laminated on the pattern circuit, and lamination was carried out at 100° C. with 20000 Pa.m. Thereafter, the photosensitive dry film resist was exposed to only 1800 mJ/cm² of light whose wavelength was 400 nm. Thereafter, the resultant was heated at 180° C. for two hours, thereby coating the cover lay film.

With respect to the pattern circuit coated with the cover lay film, a direct current voltage of 100V was applied to each of both terminals 11 and 21 in an environmental testing machine at 85° C. with 85%RH, and variation of the resistance value and whether or not any migration had occurred (whether or not dendrite had occurred) were observed in 1000 hours.

Note that, as to the migration and the dendrite, assuming that a leak current occurs in the comb-shaped circuit 10 or 20 shown in FIG. 1 for example, a potential difference occurs between lines adjacent to each other (for example, brunch lines 13 and 23), so that copper which constitutes a line serving as an anode is ionized. The copper ion is absorbed by the cover lay film having absorbed water. This is occurrence of the migration. Further, the copper ion generated by the absorption moves to a line, serving as a cathode, through the cover lay film, and is deposited. This deposition is dendrite. When the dendrite grows into a dendritic shape, lines adjacent to each other may be short-circuited.

(5) Adhesiveness

The adhesiveness was measured in accordance with JIS-D-0202.

(6) Insulation Resistance

The insulation resistance was measured in accordance with JIS-C-6481.

(7) Weight-Average Molecular Weight of Imidesiloxaneoligomer (ISO)

The weight-average molecular weight of ISO serving as a precursor of the photosensitive IMASO (A-3) was measured by a high speed GPC (HLC-8220GPC (commercial name) produced by Tosoh Corporation). The measurement was carried out under such condition that: DMF (including 0.036M LiBr and 0.019M phosphoric acid) was used as a developing solvent, and two columns (KD-805-M: commercial name) produced by Shodex were used, and a column temperature was set to 40° C., and a PI (PEO standard) was used as a detector, and a flow rate was set to 0.6 ml/min.

### SYNTHESIS EXAMPLE 1

### Of Photosensitive IMASO

15.62 g (0.030 mol) of 4,4′-(4,4′-isopropylidendiphenoxy)bisphthalic anhydride and 30 g of dimethylformamide (DMF) were placed in a 500 ml separable flask provided with a stirrer, and the mixture was stirred by the stirrer so as to dissolve the mixture. Next, 5.15 g (0.018 mol) of 4,4′-diamino-3,3′-dicarboxydiphenylmethane was dissolved in 9 g of DMF, and the resultant was added to the mixture solution, and the mixture was intensely stirred for one hour. Further, 7.47 g (0.009 mol) of silicondiamine (KF-8010 (commercial name) produced by Shin-Etsu Silicone Co., Ltd.) was added thereto, and the mixture was stirred for about one hour, thereby obtaining an amic acid oligomer solution.

The amic acid oligomer solution was placed in a tray coated with fluorocarbon resin and was dried in a vacuum oven at 200° C. under reduced pressure of 5000 Pa for two hours, thereby obtaining 25.0 g of imide siloxane oligomer (ISO). A weight-average molecular weight Mw of the obtained ISO was 9060.

Next, 18.12 g (2 mmol) of the obtained ISO was dissolved in 30 g of DMF, and 0.994 g (7 mmol) of glycidylmethacrylate (product of Wako Pure Chemical Industries, Ltd.), 0.2 g (2 mmol) of triethylamine (product of Wako Pure Chemical Industries, Ltd.), and 100 mg of radical stabilizer (Q1301 (commercial name) produced by Wako Pure Chemical Industries, Ltd.) were added thereto, and the resultant was heated at 100° C. for three hours. Thus obtained reaction solution was poured into methanol, and redeposition was carried out. Thereafter, the resultant was dried, thereby obtaining 18 g of photosensitive imide (meth)acrylsiloxaneoligomer (photosensitive IMASO). 1 5 g of thus obtained photosensitive IMASO was dissolved in 35 g of dioxolane, thereby preparing such varnish that Sc (solid content concentration)=30%.

### SYNTHESIS EXAMPLE 2

### Of photosensitive IMASO

17.3 g (0.030 mol) of (2,2′-bis(4-hydroxyphenyl)propanebenzoate)-3,3′,4,4′-tetracarboxylic anhydride and 30 g of DMF were placed in a 500 ml separable flask provided with a stirrer, and the mixture was stirred by the stirrer so as to dissolve the mixture. Next, 5.15 g (0.018 mol) of 4,4′-diamino-3,3′-dicarboxydiphenylmethane was dissolved in 9 g of DMF, and the resultant was added to the mixture solution, and the mixture was intensely stirred for one hour. Further, 5.81 g (0.007 mol) of silicondiamine (KF-8010 (commercial name) produced by Shin-Etsu Silicone Co., Ltd.) was added thereto, and the mixture was stirred for about one hour, thereby obtaining an amic acid oligomer solution.

The amic acid oligomer solution was placed in a tray coated with fluorocarbon resin and was dried in a vacuum oven at 200° C. under reduced pressure of 5000 Pa for two hours, thereby obtaining 23.5 g of ISO. A weight-average molecular weight Mw of the obtained ISO was 5460.

Next, 21.84 g (4 mmol) of the obtained ISO was dissolved in 35 g of DMF, and 2.13 g (15 mmol) of glycidylmethacrylate (product of Wako Pure Chemical Industries, Ltd.), 0.2 g (2 mmol) of triethylamine (product of Wako Pure Chemical Industries, Ltd.), and 100 mg of radical stabilizer (Q1301 (commercial name) produced by Wako Pure Chemical Industries, Ltd.) were added thereto, and the resultant was heated at 100° C. for three hours. Thus obtained reaction solution was poured into methanol, and redeposition was carried out. Thereafter, the resultant was dried, thereby obtaining 21 g of photosensitive IMASO. 15 g of thus obtained photosensitive IMASO was dissolved in 35 g of dioxolane, thereby preparing such varnish that Sc (solid content concentration)=30%.

### SYNTHESIS EXAMPLE 3

### Of Photosensitive IMASO

6.2 g (0.024 mol) of 2,2-bis [3-amino-4-hydroxyphenyl]propane, 7.47 g (0.009 mol) of silicondiamine (KF-8010 (commercial name) produced by Shin-Etsu Silicone Co., Ltd.), and 30 g of DMF were placed in a 500 ml separable flask provided with an azeotropic tube (an ester tube or a DeanStark distillation tube) and a stirrer, and the mixture was stirred by the stirrer so as to dissolve the mixture. Next, 17.3 g (0.030 mol) of (2,2′-bis(4-hydroxyphenyl)propanedibenzoate)-3,3′,4,4′-tetracarboxylic anhydride was added thereto at once, and the mixture was stirred for about three minutes. Further, 50 g of toluene and 5 g of β-picoline were added thereto, and the mixture was heated at 160° C. for about three hours. Note that, at this time, generation of water stopped in about two hours, and an amount of thus generated water was 1.1 ml.

Thus obtained reaction solution was poured into methanol, and redeposition was carried out. Thereafter, the resultant was dried, thereby obtaining 28.5 g of ISO. A weight-average molecular weight Mw of thus obtained ISO was 10500. After completion of the reaction, toluene was removed.

21.0 g (2 mmol) of the obtained ISO, 2.13 g (15 mmol) of glycidylmethacrylate (product of Wako Pure Chemical Industries, Ltd.), 0.2 g (2 mmol) of triethylamine (product of Wako Pure Chemical Industries, Ltd.), and 100 mg of radical stabilizer (Q1301 (commercial name) produced by Wako Pure Chemical Industries, Ltd.) were added thereto, and the resultant was heated at 100° C. for three hours. Thus obtained reaction solution was poured into methanol, and redeposition was carried out. Thereafter, the resultant was dried, thereby obtaining 20.5 g of photosensitive IMASO. 15 g of thus obtained photosensitive IMASO was dissolved in 35 g of dioxolane, thereby preparing such varnish that Sc (solid content concentration)=30%.

### SYNTHESIS EXAMPLE 4

### Of Photosensitive IMASO

8.79 g (0.024 mol) of 2,2-bis [3-amino-4-hydroxyphenyl]trifluoropropane, 7.47 g (0.009 mol) of silicondiamine (KF-8010 (commercial name) produced by Shin-Etsu Silicone Co., Ltd.), and 30 g of DMF were placed in a 500 ml separable flask provided with an azeotropic tube (an ester tube or a DeanStark distillation tube) and a stirrer, and the mixture was stirred by the stirrer so as to dissolve the mixture. Next, 8.83 g (0.030 mol) of 2,3,3′,4′-biphenyltetracarboxylate dianhydride was added thereto at once, and the mixture was stirred for about 60 minutes. Further, 50 g of toluene and 5 g of β-picoline were added thereto, and the mixture was heated at 160° C. for about three hours. Note that, at this time, generation of water stopped in about two hours, and an amount of thus generated water was 1.1 ml.

Thus obtained reaction solution was poured into methanol, and redeposition was carried out. Thereafter, the resultant was dried, thereby obtaining 23 g of ISO. A weight-average molecular weight Mw of thus obtained ISO was 8600. After completion of the reaction, toluene was removed.

17.2 g (2 mmmol) of the obtained ISO, 2.133 g (15 mmol) of glycidylmethacrylate (product of Wako Pure Chemical Industries, Ltd.), 0.2 g (2 mmol) of triethylamine (product of Wako Pure Chemical Industries, Ltd.), and 100 mg of radical stabilizer (Q1301 (commercial name) produced by Wako Pure Chemical Industries, Ltd.) were added thereto, and the resultant was heated at 100° C. for three hours. Thus obtained reaction solution was poured into methanol, and redeposition was carried out. Thereafter, the resultant was dried, thereby obtaining 17 g of photosensitive IMASO. 15 g of thus obtained photosensitive IMASO was dissolved in 35 g of dioxolane, thereby preparing such varnish that Sc (solid content concentration)=30%.

### EXAMPLE 15

The following components (A-3), (B), and (C) were mixed so as to prepare the photosensitive resin composition, and thus prepared photosensitive resin composition was applied to a PET film with a bar coater, thereby producing the photosensitive dry film resist in the B stage state. The protective film was laminated on the photosensitive dry film resist having the PET film, thereby producing a three-layer sheet (laminate).

Photosensitive IMASO (A-3) the photosensitive IMASO synthesized in Synthesis Example 1:50 parts by weight

(meth)acryls compound (B) bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 5 parts by weight bisphenol A EO denaturalized (recurring unit of an ethyleneoxide denaturalized portion: m+n≈4) diacrylate (ARONIX M-211B (commercial name) produced by TOAGOSEI CO., LTD.): 10 parts by weight

Optical reaction initiator (accessory component) (C-1) 3,3′,4,4′-tetra(t-butylperoxycarbonyl)benzophenone: 1 part by weight

Sensitizer (accessory component) (C-1) 4,4′-diethylaminobenzophenone: 1 part by weight

Flame retardant (accessory component) (C-2) Methacrylate having halogen atom (BR-42M (commercial name) produced by Dai-ichi Kogyo Seiyaku Co., Ltd.): 35 parts by weight

<Evaluation of Properties>

The foregoing test was carried out with respect to the obtained photosensitive dry film resist. As a result, a minute hole whose diameter was 100 μm Φ and lines of 100 μm/100 μm were developed, so that the photosensitive dry film resist was regarded as being appropriate in the developing property. Further, the bonding strength was 500 Pa.m, so that the photosensitive dry film resist was regarded as being appropriate in the flame retardancy. Further, the sample having been dipped at 270° C. for one minute was free from any problems such as exfoliation and color variation under both the normal condition and the moisture absorption condition. Further, under both the normal condition and the moisture absorption condition, the 30-second-dipable temperature was 340° C., so that the photosensitive dry film resist was regarded as being appropriate in the soldering heat resistance. Further, as to the anti-migration, the resistance value after 1000 hours remained 10⁹Ω or more and no dendrite was found. The electric insulation property was 4×10¹⁴Ω.

### EXAMPLE 16

The following components (A-3), (B), and (C) were mixed so as to prepare the photosensitive resin composition, and thus prepared photosensitive resin composition was applied to a PET film with a bar coater, thereby producing the photosensitive dry film resist in the B stage state. The protective film was laminated on the photosensitive dry film resist having the PET film, thereby producing a three-layer sheet (laminate).

Photosensitive IMASO (A-3) the photosensitive IMASO synthesized in Synthesis Example 2:50 parts by weight

(meth)acryls compound (B) bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 5 parts by weight bisphenol A EO denaturalized (recurring unit of an ethyleneoxide denaturalized portion: m+n≈4) diacrylate (ARONIX M-211B (commercial name) produced by TOAGOSEI CO., LTD.): 10 parts by weight

Optical reaction initiator (accessory component) (C-1) bis(2,4,6-trimethylbenzoyl)-phenylphosphineoxide: 1 part by weight 2,2-dimethoxy-1,2-diphenylmethane-1-one: 0.5 parts by weight

Flame retardant (accessory component) (C-2) phosphate ester (PX-200 (commercial name) produced by DAIHACHI CHEMICAL INDUSTRY CO., LTD.): 20 parts by weight diphenyl-2-metachroyloxyethylphosphate (MR-260 (commercial name) produced by DAIHACHI CHEMICAL INDUSTRY CO., LTD.): 15 parts by weight

<Evaluation of Properties>

The foregoing test was carried out with respect to the obtained photosensitive dry film resist. As a result, a minute hole whose diameter was 100 μm Φ and lines of 100 μm/100 μm were developed, so that the photosensitive dry film resist was regarded as being appropriate in the developing property. Further, the bonding strength was 500 Pa.m, so that the photosensitive dry film resist was regarded as being appropriate in the flame retardancy. Further, the sample having been dipped at 270° C. for one minute was free from any problems such as exfoliation and color variation under both the normal condition and the moisture absorption condition. Further, under both the normal condition and the moisture absorption condition, the 30-second-dipable temperature was 350° C., so that the photosensitive dry film resist was regarded as being appropriate in the soldering heat resistance. Further, as to the anti-migration, the resistance value after 1000 hours remained 10⁹Ω or more and no dendrite was found. The electric insulation property was 5×10¹⁴Ω.

### EXAMPLE 17

The following components (A-3), (B), and (C) were mixed so as to prepare the photosensitive resin composition, and thus prepared photosensitive resin composition was applied to a PET film with a bar coater, thereby producing the photosensitive dry film resist in the B stage state. The protective film was laminated on the photosensitive dry film resist having the PET film, thereby producing a three-layer sheet (laminate).

Photosensitive IMASO (A-3) the photosensitive IMASO synthesized in Synthesis Example 3: 50 parts by weight

(meth)acryls compound (B) bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 5 parts by weight bisphenol A EO denaturalized (recurring unit of an ethyleneoxide denaturalized portion: m+n=4) diacrylate (ARONIX M-211B (commercial name) produced by TOAGOSEI CO., LTD.): 10 parts by weight

Optical reaction initiator (accessory component) (C-1) bis(2,4,6-trimethylbenzoyl)-phenylphosphineoxide: 1 part by weight bis(η5-2,4-cyclopentanediene-1-yl)bis (2,6-difluoro-3-(1H-pyrrole-1-yl)-bis (2,6-difluoro-3-(1H-pyrrole-1-yl)-phenyl)titanium: 1 part by weight

Flame retardant (accessory component) (C-2) phosphagen compound (SPE-100 (commercial name) produced by Otsuka Chemical Co., Ltd.): 15 parts by weight acrylic compound having halogen atom (BR-30 (commercial name) produced by Dai-ichi Kogyo Seiyaku Co., Ltd.): 20 parts by weight

<Evaluation of Properties>

The foregoing test was carried out with respect to the obtained photosensitive dry film resist. As a result, a minute hole whose diameter was 100 μm Φ and lines of 100 μm/100 μm were developed, so that the photosensitive dry film resist was regarded as being appropriate in the developing property. Further, the bonding strength was 500 Pa.m, so that the photosensitive dry film resist was regarded as being appropriate in the flame retardancy. Further, the sample having been dipped at 270° C. for one minute was free from any problems such as exfoliation and color variation under both the normal condition and the moisture absorption condition. Further, under both the normal condition and the moisture absorption condition, the 30-second-dipable temperature was 345° C., so that the photosensitive dry film resist was regarded as being appropriate in the soldering heat resistance. Further, as to the anti-migration, the resistance value after 1000 hours remained 10⁹Ω or more and no dendrite was found. The electric insulation property was 7×10¹⁴Ω.

### EXAMPLE 18

The following components (A-3), (B), and (C) were mixed so as to prepare the photosensitive resin composition, and thus prepared photosensitive resin composition was applied to a PET film with a bar coater, thereby producing the photosensitive dry film resist in the B stage state. The protective film was laminated on the photosensitive dry film resist having the PET film, thereby producing a three-layer sheet (laminate).

Photosensitive IMASO (A-3) the photosensitive IMASO synthesized in Synthesis Example 4:50 parts by weight

(meth)acryls compound (B) bisphenol A EO denaturalized (recurring unit of an ethyleneoxide denaturalized portion: m+n≈30) diacrylate (NK ester A-BPE-30 (commercial name) produced by SHIN-NAKAMURA CHEMICAL CO., LTD.): 5 parts by weight bisphenol A EO denaturalized (recurring unit of an ethyleneoxide denaturalized portion: m+n≈4) diacrylate (ARONIX M-211B (commercial name) produced by TOAGOSEI CO., LTD.): 10 parts by-weight

Optical reaction initiator (accessory component) (C-1) bis(2,4,6-trimethylbenzoyl)-phenylphosphineoxide: 1 part by weight

Flame retardant (accessory component) (C-2) acrylic compound having halogen atom (BR-42M (commercial name) produced by Dai-ichi Kogyo Seiyaku Co., Ltd.): 35 parts by weight

<Evaluation of Properties>

The foregoing test was carried out with respect to the obtained photosensitive dry film resist. As a result, a minute hole whose diameter was 100 μm Φ and lines of 100 μm/100 μm were developed, so that the photosensitive dry film resist was regarded as being appropriate in the developing property. Further, the bonding strength was 500 Pa.m, so that the photosensitive dry film resist was regarded as being appropriate in the flame retardancy. Further, the sample having been dipped at 270° C. for one minute was free from any problems such as exfoliation and color variation under both the normal condition and the moisture absorption condition. Further, under both the normal condition and the moisture absorption condition, the 30-second-dipable temperature was 335° C., so that the photosensitive dry film resist was regarded as being appropriate in the soldering heat resistance. Further, as to the anti-migration, the resistance value after 1000 hours remained 10⁹Ω or more and no dendrite was found. The electric insulation property was 2×10¹⁴Ω.

### COMPARATIVE EXAMPLE 11

The same operation as in Example 15 was carried out except that 50 parts by weight of methylethylketone solution (its solid content concentration was 32% and its weight-average molecular weight was 85000) containing methacrylate copolymer (ternary copolymer made up of 57 wt % of methyl methacrylate, 23 wt % of methacrylic acid, and 10 wt % of butyl acrylate) was used instead of the photosensitive IMASO (A-3), thereby obtaining a three-layer sheet including the photosensitive dry film resist.

<Evaluation of Properties>

The foregoing test was carried out with respect to the obtained photosensitive dry film resist. As a result, the photosensitive dry film resist burned with a flame, so that the burning property was regarded as being inappropriate in accordance with the standard UL94V-0. While, a minute hole of 100 μm×100 μm was developed, so that the photosensitive dry film resist was regarded as being appropriate in the developing property (note that, 1% sodium carbonate aqueous solution was used as the developer in this case). Further, the bonding strength was 400 Pa.m. Further, the sample having been dipped at 270° C. for one minute was free from problems such as exfoliation and color variation under both the normal condition and the moisture absorption condition. However, swollenness was found in the moisture absorption sample. Further, under the normal condition, the 30-second-dipable temperature was 270° C., and under the moisture absorption condition, the 30-second-dipable temperature was 260° C. Further, as to the anti-migration, short circuit occurred after 400 hours, and the dendrite was found. The electric insulation property was 2×10¹²Ω.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

In case where the present invention is used particularly as the photosensitive dry film resist, it is possible to realize characteristics such as (1) realization and improvement of water system developing property, (2) improvement of utility as an imidized film, (3) improvement of property after curing, and (4) simplification of manufacture of a print wiring substrate.

Thus, the present invention can be favorably used not only in an industrial field for manufacturing a print wiring substrate such as FPC or the like, for example, in a resin production field for producing resin materials for electronic parts, but also in an industrial field of electronic devices using such a print wiring substrate.

1. A photosensitive resin composition, comprising a base resin component (A) and a (meth)acryls compound (B) as essential components, wherein the base resin component (A) is any one of: a polyimide resin (A-1) having at least either a hydroxyl group or a carboxyl group in its structure; a polyamide resin (A-2) having at least either a hydroxyl group or a carboxyl group in its structure; and photosensitive imide (meth)acrylsiloxaneoligomer (A-3).

2. The photosensitive resin composition as set forth in claim 1, wherein:
the base resin component is the polyimide resin (A-1) or the polyamide resin (A-2), and
the (meth)acryls compound (B) is at least one kind of a compound selected from a (meth)acrylic compound, an epoxy(meth)acrylate, a polyester(meth)acrylate, a urethane (meth)acrylate, and an imide(meth)acrylate.

3. The photosensitive resin composition as set forth in claim 2, wherein:
the polyimide resin (A-1) is a polyimide resin having a phenolic hydroxy group (A-1-1) which is a polyimide resin partially made of a phenol derivative having an amino group, and
the phenol derivative is such that two or more phenol compounds bind each other via an atom or an atom group in a chain manner and each of the phenol compounds at both ends has an amino group which substitutes one of hydrogen atoms in a benzene ring.

4. The photosensitive resin composition as set forth in claim 3, wherein the phenol derivative used as a martial for the polyimide resin (A-1-1) is a compound represented by formula (1) 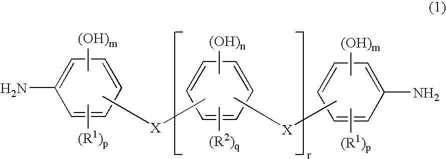
where R¹ and R² may be identical with or different from each other, and each of R¹ and R² represents a hydrogen atom, an alkyl group containing 1 to 9 carbon atoms, an alkoxy group containing 2 to 10 carbon atoms, or COOR³ (R³ represents a hydrogen atom or an alkyl group containing 1 to 9 carbon atoms), and X represents —O—, —S—, —SO₂—, —C(CH₃)₂—, —CH₂—, —C(CH₃)(C₂H₅)—, or C(CF₃)₂—, and each of m and p is an integer not less than 0 which is under such condition that m+p=4, and each of n and q is an integer not less than 0 which is under such condition that n+q=4, and r is any one of integers 0 to 10.

5. The photosensitive resin composition as set forth in claim 2, wherein the polyimide resin (A-1) is a polyimide resin having at least one recurring unit represented by formula (2) 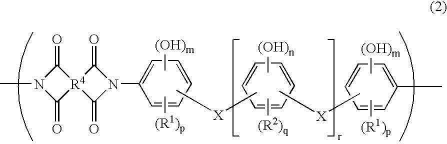
where R¹ and R² may be identical with or different from each other, and each of R¹ and R² represents a hydrogen atom, an alkyl group containing 1 to 9 carbon atoms, an alkoxy group containing 2 to 10 carbon atoms, or COOR³ (R³ represents a hydrogen atom or an alkyl group containing 1 to 9 carbon atoms), and X represents —O—, —S—, —SO₂—, —C(CH₃)₂—, —CH₂—, —C(CH₃)(C₂H₅)—, or C(CF₃)₂—, and R⁴ represents a residue of aromatic tetra carboxylate dianhydride, and each of m and p is an integer not less than 0 which is under such condition that m+p=4, and n and q are under such condition that n+q=4, and n is an integer not less than 0 and q is an integer not less than 0, and r is any one of integers 0 to 3.

6. The photosensitive resin composition as set forth in claim 2, wherein a weight-average molecular weight of the polyimide resin (A-1) or the polyamide resin (A-2) is 5000 or more and 100000 or less.

7. The photosensitive resin composition as set forth in claim 2, wherein a hydroxyl equivalent of the polyimide resin (A-1) or the polyamide resin (A-2) is 5000 or less.

8. The photosensitive resin composition as set forth in claim 7, wherein the hydroxyl equivalent of the polyimide resin (A-1) or the polyamide resin (A-2) is 3000 or less.

9. The photosensitive resin composition as set forth in claim 2, wherein the (meth)acryls compound (B) is a compound having at least one epoxy group and at least one (meth)acryl group in its molecule.

10. The photosensitive resin composition as set forth in claim 2, wherein the (meth)acryls compound (B) is epoxy (meth)acrylate having at least two hydroxyl groups in its molecule.

11. The photosensitive resin composition as set forth in claim 2, further comprising, as an accessory component (C), at least one kind selected from: at least one kind (C-1) of a photoreaction initiator, a sensitizer, and a photopolymerization assistant; a flame retardant (C-2); an epoxy resin (C-3); and a curing promotion agent and/or a curing agent (C-4).

12. The photosensitive resin composition as set forth in claim 1, wherein:
the base resin component is the polyimide resin (A-1), and the polyimide resin (A-1) is a photosensitive polyimide resin (A-1-2) obtained by reacting a compound having a carbon-carbon double bond with a polyimide resin having a hydroxyl group in its structure, and
the (meth)acryls compound (B) is at least one kind of a compound selected from a (meth)acrylic compound, an epoxy (meth)acrylate, a polyester (meth)acrylate, a urethane(meth)acrylate, and an imide(meth)acrylate, and
the photosensitive resin composition further includes, as an accessory component (C), at least one kind (C-1) selected from a photoreaction initiator, a sensitizer, and a photopolymerization assistant.

13. The photosensitive resin composition as set forth in claim 12, wherein:
the photosensitive polyimide resin (A-1-2) is a polyimide resin having a phenolic hydroxyl group which is a polyimide resin partially made of a phenol derivative having an amino group, and
the phenol derivative is such that two or more phenol compounds bind each other via an atom or an atom group in a chain manner and each of the phenol compounds at both ends has an amino group which substitutes one of hydrogen atoms in a benzene ring.

14. The photosensitive resin composition as set forth in claim 13, wherein the phenol derivative used as a martial for the polyimide resin is a compound represented by formula (3) 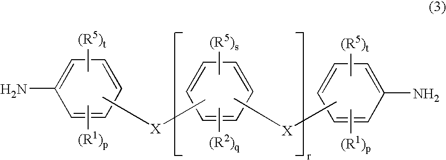
where R¹ and R² may be identical with or different from each other, and each of R¹ and R² represents a hydrogen atom, an alkyl group containing 1 to 9 carbon atoms, an alkoxy group containing 2 to 10 carbon, or COOR³ (R³ represents a hydrogen atom or an alkyl group containing 1 to 9 carbon atoms), and X represents —O—, —S—, —SO₂—, —C(CH₃)₂—, —CH₂—, —C(CH₃)(C₂H₅)—, or C(CF₃)₂—, and all of R⁵ may be identical with or different from each other, and each R⁵ represents —OH or an unsaturated organic group having a carbon-carbon double bond in its structure, a number of —OH or the unsaturated organic group being at least one, and each of t and p is an integer not less than 0 which is under such condition that t+p=4, and each of s and q is an integer not less than 0 which is under such condition that s+q=4, and r is any one of integers 0 to 10.

15. The photosensitive resin composition as set forth in claim 14, wherein the unsaturated organic group is an organic group selected from a group (4) 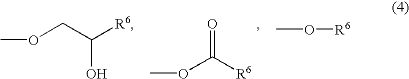
where R⁶ is a monovalent organic group having a carbon-carbon double bond.

16. The photosensitive resin composition as set forth in claim 12, wherein the photosensitive polyimide resin (A-1-2) is a polyimide resin having at least one recurring unit represented by formula (5) 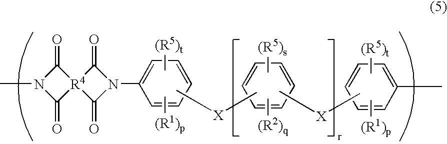
where R¹ and R² may be identical with or different from each other, and each of R¹ and R² represents a hydrogen atom, an alkyl group containing 1 to 9 carbon atoms, an alkoxy group containing 2 to 10 carbon atoms, or COOR³ (R³ represents a hydrogen atom or an alkyl group containing 1 to 9 carbon atoms), and X represents —O—, —S—, —SO₂—, —C(CH₃)₂—, —CH₂—, —C(CH₃)(C₂H₅)—, or C(CF₃)₂—, and R⁴ represents a residue of aromatic tetra carboxylate dianhydride, and all of R⁵ may be identical with or different from each other, and each R5 represents —OH or an unsaturated organic group containing a carbon-carbon double bond in its structure, a number of —OH or the unsaturated organic group being at least one, and each of t and p is an integer not less than 0 which is under such condition that t+p=4, and each of s and q is an integer not less than 0 which is under such condition that s+q=4, and r is any one of integers 0 to 10.

17. The photosensitive resin composition as set forth in claim 16, wherein the unsaturated organic group is an organic group selected from a group (4) 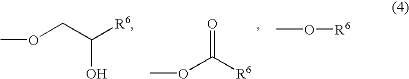
where R⁶ is a monovalent organic group having a carbon-carbon double bond.

18. The photosensitive resin composition as set forth in claim 12, wherein a weight-average molecular weight of the photosensitive polyimide resin (A-1-2) is 5000 or more and 200000 or less.

19. The photosensitive resin composition as set forth in claim 13, wherein a weight-average molecular weight of each phenolic hydroxyl group of the polyimide resin is 10000 or less.

20. The photosensitive resin composition as set forth in claim 12, wherein the (meth)acryls compound (B) is a compound having at least one epoxy group and at least one (meth)acryl group in its molecule.

21. The photosensitive resin composition as set forth in claim 12, wherein the (meth)acryls compound (B) is epoxy (meth)acrylate having at least two hydroxyl groups in its molecule.

22. The photosensitive resin composition as set forth in claim 12, further comprising, as the accessory component (C), at least one kind selected from: a flame retardant (C-2); an epoxy resin (C-3); and a curing promotion agent and/or a curing agent (C-4).

23. The photosensitive resin composition as set forth in claim 2, wherein:
the base resin component is the polyimide resin (A-1), and the polyimide resin (A-1) is a soluble polyimide resin (A-1-3) having a polymerizable functional group and at least one of a carboxyl group and a hydroxyl group, and
the photosensitive resin composition further includes, as a storage stabilization additive (D), at least one kind selected from a polymerization inhibitor, a stabilizer, and an oxidization inhibitor.

24. The photosensitive resin composition as set forth in claim 23, wherein the soluble polyimide resin (A-1-3) includes, as a polymerizable functional group, at least one kind of a functional group selected from a vinyl group and a (meth)acryl group.

25. The photosensitive resin composition as set forth in claim 23, wherein the storage stabilization additive (D) is at least one kind of a compound selected from a hydroquinone compound, a hindered phenolic compound, a nitrosamine compound, and an aromatic amine.

26. The photosensitive resin composition as set forth in claim 23, wherein a viscosity increasing rate in case where the photosensitive resin composition is left at a room temperature for 7 days under such condition that the photosensitive resin composition is dissolved in an organic solvent is 0% or more and 20% or less.

27. The photosensitive resin composition as set forth in claim 23, further comprising, as the accessory component (C), at least one kind selected from: at least one kind (C-1) of a photoreaction initiator, a sensitizer, and a photopolymerization assistant; a flame retardant (C-2); an epoxy resin (C-3); and a curing promotion agent and/or a curing agent (C-4).

28. The photosensitive resin composition as set forth in claim 2, wherein:
the base resin component is the photosensitive imide(meth)acrylsiloxaneoligomer (A-3), and
the (meth)acryls compound is a polyunsaturated (meth)acryls compound (B-1) having two or more unsaturated double bonds, and
an amount of the polyunsaturated (meth)acryls compound (B-1) ranges from 5 to 200 parts by weight with respect to 100 parts by weight of the photosensitive imide (meth)acrylsiloxaneoligomer (A-3).

29. The photosensitive resin composition as set forth in claim 28, wherein:
the photosensitive imide(meth)acrylsiloxaneoligomer (A-3) is obtained by reacting imidesiloxaneoligomer with an epoxy compound having a double bond, and
the imidesiloxaneoligomer is obtained by reacting diamine with tetra carboxylate dianhydride and imidizing the diamine and the tetra carboxylate dianhydride that have been reacted.

30. The photosensitive resin composition as set forth in claim 29, wherein the diamine is at least siloxanediamine.

31. The photosensitive resin composition as set forth in claim 30, wherein the siloxanediamine is diaminopolysiloxane represented by formula (6) 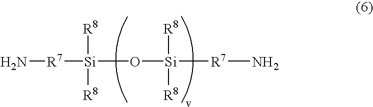
where R⁷ is —CᵤH₂ᵤ— or —C₆H₄—, and R⁸ is a methyl group, an ethyl group, or a phenyl group, and u is any one of integers 1 to 6, and v is any one of integers 2 to 50.

32. The photosensitive resin composition as set forth in claim 31, wherein: in case of using the diaminopolysiloxane as the diamine, a molar ratio of the diaminopolysiloxane ranges from 5 to 70 mol % with respect to 100 mol % of whole the diamine.

33. The photosensitive resin composition as set forth in claim 29, wherein diamine having a phenolic hydroxyl group or diamine having a carboxyl group is used as the diamine.

34. The photosensitive resin composition as set forth in claim 33, wherein: in case of using the diamine having a phenolic hydroxyl group as the diamine, a molar ratio of the tetra carboxylate dianhydride ranges from 50 to 95 mol % with respect to 100 mol % of whole the diamine.

35. The photosensitive resin composition as set forth in claim 33, wherein: in case of using the diamine having a carboxyl group as the diamine, a molar ratio of the diamine ranges from 50 to 95 mol % with respect to 100 mol % of the tetra carboxylate dianhydride.

36. The photosensitive resin composition as set forth in claim 33, wherein the diamine having a phenolic hydroxyl group or the diamine having a carboxyl group is an aromatic diamine compound represented by formula (7) 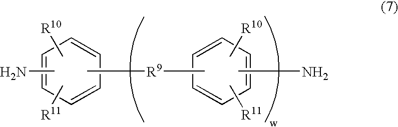
where R9 represents a group having a direct bond or a bivalent group selected from —O—, —S—, —CO—, —SO₂—, —SO—, —CH₂—, —C(CH₃)₂—, —O—C₆H₄—O—, —C₆H₄—, and —O—C₆H₄—C(CH₃)₂—C₆H₄—O—, and R¹⁰ represents —OH or —COOH, and R¹¹ represents a hydrogen atom, a methyl group, or a halogen atom.

37. The photosensitive resin composition as set forth in claim 28, further comprising a flame retardant (C-2) as the accessory component (C).

38. The photosensitive resin composition as set forth in claim 37, wherein an amount of the flame retardant (C-2) ranges from 5 to 200 parts by weight with respect to 100 parts by weight of the photosensitive imide (meth)acrylsiloxaneoligomer (A-3) and 5 to 200 parts by weight of the polyunsaturated (meth)acryls compound (B-1).

39. The photosensitive resin composition as set forth in claim 37, wherein the flame retardant (C-2) is at least one kind of a compound selected from phosphate ester, condensed phosphate ester, phosphite ester, phosphagene compound, phosphine oxide, phosphine, phosphate ester having halogen atom, condensed phosphate ester having halogen atom, (meth)acryls compound having halogen atom, and organopolysiloxane compound.

40. The photosensitive resin composition as set forth in claim 28, further comprising: at least one kind (C-1) selected from a photoreaction initiator, a sensitizer, and a photopolymerization assistant; an epoxy resin (C-3); and at least one kind (C-4) selected from a curing promotion agent and/or a curing agent.

41. A photosensitive dry film resist, being made of the photosensitive resin composition as set forth in claim 1.

42. The photosensitive dry film resist as set forth in claim 41, wherein an epoxy resin layer is formed on a surface of the photosensitive dry film resist.

43. The photosensitive dry film resist as set forth in claim 41, wherein: in case of using, as a developer, 1 wt % of sodium hydrate whose temperature is 40° C. and using a spray developing device as developing means,
a dissolving time at a spray pressure of 0.85 MPa is 180 seconds or less.

44. The photosensitive dry film resist as set forth in claim 43, wherein the dissolving time is 20 seconds or more.

45. The photosensitive dry film resist as set forth in claim 41, wherein: in case of using, as a developer, a sodium hydrate aqueous solution whose temperature is 40° C. and whose concentration is 1 wt % and using a spray developing device as developing means,
a dissolving time at a spray pressure of 0.85 MPa varies within a range of ±20% after the photosensitive dry film resist is left at room temperature for 7 days compared with the photosensitive dry film resist before being left for 7 days.

46. A laminate, including a layer made of the photosensitive dry film resist as set forth in claim 41,
said laminate comprising at least either a protective film for protecting the surface of the photosensitive dry film resist or a support film for supporting the photosensitive dry film resist.

47. A print wiring substrate, using the photosensitive dry film resist as set forth in claim 41 as an insulating protection layer.

48. A flexible print wiring substrate, using the photosensitive dry film resist as set forth in claim 41 as a photosensitive cover lay film.

49. A flexible print wiring substrate, comprising a photosensitive cover lay film made of the photosensitive resin composition as set forth in claim 1.
